(19) United States
(12) Patent Application Publication
(10) Pub. No.: US 2011/0270646 A1
(43) Pub. Date: Nov. 3, 2011

(54) COMPUTER IMPLEMENTED DECISION SUPPORT METHOD & SYSTEM

(76) Inventors: Gorur Narayana Srinivasa Prasanna, Karnataka (IN); Abhilasha Aswal, Karnataka (IN); Anushka Chandra Babu, Karnataka (IN); Dileep Kumar, Karnataka (IN); Mabel Mary Joy, Karnataka (IN); Piyushkumar Jain, Karnataka (IN)

(21) Appl. No.: 13/003,507

(22) PCT Filed: Jul. 13, 2009
(86) PCT No.: PCT/IN2009/000398

§ 371 Date: Mar. 29, 2011

(30) Foreign Application Priority Data
Jul. 11, 2008 (IN) 1684/CHE/2008

(51) Int. Cl. G06Q 10/00; G06N 5/02

(52) U.S. Cl. 705/7.27; 706/46

(57) ABSTRACT

In this research, we propose to extend the robust optimization technique and target it for problems encountered in supply chain management. Our method represents uncertainty as polyhedral uncertainty sets made of simple linear constraints derivable from macroscopic economic data. We avoid the probability distribution estimation of stochastic programming. The constraints in our approach are intuitive and meaningful. This representation of uncertainty is applied to capacity planning and inventory optimization problems in supply chains. The representation of uncertainty is the unique feature that drives this research. It has led us to explore different problems in capacity/inventory planning under this new paradigm. A decision support system package has been developed, which can conveniently interface to manufacturing/firm data warehouses, inferring and analyzing constraints from historical data, analyzing performance (worst case/best case), and optimizing plans.

### BACKGROUND AND MOTIVATION

The supply-chain is an integrated effort by a number of entities—from suppliers of raw materials to producers, to the distributors—to produce and deliver a product or a service to the end user. Planning and managing a supply chain involves making decisions which depend on estimations of future scenarios (about demand, supply, prices, etc). Not all the data required for these estimations are available with certainty at the time of making the decision. The existence of this uncertainty greatly affects these decisions. If this uncertainty is not taken into account, and nominal values are assumed for the uncertain data, then even small variations from the nominal in the actual realizations of data can make the nominal solution highly suboptimal. This problem of design/analysis/optimization under uncertainty is central to decision support systems, and extensive research has been carried out in both Probabilistic (Stochastic) Optimization and Robust Optimization (constraints) frameworks. However, these techniques have not been widely adopted in practice, due to difficulties in conveniently estimating the data they require. Probability distributions of demand necessary for the stochastic optimization framework are generally not available. The constraint based approach of the robust optimization School has been limited in its ability to incorporate many criteria meaningful to supply chains. At best, the “price of robustness” of Bertsimas et al [9] is able to incorporate symmetric variations around a nominal point. However, many real life supply chain constraints are not of this form. In this thesis, we present a method of decision support in supply chains under uncertainty, using capacity planning and inventory optimization as examples. This work is accompanied by an implementation of “Capacity Planning” and “Inventory Optimization” modules in a “Supply-Chain Management” software.

Models for Optimization Under Uncertainty

In many supply chain models, it is assumed that all the data are known precisely and the effects of uncertainty are ignored. But the answers produced by these deterministic models can have only limited applicability in practice. The classical techniques for addressing uncertainty are stochastic programming and robust optimization.

To formulate an optimization problem mathematically, we form an objective function f: [symbol] ⁿ→ [symbol] that is minimized (or maximized) subject to some constraints.

Minimize f₀(x, ξ)

Subject to fᵢ(x, ξ)÷0, ∀ i ε I, 1.1

where ξ ε [symbol] ^{d} is the vector of data.

When the data vector ξ is uncertain, deterministic models fix the uncertain parameters to some nominal value and solve the optimization problem. The restriction to a deterministic value limits the utility of the answers.

In stochastic programming, the data vector ξ is viewed as a random vector having a known probability distribution. In simple terms, the stochastic programming problem for 1.1 ensures that a given objective which is met at least p₀ percent of time, under constraints met at least pᵢ percent of time, is minimized. This is formulated as:

Minimize T

Subject to P(f₀(x, ξ)≦T)≧p₀

P(fᵢ(x, ξ)≧0)≧pᵢ, ∀ i ε I.

The problem can be formulated only when the probability distribution is known. In some cases, the probability distribution can be estimated with reasonable accuracy from historical data, but this is not true of supply chains.

In robust optimization, the data vector ξ is uncertain, but is bounded—that is, it belongs to a given uncertainty set U. A candidate solution x must satisfy fᵢ(x, ξ)≧0, ∀ ξ ε U, i ε I. So the robust counterpart of 1.1 is:

Minimize T

Subject to f₀(x, ξ)≦T,

fᵢ(x, ξ)≧0, ∀i ε I, ∀ξε U.

In this case we don't have to estimate any probability distribution, but computational tractability of a robust counterpart of a problem is an issue. Also, specification of an intuitive uncertainty set is a problem.

Our approach is a variation of robust optimization. Our formulation bounds U inside a convex polyhedron CP, U ε0 CP. The choice of robust optimization avoids the (difficult) estimation of probability distributions of stochastic programming. The faces and edges of this polyhedron CP are built from simple and intuitive linear constraints, derivable from historical data, which are meaningful in terms of macro-economic behavior and capture the co-relations between the uncertain parameters.

In practice, supply chain management practitioners use a very simple formulation to handle uncertainty. The approaches to handle uncertainty are either deterministic, or use a very modest number of scenarios for the uncertain parameters. As of now, large scale application of either the stochastic optimization or the robust optimization technique is not prevalent.

Model

The model for handling uncertainty is an extension of robust optimization. The uncertainty sets are convex polyhedra made of simple and intuitive constraints derived from historical time series data. These constraints (simple sums and differences of supplies, demands, inventories, capacities etc) are meaningful in economic terms and reflect substitutive/complementary behavior. Not only is the specification of uncertainty is unique, but it they also has the ability to quantify the information content in a polytope.

The constraints are derived from macroscopic economic data such as gross revenue in one year, or total demand in one year, or the percentage of sales going to a competitor in a year etc. The amount of information required to estimate these constraints is far less than the amount of information required to estimate, say, probability distributions for an uncertain parameter. Each of the constraints has some direct economic meaning. The amount of information in a set of constraints can be estimated using Shannon's information theory. The set of constraints represents the area within which the uncertain parameters can vary, given the information that is there in the constraints. If the volume of the convex polytope formed by the constrains is V_{CP}, and assuming that in the lack of information, the parameters vary with equal probability in a large region R of volume Vₘₐₓ, then the amount of information provided by the constraints specifying the convex polytope is given by:

$$I = {log}_{2} ( \frac{{V}_{max}}{{V}_{CP}} )$$

This assumes that all parameter sets are equally likely, if probability distributions of the parameter sets are known, the volume is a volume weighted by the (multidimensional probability density). Our formulation automatically generates a hierarchical set of constraints, each more restrictive than the previous, and evaluates the bounds on the performance parameters in reducing degrees of uncertainty. The amount of information in each of these constraint sets is also quantified using the above quantification. Our formulation also is able to make global changes to the constraints, keeping the amount of information the same, increasing it, reducing, it etc. The formulation is able to evaluate the relations between different constraints sets in terms of subset, disjointness or intersection, relate these to the observed optimum, and thereby help decision support.

While it is recognized that volume computation of convex polyhedra is a difficult problem, for small to medium (10-20) number of dimensions, one can use simple sampling techniques. For time dependent problems, the constraints could change with time, and so would the information—the volume computation will be done in principle at each time step. Computational efficiency can be obtained by looking only at changes from earlier timesteps.

All this is illustrated with an example in Chapter 4. The main contribution of this thesis is incorporation of intuitive demand uncertainty into the capacity/inventory optimization problems in supply chain management. How both static capacity planning and dynamic inventory optimization problems can be incorporated naturally in the present formulation is shown.

Literature Review

The classical technique to handle uncertainty is stochastic programming and extensive work has been done in this field. To solve capacity planning problems under uncertainty, stochastic programming as well as robust optimization has been used extensively. Shabbir Ahmed and Shapiro et. al. [1],[24],[25], have proposed a stochastic scenario tree approach. Robust approaches have been proposed by Paraskevopoulos, Karakitsos and Rustem [23] and Kazancioglu and Saitou [18], but they still assume the stochastic nature of uncertain data. Our work avoids the stochastic approach in general, because of difficulties in P.D.F estimation.

In the 1970's, Soyster [18] proposed a linear optimization model for robust optimization. The form of uncertainty is “column-wise”, i.e., columns of the constraint matrix A are uncertain and are known to belong to convex uncertainty sets. In this formulation, the robust counterpart of an uncertain linear program is a linear program, but it corresponds to the case where every uncertain column is as large as it could be and thus is too conservative. Ben-Tal and Nemirovski [4],[5],[6], and El-Ghaoui [15] independently proposed a model for “row-wise” uncertainty—that is, the rows of A are known to belong to given convex sets. In this case, the robust counterpart of an uncertain linear program is not linear but depends on the geometry of the uncertainty set. For example, if the uncertainty sets for rows of A are ellipsoidal, then the robust counterpart is a conic quadratic program. The geometry of the uncertainty set also determines the computational tractability. They propose ellipsoidal uncertainty sets to avoid the over-conservatism of Soyster's formulation since ellipsoids can be easily handled numerically and most uncertainty sets can be approximated to ellipsoids and intersection of finitely many ellipsoids. But this approach leads to non-linear models. More recently Bertsimas, Sim and Thiele [9], [10], [11] have proposed “row-wise” uncertainty models that not only lead to linear robust counterparts for uncertain linear programs but also allow the level of conservatism to be controlled for each constraint. All parameters belong to a symmetrical pre-specified interval [ a̅ᵢ̅ⱼ̅−â\hat{aᵢⱼ}, a̅ᵢ̅ⱼ̅+â\hat{aᵢⱼ}]. The normalized deviation for a parameter is defined as:

$${z}_{ij} = \frac{{a}_{ij} - \overline{{a}_{ij}}}{{\hat{a}}_{ij}} .$$

The sum of normalized deviation of all the parameters in a row of A is limited by a parameter called the Budget of uncertainty, Γᵢ.

$${\sum }_{j = 1}^{n} \vert {z}_{ij} \vert \leq {Γ}_{i} , ∀ i$$

Γᵢ can be adequately chosen to control the level of conservatism. It is easy to see that if Γᵢ=0, then there is no protection against uncertainty, and when Γᵢ=n, then there is maximum protection. The uncertainty set in this formulation is defined by its boundaries which are 2^{N} in number, where N is the number of uncertain parameters. The polyhedron formed is a symmetrical figure (with appropriate scaling) around the nominal point. This symmetric nature does not distinguish between a positive and a negative deviation, which can be important in evaluating system dynamics (for example poles in the left versus right half plane).

The present work uses intuitive linear constraints, which can be arbitrary in principle. We do not have strong theoretical results about optimality, but are able to experimentally verify the usefulness of the formulation in simplified semi-industrial scale problems with breakpoints in cost and upto a million variables.

For inventory optimization, the classical technique is the EOQ model proposed by Harris [16]in 1913. Only in the 1950's did work on stochastic inventory control begin with the work of Arrow, Harris and Marschak [3], Dvoretzky, Kiefer and Wolfowitz [14], and Whitin [30]. In 1960, Clark and Scarf [13] proved the optimality of base stock policies for linear systems using dynamic programming. Recently Bersimas and Thiele [10], [11], have applied robust optimization to inventory optimization. However their work is limited to symmetric polyhedral uncertainty sets with 2^{N} faces, and is not directly related to economically meaningful parameters. In this work, we extend the classical results and derive both bounds in simple cases, as well as convex optimization formulations for the general case.

Swaminathan and Tayur [28], present an overview of models developed to handle problems in the supply chain domain. They list all the questions that are needed to be answered by a supply chain management system and discuss which models address which of these issues. In the procurement and supplier decisions, our model can be used to answer the following questions: How many and what kinds of suppliers are necessary? How should long-term and short-term contracts be used with suppliers?

In the production decisions, the following questions can be answered: In a global production network, where and how many manufacturing sites should be operational? How much capacity should be installed at each of these sites?

In the distribution decisions, the following questions can be answered: What kind of distribution channels should a firm have? How many and where should the distribution and retail outlets be located? What kinds of transportation modes and routes should be used?

In material flow decisions, the following questions can be answered: How much inventory of different product types should be stored to realize the expected service levels? How often should inventory be replenished? Should suppliers be required to deliver goods just in time?

Theory and Model

Two major optimization problems in supply chain management are long term capacity planning (static problem), and short term inventory control optimization (a dynamic problem). In capacity planning, the entire structure of the supply chain—locations and sizes of factories, warehouses, roads, etc is decided (within constraints). In inventory optimization, we take the structure of the supply chain as fixed, and decide possibly in real-time who to order from, the order quantities, etc. The challenge is to perform these optimizations under uncertainty.

Within this broad framework, many variants of the supply chain and inventory optimization exist. To illustrate the power of the present approach, we have treated representative examples of both problems in this thesis, using the convex polyhedral representation of uncertainty. Our capacity planning work has treated semi-industrial scale problems, with 100's of nodes, resulting in LPs upto 1 million variables. Due to the computational complexity of the dynamic inventory problem, only relatively small problems have been treated.

The results are benchmarked with theoretical analyses—problem specific ones for capacity planning and EOQ extensions for inventory optimization.

We stress that the contributions of this work are the application of the uncertainty ideas in a complete supply chain optimization framework. Our initial focus is on the big picture, the intuitive nature, and the capabilities of the approach using simple techniques, rather than provably optimal methods for one or more subproblems (we do have a number of theoretical results also). Large scale theoretical results will be a major part of the extensions of this work. Some of our results maybe suboptimal, but recall that this whole exercise is optimization under uncertainty—even loose but guaranteed bounds on cost are useful.

### BRIEF DESCRIPTION OF DRAWINGS

FIG. 1 describes a small supply chain;

FIG. 2 describes a Flow at a node;

FIG. 3 describes a Piecewise linear cost model;

FIG. 4 describes the CPLEX screen shot while solving problem in table 1;

FIG. 5 describes the Saw-tooth inventory curve;

FIG. 6 describes the Model of inventory at a node;

FIG. 41 describes an Inventory example 5 solution;

FIG. 42 describes an Inventory example 7 solution;

FIGS. 43, 46 describe a small supply chain;

FIG. 44 describes the allowable demand region;

FIG. 45 describes the output of this mixed integer linear program;

FIG. 47 describes screenshot from the supply chain management software;

FIGS. 48-50 describes graph showing all the constraints for a scenario;

FIG. 51 describes change in the values of the demand objective function with respect to the information content;

FIG. 52 describes change in the range of output demand objective function as constraints are dropped;

FIG. 53, 54 describes the trend for the cost objective function;

FIG. 55 describes SCM graph viewer;

FIGS. 56, 57 describes constraint manager module;

FIGS. 58, 59 describes information estimation module;

FIGS. 60-65 describe the graphical visualizer module;

FIG. 66 describes the capacity planning module;

FIG. 67 describes the output analyzer;

FIG. 68 describes the screen shot for the bidder;

FIGS. 69 and 70 describe the screen shot for the auctioneer;

FIG. 71 describes least square technique;

FIG. 72 describes Constraint prediction for data set for a single dimension;

FIG. 73 describes Constraint prediction for data set for two dimensions;

FIGS. 74, 75 and 76 describe Graphical representation of a constraint set;

FIGS. 77-80 describes possible resulting scenarios by distorting a polytope while keeping the volume fixed;

FIG. 81 describes a Decision Support System;

FIG. 82 describes an embodiment of the ideas in a real-time supply chain control system;

FIG. 83 describes an Input Analysis Phase;

FIG. 84 describes a Constraint Transformation;

FIG. 85 describes a Simple Example of Constraint Transformation;

FIG. 86 describes a Constraint Prediction;

FIG. 87 describes a Time Series of Relations, together with inter-polytope max distances as explained in text. Min distances can also be computed, but are not shown for clarity;

FIG. 88 describes Constraints in Contracts;

FIG. 89 describes one example of Sense and Response action—Generalized Basestock;

FIG. 90 describes an Input-Output Uncertainty and correlation analysis; and

FIG. 91 describes a Screen shot of the input-output analyzer module for a small supply chain.

### DETAILED DESCRIPTION OF THE INVENTION

Capacity Planning

Introduction

A supply chain is a network of suppliers, production facilities, warehouses and end markets. Capacity planning decisions involve decisions concerning the design and configuration of this network. The decisions are made on two levels: strategic and tactical. Strategic decisions include decisions such as where and how many facilities should be built and what their capacity should be. Tactical decisions include where to procure the raw-materials from and in what quantity and how to distribute finished products. These decisions are long range decisions and a static model for the supply chain that takes into account aggregated demands, supplies, capacities and costs over a long period of time (such as a year) will work.

From a theoretical viewpoint, the classical multi-commodity flow model [Ahuja-Orlin [2]] is the natural formulation for capacity planning. However, in practice a number of non-convex constraints like cost/price breakpoints and binary 0/1 facility location decisions change the problem from a standard LP to an non-convex LP problem, and heuristics are necessary for obtaining the solution even with state-of-the-art programs like CPLEX. Theoretical results on the quality of capacity planning results do exist, and refer primarily to efficient usage of resources relative to minimum bounds. For example, one can compare the total installed capacity with respect to the actual usage (utilization), total cost with respect to the minimum possible to meet a certain demand, etc.

The Supply Chain Model: Details

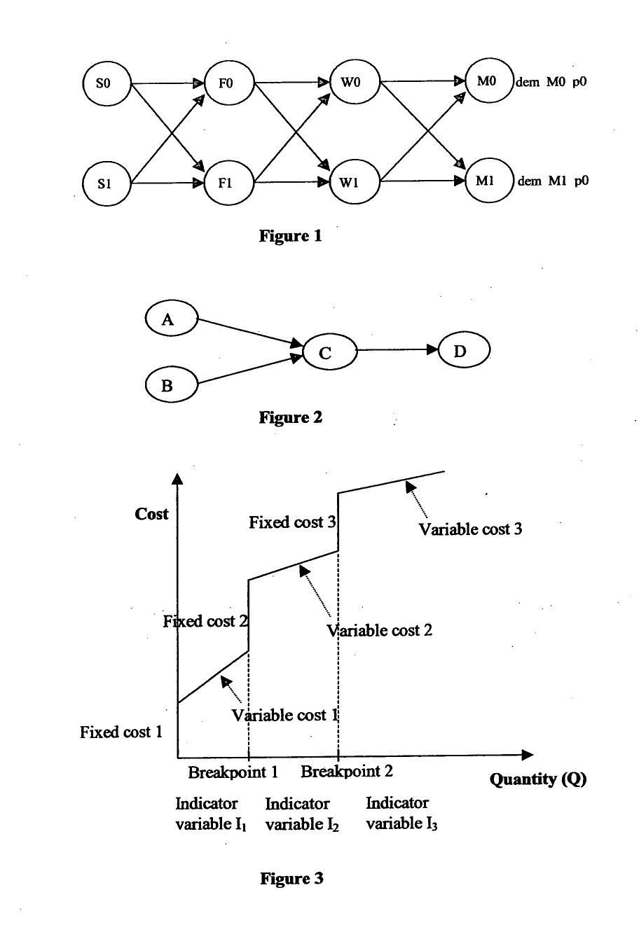

In our simple generic example, to design a supply chain network, we make location and capacity allocation decisions. We have a fixed set of suppliers and a fixed set of market locations. We have to identify optimal factory and warehouse locations from a number of potential locations. The supply chain is modeled as a graph where the nodes are the facilities and edges are the links connecting those facilities. The model will work for linear, piece-wise linear as well as non-linear cost functions. FIG. 1 gives a general supply chain structure.

In general the supply chain nodes can have complex structure. We distinguish two major classes: AND and OR nodes, and their behaviour¹. [symbol] not claim to be consisten

[symbol]

OR Nodes: At the OR nodes, the general flow equation holds. Here, the sum of inflow is equal to the sum of outflow and there is no transformation of the inputs. The output is simply all the inputs put together. A warehouse node is usually an OR node. For example a coal warehouse might receive inputs from 5 different suppliers. The input is coal and the output is also coal and even if fewer than 5 suppliers are supplying at some time, then also output from the warehouse an be produced.

In FIG. 2, if C is an OR node, then the equations of flow through the node C will be as follows:

φ_{CD}=φ_{AC}+φ_{BC}

AND nodes: At the AND nodes, the total output is equal to the minimum input. A factory is usually an AND node. It takes in a number of inputs and combines them to form some output. For example a factory producing toothpaste might take calcium and fluoride as inputs. Output from the factory can only be produced when both the inputs are being supplied to the factory. Even if the amount of one input is very large, the output produced will depend on the quantity of other input which is being supplied in smaller amounts. The flow equation for node C in the figure, if C is an AND node will be as follows:

φ_{CD}=min(φ_{AC},φ_{BC})

The total cost of the supply chain is divided into 4 parts
1. Fixed capital expenses for the nodes: the cost of building the factory or warehouse
2. Fixed capital expenses for the edges: the cost of building the roads
3. Operational expenses for nodes
4. Transportation expenses for the edges

The following notations are used in the model:

S=Number of supplier nodes

M=Number of market nodes

P=Number of products

X=Number of intermediate stages

Nₓ=Number of potential facility locations in stage x

E=Number of edges

Cᵢⱼ^{p}(Q)=Cost function for node j in stage i of the supply chain

Cₖ^{p}(Q)=Cost function for edge k of the supply chain

Qᵢⱼ^{p}=Quantity of product p processed by node j in stage i

Qₖ^{p}=Quantity of product p transported over edge k

Qᵢⱼ₋ₘₐₓ=Maximum capacity of node j in stage i

Qₖ₋ₘₐₓ=Maximum capacity of edge k

Φₗₘ^{p}=Flow of product p between node l and node m

Fᵢⱼ=Fixed capital cost of building node j in stage i of the supply chain

Fₖ=Fixed capital cost of building edge k in the supply chain

uⱼ=Indicator variable for entity j in the supply chain, i.e., uⱼ=1 if entity j is located at site j, 0 otherwise

The goal is to identify the locations for nodes in the intermediate stages as well as quantities of material that is to be transported between all the nodes that minimize the total fixed and variable costs.

The problem can be formulated mathematically as follows (see below also): Minimize (w.r.t optimizable parameters):

$${Max}_{demand , supply} ( \begin{matrix}{\sum }_{i = 1}^{X} ( {\sum }_{j = 1}^{{N}_{i}} {u}_{ij} {F}_{ij} ) + {\sum }_{k = 1}^{E} {u}_{k} {F}_{k} + \\ {\sum }_{i = 1}^{X} ( {\sum }_{j = 1}^{{N}_{i}} ( {\sum }_{p = 1}^{P} {C}_{ij}^{p} ( {Q}_{ij}^{p} ) ) ) + {\sum }_{k = 1}^{E} ( {\sum }_{p = 1}^{P} {C}_{k}^{p} ( {Q}_{k}^{p} ) )\end{matrix} )$$

Subject to:

$${\sum }_{p = 1}^{P} {Q}_{k}^{p} \leq {Q}_{k - max} for all k = 1 , … , E$$

$${\sum }_{p = 1}^{P} {Q}_{ij}^{p} \leq {Q}_{ij - max} for all i = 1 , … , X and j = 1 , … , {N}_{X}$$

$${\sum }_{l ∈ Pred ( m )}^{ } {Φ}_{lm}^{p} = {\sum }_{n ∈ Succ ( m )}^{ } {Φ}_{mn}^{p} for all m = 1 , … , {N}_{X} , \\ for all x = 1 , … , X$$

$${\sum }_{l ∈ Pred ( m )}^{ } {Φ}_{lm}^{p} = {Dem}_{m}^{p} for all p = 1 , … , P and m = 1 , … , M$$

Demand constraints (see below)
Supply constraints (see below)

This minimax program is in general not a linear or integer linear optimization (weak duality can be used to get a bound, but strong duality may not hold due to the nonconvex cost, profit functions having breakpoints). The absolute best case (best decision, best demands and supplies) and worst case (worst decision, worst demands and supplies) can be found using LP/ILP techniques. We stress that even this information is very useful, in a complex supply chain framework.

However, note the following. The key idea in our approach is that we use linear constraints to represent uncertainty. Sums, differences, and weighted sums of demands, supplies, inventory variables, etc, indexed by commodity, time and location can all be intermixed to create various types of constraints on future behaviour. Integrality constraints on one or more uncertain variables can be imposed, but do result in computational complexities.

Given this, we have the following advantages of our approach:
The formulation is quite intuitive and economically meaningful, in the supply chain context. Many kinds of future uncertainty can be specified.
Bounds can be quickly given on any candidate solution using LP/ILP, since the equations are then linear/quasi-linear in the demands/supplies/other params, which are linearly constrained (or using Quadratic programming with quadratic constraints). The best case, best decision and worst case, worst decision are clearly global bounds, solved directly by LP/ILP.
The candidate solution is arbitrary, and can incorporate general constraints (e.g set-theoretic) not easily incorporated in a mathematical programming framework (formally specifying them could make the problem intractable).
Multiple candidate solutions can be obtained in one of several ways, and the one having the lowest worst case cost selected. These solutions can be obtained by:
   Randomly sampling the solution space: A feasible solution in the supply chain context can be obtained by solving the deterministic problem for a specific instance with a random sample of demand and other parameters. The computational complexity is that of the deterministic problem only. A number of solutions can be sampled, and the one having the lowest worst-case cost selected. While the convergence of this process to the Min-max solution is still an open problem, note that our contribution is the complete framework, and the tightest bound is not necessarily required in an uncertain setting.
   Successively improving the worst case bound.
      1. A candidate solution is found (initially by sampling, say), and its worst case performance is determined at a specific value of the uncertain parameters (demand, supply, . . . ).
      2. The best solution for that worst case parameter set is determined by solving a deterministic problem. This is treated as a new candidate solution, and step 1 is repeated.
      3. The process stops when new solutions do not decrease the worst case bound significantly, or when an iteration limit has been reached.

In passing we note that the availability of multiple candidate solutions can be used to determine bounds for the a-posteriori version of this optimization. How much is the worst case cost, if we make an optimal decision after the uncertain parameters are realized? This is very simply incorporated in our cost function C( ), by using at each value of the uncertain parameters, a new cost function which is the minimum of all these solutions. This retains the LP/ILP structure of the problem of determining best/worst case bounds given candidate solutions.

C(Demands,Supplies, . . . )=min(C₁(Demands, Supplies, . . . ), C₂(Demands, Supplies, . . . ), . . . )

These same comments apply for the inventory optima ion problem also.

Contrasting this with the probabilistic approach, even if an optimal sets of decisions (candidate solution) is given, at the minimum, the pdf's governing the uncertain parameters will in general have to be propagated through an AND-OR tree, which can be computationally intensive.

For handling the full min/max optimization, at this time of writing, we have implemented sampling. We take a number of candidate solutions, evaluate the best/worst cost and select the best w.r.t the worst case cost (the best w.r.t the best case cost can be found by LP/ILP). The worst/worst estimate (solved by an LP/ILP) is used as an upper bound for this search. The solutions can be improved using simulated annealing, genetic algorithms, tabu search, etc. While this approach is generally sub-optimal, we stress that the objective of this thesis is to illustrate the capabilities of the complete formulation, even with relatively simple algorithms. In addition, these stochastic solution methods can incorporate complex constraints not easily incorporated in a mathematical optimization framework (but the representation of uncertainty is very simple to specify mathematically).

We next discuss the nature of the demand constraints—supply constraints are similar and will be skipped for brevity.

Demand Constraints

Bounds: these constraints represent a-priori knowledge about the limits of a demand variable.

Min1≦d₁≦Max1

Complementary constraints: these constraints represent demands that increase or decrease together.

Min2≦d₁−d₂≦Max2

Substitutive constraints: these constraints represent the demands that cannot simultaneously increase or decrease together.

Min3≦d₁+d₂≦Max3

Revenue constraints: these constraints bound the total revenue, i.e. the price times demand for all products added up is constrained.

Min4≦k₁d₁+k₂ d₂+ . . . Max4

If both the price (ki) and the demand (di) are variable, then the constraint becomes a quadratic, and convex optimization techniques are required in general.

Note that the variables in these constraints can refer to those at a node/edge, at all nodes/edges, or any subset of nodes or edges.

The Cost Function for the Model

In general the cost function will be non-linear. The costs can be additive—that is, the total cost is the sum of the costs of the sub systems or can be non-additive—that is, the cost of the whole system is not separable into costs for its constituent subsystems. For a dpᵢpmic system, the total cost will be the sum of costs over all the time periods. We consider the case of a cost-function with break points for a static system in this section. The costs are additive. This is modeled using indicator variables as per standard ILP methods. The cost function becomes a linear function of these indicator variables. Linear inequality constraints are added to ensure that the values of the indicator variables represent the correct cost function. FIG. 3 shows a graphical representation of the cost function.

From standard integer linear programming principles, the cost function can be written using the following formulation:

b=Number of breakpoints

Q=Quantity processed

Total Cost=Fixed cost+Variable cost

Indicator Variables:

I₁>0 if Q>0=0; if Q=0

Iᵢ>0; if Q>Breakpointᵢ₋₁=0; if Q<Breakpointᵢ₋₁, for all i=2, . . . , b,

$$Fixed cost = {\sum }_{i = 1}^{b + 1} ( {I}_{i} \times {Fixed\_cost}_{i} )$$

Where the indicator variables Iᵢ are constrained as follows:

Iᵢ×M≧(Q−Breakpointᵢ₋₁)

(Iᵢ−1)M<(Q−Breakpointᵢ₋₁)

Where Breakpoint₋₁=0

$$Variable cost = ( Q \times {Variable\_cost}_{1} ) + {\sum }_{i = 1}^{b} ( Q - {Breakpoint}_{i} ) \times ( {Variable\_cost}_{i + 1} - {Variable\_cost}_{i} )$$

Here, (Q−Breakpointᵢ)=(Q−Breakpointᵢ) if Q>=Breakpointᵢ

Else, (Q−Breakpointᵢ)=0

So we replace Q by another variable Z₁ and all (Q−Breakpointᵢ) by Zᵢ such that:

$$Variable cost = ( {Z}_{1} \times {Variable\_cost}_{1} ) + {\sum }_{i = 1}^{b} ( {Z}_{i + 1} \times ( {Variable\_cost}_{i + 1} - {Variable\_cost}_{i} ) )$$

Where, Zᵢ variables are constrained as follows:

Zᵢ≧(Q−Breakpointᵢ₋₁)

Zᵢ≧0

where Breakpoint₋₁=0

Solution of the Optimization Problems:

The integer linear programs resulting from the above model are solved using CPLEX. The size of the problems can be very large, and hence heuristics are in general required for industrial scale problems. At the time of writing, we have been able to tackle problems with the following statistics:

TABLE 1
Problem statistics for a semi-industrial scale problem

| | Prod- | Break- | Varia- | Con- | Integer | LP file | Time |
|---|---|---|---|---|---|---|---|
| Nodes | ucts | points | bles | straints | variables | size | taken |
| 40 | 2000 | 0 | 970030 | 1280696 | 320000 | 97.1 MB | 600.77 |
| | | | | | | | sec |

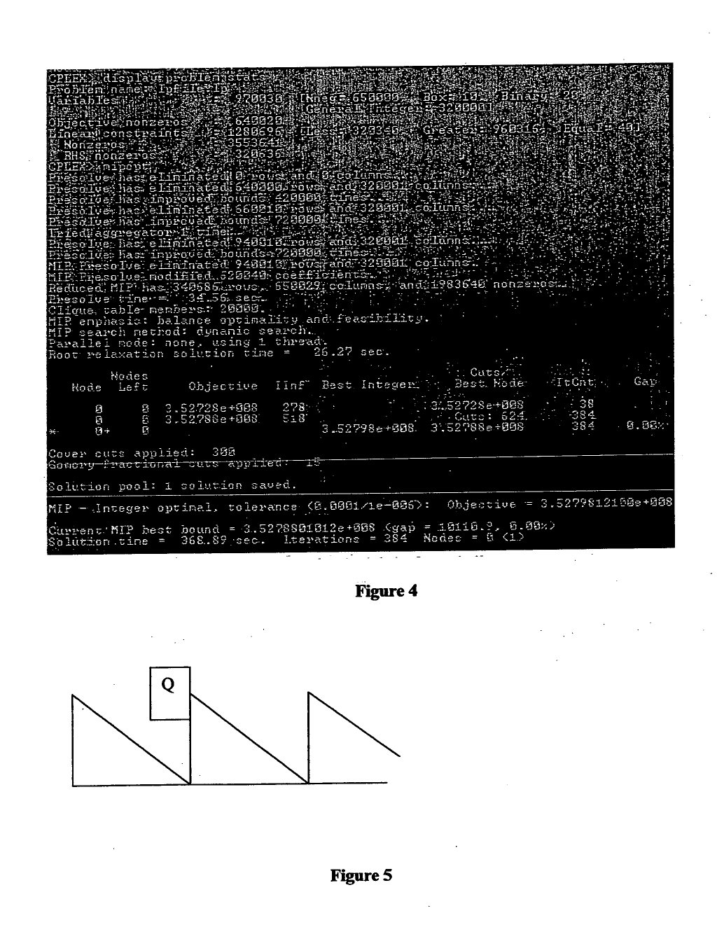

The screen shot of CPLEX solver while solving the above problem is given in FIG. 4.

Inventory Optimization

Extensions to Classical Inventory Theory

The literature on inventory optimization is very rich, and these results can be extended using our formulation. Several classical results from inventory theory can be reformulated using our representation of uncertainty. We begin with the classical EOQ model [13], [16], [17] wherein an exogenous demand D for a Stock Keeping Unit (SKU) has to be optimally serviced. A per order fixed cost f(Q) and holding cost per unit time h(Q) exists. Note that h(Q) need not be linear in Q, convexity [12] is enough. For non-convex costs—for example, with breakpoints, we have to use numerical methods—analytical formulae are not easily obtained. We shall deal with non-convex costs in the Chapter 4 (Experimental results). Our notation allows the fixed cost f(Q) to vary with the size of the order Q, under the constraint that it increases discontinuously at the origin Q=0.

The results in this section can be used both to correlate with the answers produced by the optimization methods for simple problems, as well as provide initial guesses for large scale problems with many cost breakpoints, etc. In addition, these methods can be quickly used to get estimates of both input and output information content, following the methods in the Introduction section. The input information is computed using the input polytope, and the output information is computed using bounds on a variety of different metrics spanning the output space.

As shown in FIG. 5, the total cost per unit time is clearly given by the sum of the holding h(Q) and the fixed costs f(Q), and can be written as the sum of fixed costs per order and holding (variable costs) per unit time. Classical techniques enable us to determine EOQ for each SKU independently, by classical derivative based methods. The standard optimizations yield the optimal stock level Q* and cost C*(Q*) proportional to the square root of the demand per unit time.

C(Q)=h(Q)+f(Q)(D/Q)

Q*=\sqrt{2fD/h;}C*(Q)=\sqrt{2fDh}

Our representation of uncertainty in the form of constraints generalizes these optimizations using constraints between different variables as follows.

Firstly, meaningful constraints on demands in a static case require at least two commodities, else we get max/min bounds on demand of a single commodity, which can be solved by plugging in the max/min bounds in the classical EOQ formulae. Hence below the simplest case is with two commodities. In a dyrwmic setting, where the demand constraints are possibly changing over time, these two demands can be for the same commodity at different instants of time:

Additive SKU Costs

In the simplest case, we assume that the costs of holding inventory are additive across commodities, and we have (first for the 2-dimensional and then the N-dimensional case, with 2 and N SKU's respectively)

$${C}_{1} ( {Q}_{1} , {D}_{1} ) = {h}_{1} ( {Q}_{1} ) + {f}_{1} ( {Q}_{1} ) ( {D}_{1} / {Q}_{1} ) \\ {C}_{2} ( {Q}_{2} , {D}_{2} ) = {h}_{2} ( {Q}_{2} ) + {f}_{2} ( {Q}_{2} ) ( {D}_{2} / {Q}_{2} ) \\ C ( {Q}_{1} , {Q}_{2} , {D}_{1} , {D}_{2} ) = {C}_{1} ( {Q}_{1} ) + {C}_{2} ( {Q}_{2} ) \\ [ {D}_{1} , {D}_{2} ] ∈ CP \\ {C}^{*} ( {D}_{1} , {D}_{2} ) = {min}_{{Q}_{1} , {Q}_{2}} C ( {Q}_{1} , {Q}_{2} , {D}_{1} , {D}_{2} ) \\ {C}_{i} ( {Q}_{i} , {D}_{i} ) = ( {h}_{i} ( {Q}_{i} ) + {f}_{i} ( {Q}_{i} ) ( {D}_{i} / {Q}_{i} ) ) \\ C ( {Q}_{1} , {Q}_{2} , … , {D}_{1} , {D}_{2} , … ) = {\sum }_{i}^{ } {C}_{i} ( {Q}_{i} ) \\ [ {D}_{1} , {D}_{2} , … ] ∈ CP \\ {C}^{*} ( {D}_{1} , {D}_{2} , … ) = {min}_{{Q}_{1} , {Q}_{2} , …} C ( {Q}_{1} , {Q}_{2} , … , {D}_{1} , {D}_{2} , … ) \qquad EQUATION ( 1 )$$

We shall discuss the implications of Equation (1) in detail below

A. Inventory Levels Unconstrained by Demand

Consider the 2-D case (the results easily generalize for the N-D case). Under our assumptions, Q₁ and Q₂ are to be chosen such that the cost is minimized If there are no constraints on relating Q₁ and Q₂, or Qᵢ and Dᵢ, then we can independently optimize Q₁, and Q₂ with respect to D₁ and D₂, and the constraints CP will yield a range of values for the cost metric C₁+C₂. In general, as long as Q₁ and Q₂ are independent of D₁ and D₂ (meaning thereby that there is no constraint coupling the demand variables with the inventory variables), then Q₁ and Q₂ can be optimized independently of the demand variables. Then the uncertainty results in a range of the optimized cost only.

Cₘₐₓ=max_{[D}_{₁}_{,D}_{₂}_{]∈CP}[C^{*}(D₁,D₂)]=

=max_{[D}_{₁}_{,D}_{₂}_{]∈CP}[min_{Q}_{₁}_{,Q}_{₂}C(Q₁,Q₂,D₁,D₂)]

Cₘₐₓ=min_{[D}_{₁}_{,D}_{₂}_{]∈CP}[C^{*}(D₁,D₂)]=

=min_{[D}_{₁}_{,D}_{₂}_{]∈CP}[min_{Q}_{₁}_{,Q}_{₂} C(Q₁,Q₂,D₁,D₂)]

A.1 Linear Holding Costs

If the holding cost is linear in the inventory quantity Q, and the fixed cost is constant, the classical results [17] readily generalize to:

Q₁^{*}=\sqrt{2f₁D₁/h₁:}C₁^{*}(D₁)=\sqrt{2f₁D₁h₁}

Q₂^{*}=\sqrt{2f₂D₂/h₂;}C₂^{*}(D₂)=\sqrt{2f₂D₂h₂}

C*(D₁,D₂)=C₁*(D₁)+C₂*(D₂)=\sqrt{2f₁D₁h₁}+\sqrt{2f₂D₂h₂}

Cₘₐₓ=max_{[D}_{₁}_{,D}_{₂}_{]∈CP} [\sqrt{2f₁D₁h₁}+\sqrt{2f₂D₂h₂}]

Cₘᵢₙ=min_{[D}_{₁}_{,D}_{₂}_{]∈CP} [\sqrt{2f₁D₁h₁}+\sqrt{2f₂D₂h₂}]

Cₘₐₓ and Cₘᵢₙ are clearly convex functions of D₁ and D₂, and can be found by convex optimization techniques.

A.1.1 Substitutive Constraint-Equalities

For example, under a substitutive constraint D₁+D₂=D, it is easy to show that:

$${C}^{*} ( {D}_{1} , {D}_{2} ) = {C}_{1}^{*} ( {D}_{1} ) + {C}_{2}^{*} ( {D}_{2} ) = \sqrt{2 {f}_{1} {D}_{1} {h}_{1}} + \sqrt{2 {f}_{2} {D}_{2} {h}_{2}}$$

$${D}_{1} + {D}_{2} = D \\ ⇒ \\ {C}_{max} = {C}^{*} ( \frac{{f}_{1} {h}_{1} D}{{f}_{1} {h}_{1} + {f}_{2} {h}_{2}} , \frac{{f}_{2} {h}_{2} D}{{f}_{1} {h}_{1} + {f}_{2} {h}_{2}} ) = \sqrt{2 D ( {f}_{1} {h}_{1} + {f}_{2} {h}_{2} )}$$

$${C}_{min} = min ( {C}^{*} ( 0 , D ) , {C}^{*} ( D , 0 ) ) = \sqrt{2 D min ( {f}_{1} {h}_{1} , {f}_{2} {h}_{2} )}$$

Under a complementary constraint D₁−D₂=K, with D₁ and D₂ limited to Dₘₐₓ, have the maximal/minimal cost as

Cₘₐₓ=C^{*}(f₁h₁Dₘₐₓ,f₂h₂(Dₘₐₓ−D))

Cₘᵢₙ=C^{*}(f₁h₁D,0)

A.1.2 Substitutive and Complementary Constraints: Inequalities

If we have both substitutive and complementary constraints, which are inequalities, a convex polytope CP is the domain of the optimization. We get in the 2-D case equations of the form:

$${C}^{*} ( {D}_{1} , {D}_{2} ) = {C}_{1}^{*} ( {D}_{1} ) + {C}_{2}^{*} ( {D}_{2} ) = \sqrt{2 {f}_{1} {D}_{1} {h}_{1}} + \sqrt{2 {f}_{2} {D}_{2} {h}_{2}}$$

$$CP \text{:} ( \begin{matrix}{D}_{min} \leq {D}_{1} + {D}_{2} \leq {D}_{max} \\ - Δ \leq {D}_{1} + {D}_{2} \leq Δ\end{matrix} \\ {C}_{max} = {max}_{[ {D}_{1} , {D}_{2} ] ∈ CP} [ \sqrt{2 {f}_{1} {D}_{1} {h}_{1}} + \sqrt{2 {f}_{2} {D}_{2} {h}_{2}} ] \\ {C}_{min} = {min}_{[ {D}_{1} , {D}_{2} ] ∈ CP} [ \sqrt{2 {f}_{1} {D}_{1} {h}_{1}} + \sqrt{2 {f}_{2} {D}_{2} {h}_{2}} ]$$

Convex optimization techniques are required for this optimization. The same applies if we have a number of equalities in addition to these inequalities.

B. Constrained Inventory Levels

If the inventory levels Qᵢ and demands Dᵢ, are constrained by a set of constraints written in vector form for 2-D as:

Φ̅[̅Q̅₁̅,̅Q̅₂̅,̅D̅₁̅,̅ D̅₂̅]<=\vec{0}

where Φ[ ] is a vector of constraints. then the minimization is more complex, and the set of equations (1) has to be viewed as a convex optimization problem ( . . . ), and solved using convex optimization techniques developed during the last two decades [4],[12]. The vector constraint above can incorporate constraints like
Limits on total inventory capacity (Q₁+Q₂<=Qₜₒₜ)
Balanced inventories across SKUs (Q₁−Q₂)<=□
Inventories tracking demand (Q₁−D₁<=□Dₘₐₓ)

Equations 1 can then be written as

C₁(Q₁,D₁)=h₁(Q₁)+f₁(Q₁)(D₁/Q₁)

C₂(Q₂,D₂)=h₂(Q₂)+f₂(Q₂)(D₂/Q₂)

C(Q₁,Q₂,D₁,D₂)=C₁(Q₁)+C₂(Q₂)

[D₁,D₂] ∈ CP

Φ̅[̅Q̅₁̅,̅Q̅₂̅,̅D̅₁̅,̅D̅₂̅]̅<=\vec{0}

C*(D₁,D₂)=min_{Q}_{₁}_{,Q}_{₂} C(Q₁,Q₂,D₁,D₂)

Cₘₐₓ=max_{[D}_{₁}_{,D}_{₂}_{]∈CP}[C*(D₁,D₂)]

An example is furnished later in Chapter 4.

Non Additive (Non Separable) Costs:

In this case, the costs cannot be separately added and the problem has to be solved as a coupled optimization problem, namely:

[D₁, D₂] ∈ CP

Φ̅[̅Q̅₁̅,̅Q̅₂̅,̅D̅₁̅,̅D̅₂̅]×<=\vec{0}

C*(D₁,D₂)=min_{Q}_{₁}_{,D}_{₂}_{9∈CP}C*(D₁,D₂)

Cₘᵢₙ=min_{[D}_{₁}_{,D}_{₂}_{]∈CP} C*(D₁,D₂)

Convex optimization techniques are required. -.

Time Dependent Constraints

So far we have treated a static problem, where the demand values D₁, D₂, . . . are constant in time, the values being unknown but constrained, and the constraints do not change with time (Equation -). It is straightforward to extend these results to time varying demand constraints. Classically this is treated by probabilistic [13], or robust optimization methods [10], [11], and either the mean or the worst case/best case value of the total cost is minimized. Our formulation can be easily generalized to incorporate this time variance by changing the constraints on the demand vector over time.

We assume a discrete time model for simplicity. Let D_{c}^{t} denote the demand for commodity “c” at time “t”. In a static scenario, these demands are constrained by linear (or nonlinear) equations. If there are N demand variables and M constraints, we have

$$[ {D}_{1} , {D}_{2} , … , {D}_{N} ] ∈ CP$$

$$CP \text{:} {\sum }_{i}^{ } {α}_{ij} {D}_{i} \leq K , i = \{ 1 , 2 , … N \} , j = \{ 1 , 2 , … M \}$$

where the time superscript has been dropped in this static case. EOQ can be found for this set, following procedures outlined in Equation 1. Similar methods can be used if there are correlations between demand and, inventory variables.

In the dynamic case, the convex polytope keeps changing, and so does the EOQ (in fact it is not strictly accurate to speak of a single EOQ for any commodity, since the process is non-stationary, when viewed in the probabilistic framework). If the constraints do not relate variables at different timesteps, we have

$$[ {D}_{1}^{t} , {D}_{2}^{t} , … , {D}_{N}^{t} ] ∈ {CP}_{t}$$

$$CP \text{:} {\sum }_{i}^{ } {α}_{ij}^{t} {D}_{i}^{t} \leq {K}^{t} , i = \{ 1 , 2 , … N \} , j = \{ 1 , 2 , … M \}$$

Here again, we can speak of an EOQ which changes with time Similar methods can be used if there are correlations between demand and inventory variables for one time step.

The situation is more complex when there are correlations between variables at different time instants (between demand/inventory at one timestep and demand/inventory at another timestep). Considering a finite time horizon, an appropriate metric has to be formulated for optimization.

A. Additive Costs

For simplicity, we discuss the case of separable and additive costs [7], but our work can be generalized for the case of non-additive and non-separable costs, the optimizations imposing heavier computational load. The equations become:

$${C}_{1} ( {Q}_{1}^{t} , {D}_{1}^{t} ) = {h}_{1} ( {Q}_{1}^{t} ) + {f}_{1} ( {Q}_{1}^{t} ) ( {D}_{1}^{t} / {Q}_{1}^{t} )$$

$${C}_{2} ( {Q}_{2}^{t} , {D}_{2}^{t} ) = {h}_{2} ( {Q}_{2}^{t} ) + {f}_{2} ( {Q}_{2}^{t} ) ( {D}_{2}^{t} / {Q}_{2}^{t} )$$

$${C}^{t} ( {Q}_{1}^{t} , {Q}_{2}^{t} , {D}_{1}^{t} , {D}_{2}^{t} ) = {C}_{1} ( {Q}_{1}^{t} , {D}_{1}^{t} ) + {C}_{2} ( {Q}_{2}^{t} , {D}_{2}^{t} )$$

$${Q}_{i}^{t} = {Q}_{i}^{0} - {\sum }_{k = 1 … ( t - 1 )}^{ } {D}_{i}^{k} \\ [ \begin{matrix}{Q}_{1}^{1} , {Q}_{1}^{2} , … , {Q}_{1}^{t} , {Q}_{2}^{1} , {Q}_{2}^{2} , … , {Q}_{2}^{t} , … , \\ {D}_{1}^{1} , {D}_{1}^{2} , … , {D}_{1}^{t} , {D}_{2}^{1} , {D}_{2}^{2} , … , {D}_{2}^{t}\end{matrix} ] ∈ CP$$

$${C}^{tot} ( \vec{Q} , \vec{D} ) = {\sum }_{t}^{ } {C}^{t} ( {Q}_{1}^{t} , {Q}_{2}^{t} , {D}_{1}^{t} , {D}_{2}^{t} ) \\ {C}^{max} ( {D}_{1} , {D}_{2} ) = {max}_{\vec{Q} , \vec{D}} {C}^{tot} ( \vec{Q} , \vec{D} ) \\ {C}^{min} ( {D}_{1} , {D}_{2} ) = {min}_{\vec{Q} , \vec{D}} {C}^{tot} ( \vec{Q} , \vec{D} )$$

The above section was an analytic discussion of lower bounds in inventory theory generalized under convexity assumptions, using our formulation of uncertainty. The next section discusses an exact method—the (mathematical formulation for the inventory optimization problem.

The Inventory Optimization Model

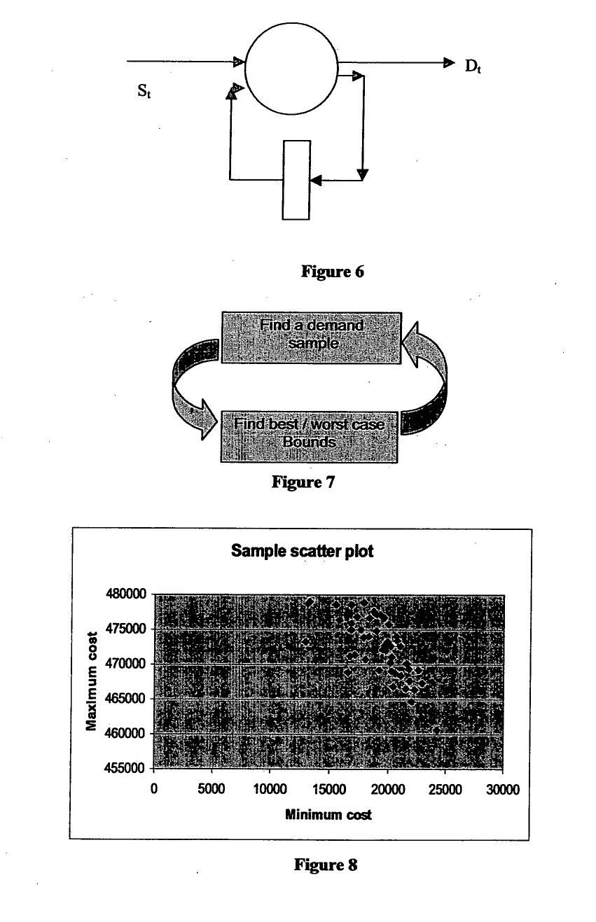

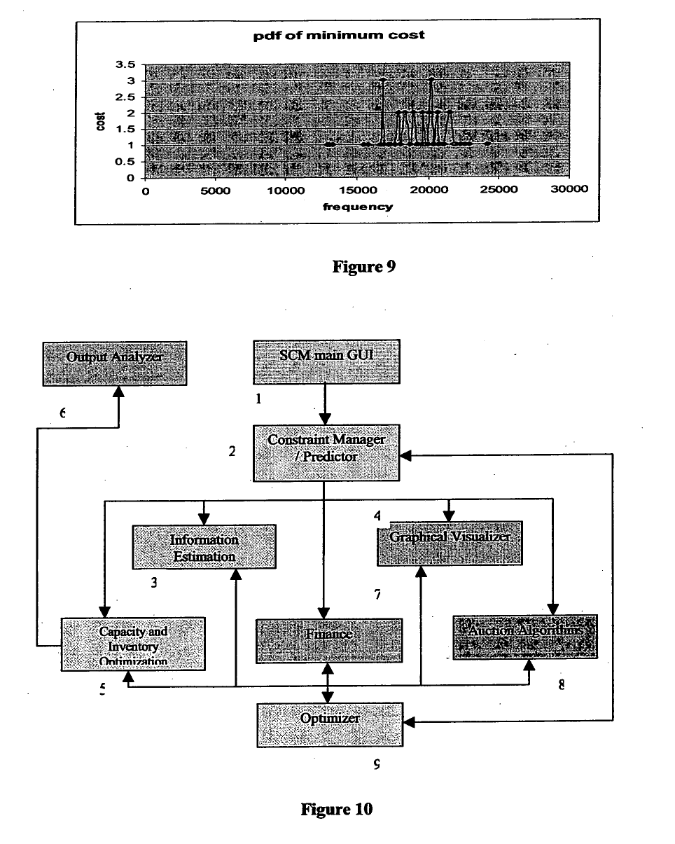

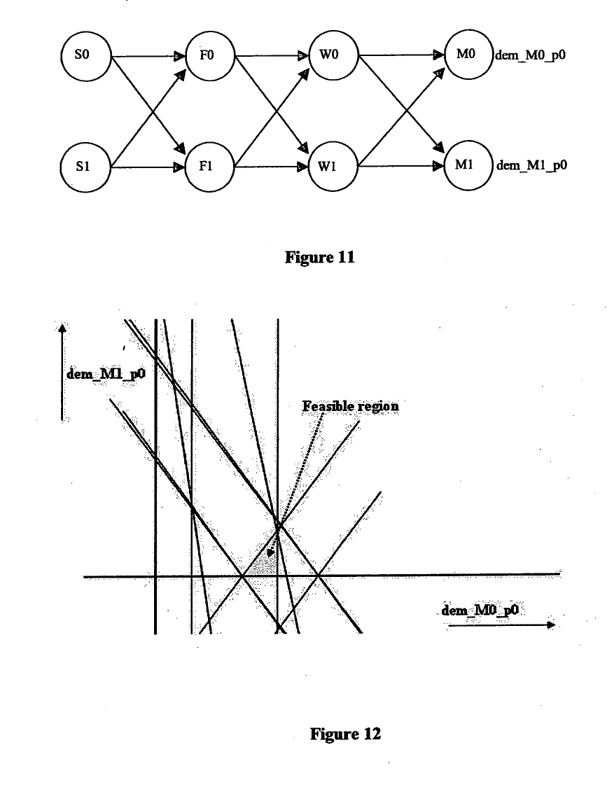

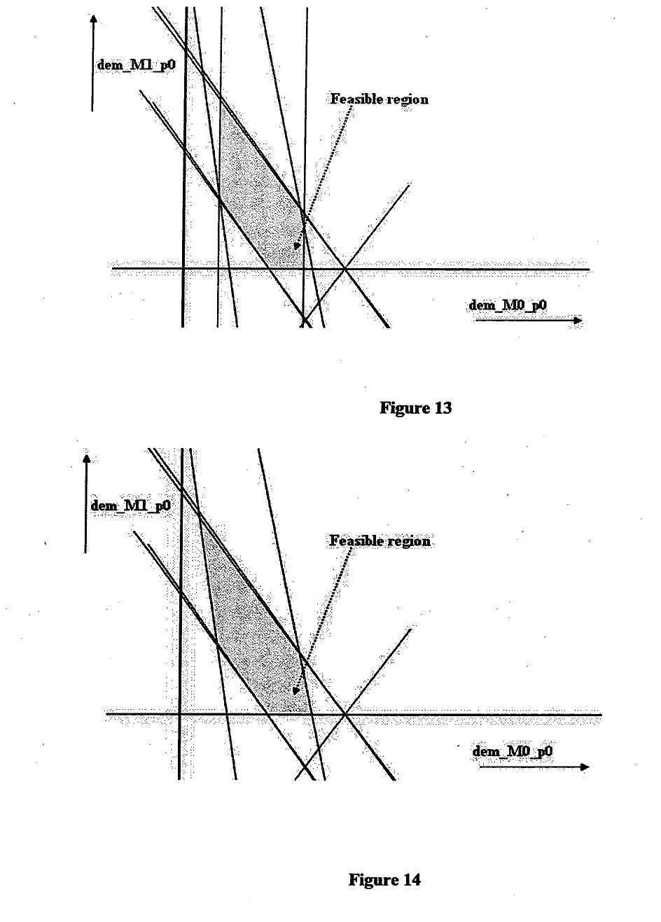

For simplicity, we shall discuss the inventory optimization at a single node, but our results extend straightforwardly to arbitrary sets of nodes. Consider the inventory at time t at a single node in a supply chain (see FIG. 6). We define:

Invₜ=inventory at the beginning of the time period t

Dₜ=demand in period t

Sₜ=amount ordered in the beginning of time period t

The system evolves over time and can be described by the following equation.

Invₜ₊₁=Invₜ+Sᵢ−Dₜ

For system with N products, the equation becomes:

Invₜ₊₁^{p}=Invₜ^{p}+Sₜ^{p}Dₜ^{p}, for all p=1, . . . , N

The cost incurred at every time step includes:
1. Holding cost h per unit inventory (shortage cost s if stock is negative).
2. A fixed ordering cost per order C.

The cost function for the system consists of the holding/shortage cost and the ordering cost for all the products summed over all the time periods. This cost has to be minimized when the demand is not known exactly but the bounds on the demand are known. The problem can be formulated as the following mathematical programming problem:

$${Minimize}_{decision} {Max}_{demand , supply ,} ( {\sum }_{p = 1}^{N} ( {\sum }_{t = 0}^{T - 1} ( {I}_{t}^{p} \times {C}^{p} ) + {\sum }_{t = 0}^{T - 1} {y}_{t}^{p} ) )$$

Subject to yₜ^{p}≧hₜ^{p}(Invₜ₊₁^{p})

yₜ^{p}≧−sₜ^{p}(Invₜ₊₁^{p})

(Iₜ^{p}−M)≧Sₜ^{p}

(Iₜ^{p}−1)M<Sₜ^{p}

Invₜ₊₁^{p}=Invₜ^{p}+Sₜ^{p}−Dₜ^{p}

Sₜ^{p}≧0
Demand constraints
Supply constraints
Capacity constraints
Inventory constraints

This minimax program is in general not a linear or integer linear optimization, and the comments on capacity planning problems (using duality to obtain bounds, sampling, . . . ) in Section 2.1.2 apply. While this approach is generally sub-optimal, we stress that the objective of this thesis is to illustrate the capabilities of the complete formulation, even with relatively simple algorithms. In addition, this method enables complex non-convex constraints to be easily incorporated in the solution.

We next discuss the nature of the inventory constraints—demand/supply/revenue constraints are similar and will be skipped for brevity (for example revenue, etc—see Section 2.1.1). We again reiterate that the variables in these constraints can be arbitrary sets of nodes and/or edges, and can refer to multiple commodities, at different timesteps.

Inventory Constraints

Total inventory at a node can be limited:

$${Min}_{1} \leq {\sum }_{p = 1}^{N} {Inv}_{t}^{p} \leq {Max}_{1} , for t = 0 , … , T - 1$$

Total inventory at a node over all time periods can be limited:

$${Min}_{2} \leq {\sum }_{t = 0}^{T - 1} {\sum }_{p = 1}^{N} {Inv}_{t}^{p} \leq {Max}_{2}$$

The inventory of a particular product can be limited:

Min₃≦Invₜ^{p}≦Max₃

The inventory of all the products can be balanced:

Min₄≦Invₜ^{p1}−Inv₁^{p2}<Max₄

Finding an Optimal Ordering Policy

Using our convex polyhedral formulation, we find optimal ordering policy using the following approaches. Here, without recourse we mean a static one-shot optimization, and with recourse a rolling-horizon decision.

1. Without Recourse

The total cost over all time periods is minimized in a single step and optimal policy is computed according to it. This approach is taken when all the demands are known in advance and we just have to find an optimal policy for the given demands. This is deterministic optimal control, i.e., when there is no uncertainty. This approach gives us the optimal solution with uncertain parameters fixed at some particular values. We can use this approach even when we don't know the demands but know the constraints governing these demands and other exogenous variables like supply etc. We use sampling methods coupled with the global bounds (best decision, best parameters/worst decision, worst parameters) to obtain the bounds for the optimal problem without recourse as discussed in Section 2.1.2. This is a conservative policy since it gives no opportunity to correct in the future based on actual realizations of the uncertain parameters.

2. Iterative Method (With Recourse)

This approach is taken when we do not know the demands. This is a rolling-horizon optimization where we steer our policy as we step forward in time, continually adjusting the policy for the realized data. Here the first step is to find a sample solution by solving the problem without recourse. This solution is close-to-optimal over the entire range of parameter uncertainty. The first decision of this solution is typically implemented. In the next time step, when one or more of the demands are realized, the uncertainty has partly resolved itself. So the actual solution should in general be different from the first solution. When the values of demand for one time step are realized, then these values are plugged in the constraints and another solution is optimized for all the future time steps. In general, this will be different from the previous solution, and its first decision is implemented. At each time step, value of demand variables of one time period is revealed. So the solution changes as time progresses. For example, in the first time step, a decision is made about the order quantity for all the time steps, but only the first answer is implemented for the 1^{st} timestep. At this point demand is not known. In the second step, the demand for first time step is known and decision about the order quantities for all the future time steps is made again with the value of the demand for first time step fixed at its realized value. The first answer is implemented for the 2^{nd} timestep. At the third time step, the values for demand at first as well as the second time step are known. So the decision for the order quantities for all future time steps is made again now with 2 demands fixed. The first answer is implemented for the 3^{rd} timestep. Thus decisions are made periodically, and optimal solution for all the time steps is approached iteratively.

This approach can be taken even when we know the demands up to a point in time and after that the demands are uncertain. We just have to plug in the values of the demands that are known in the system.

In our uncertainty formulation, as time progresses, we are taking successive slices of the high-dimensional parameter polytope at the realized values of the initially uncertain parameters. Optimization is iteratively done on these slices. Models utilizing LP/ILP can profitably use incremental LP/ILP techniques, keeping the old basis substantially fixed, etc.

To compare with other work, out rolling horizon method does not lose uncertainty as time marches on. In the rolling horizon approaches described by Kleywegt, Shapiro [26] or Powell, Topaloglu [19], [20], [29], there is loss of uncertainty as these approaches use a point estimate for all the future uncertain parameters while fixing the values of parameters whose values have been realized. Our approach is more robust as we do not make any estimates about the unknown parameters of the future, but keep their uncertainty sets intact in the problem. Our approach essentially projects the polytope of the constraints for the uncertain parameters onto the dimensions of the previous time step parameters (ones whose values have just been realized). Thus we keep projecting the polytope onto the dimensions of those parameters whose values are revealed as time goes on and the dimensionality of the uncertainty set keeps reducing, but we do not lose the robustness for the parameters whose values are yet unknown.

3. Demand Sampling

This approach goes as follows: a candidate solution is found by getting a demand sample and computing the bounds on the cost. A demand sample is nothing but a random nominal solution (a feasible solution) for the demand variables subject to the demand constraints. The values of demand parameters are fixed to the nominal solution values and bounds on the cost are computed. A number of candidate solutions are found as shown in FIG. 7 in this way and the cost is minimized/maximized over all of them. In addition to being an approach to solving the problem without recourse, the P.D.F of the cost of solutions (not the min/max bounds) can be used to approximate the P.D.F of the cost function, over the uncertain parameter set, in low dimensional cases.

By taking a number of samples in this way, we get a scatter plot as shown in FIG. 8 for the solution best/worst case bounds as follows, for the example 3 in Inventory optimization results section.

Since we are sampling the demand, the worst policy over all the samples should approach the worst decision, worst case solution in the without recourse approach and the best case over all the samples should approach the best decision, best case solution without recourse, as the number of samples taken increases. From this same scatter plot, the Min-Max solution has a cost not exceeding about 460000.

The estimated pdf of the minimum costs is as given in FIG. 9, each point corresponding to an optimal solution for one sample of the demands, and other parameters. If the parameters are few, and we take many samples, statistical significance is high enough to give us the ability to compute the probability distribution for the optimal cost and hence simply put, obtain a relation to answers produced by the stochastic programming approach.

This approach is related to the “Certainty equivalent controller (CEC)” control scheme of Bertsekas [8]. CEC applies at each stage, the control that would be optimal if the uncertain quantities were fixed at some typical values. The advantage is that the problem becomes much less demanding computationally.

Software Implementation

The analytical techniques described in chapter 2 use linear programming. Even a moderate sized supply chain leads to huge linear programs with thousands of variables. We have extended the existing SCM project at IIIT-B to include capacity planning and inventory optimization capabilities and applied it to semi-industrial scale problems (for capacity planning). It uses CPLEX 10.0 to solve the optimization problems and is coded in java programming language.

Software Architecture

The SCM software consists of the following main modules:
SCM main GUI
Constraint Manager/Predictor
Information Estimation
Graphical Visualizer
Inventory and Capacity Optimization
Auctions
Optimizer (CPLEX, QSopt)
Output Analyzer

The relationship between the different modules is given in FIG. 10.

Description

SCM Main GUI 1:

The supply chain network is given as input to the system through the SCM main GUI 1 as a graph. Each element of the graph is a set of attribute value pairs where the attributes are those that are relevant to the type of element for example; a factory node has attributes such as a set of products, and for each product—production capacity, cost function, processing time etc. The optimization problem is specified by the user at this stage. The system is intended to be flexible enough for the user to choose any subset of parameters to be optimized over the entire chain or a subset of the chain

Constraint Manager 2:

Once the supply chain is specified as the input graph with values assigned to all the required attributes and the problem is specified, the control goes to the constraint manager/predictor module. Here the user can enter any constraints on any set of parameters manually as well as use the constraint predictor to generate constraints for the uncertain parameters using historical time series data. This set of constraints represents the set of assumptions given by the user and is a scenario set as each point within the polytope formed by these constraints is one scenario. The constraint predictor is described later in the document. Constraint manager uses the optimizer 9 in order to do this. Now the problem is completely specified and the user can choose to do one of the following:
Analyze the Problem Using Information Estimation Module 3
Information estimation module automatically generates a hierarchy of scenario sets from the given set of assumptions, each more restrictive than the preceding and produces performance bounds for each of these sets. The user can not only evaluate the performance of the supply chain in successively reducing degrees of uncertainty but also get a quantification of the amount of uncertainty in each scenario set using Information theoretic concepts. Thus the user can compare different specifications of the future quantitatively. Constraints can also be perturbed keeping the total information content the same, more or less in this module. To do this, the information estimation module also uses the optimizer module.
View the Constraints Entered/Generated in a Graphical Form in the Graphical Visualizer Module 4
The graphical visualizer module displays the constraint equations in a graphical form that is easy to comprehend. Here the user can not only look at the set of assumptions given by him, but also compare one set of assumptions with another set. This module finds relationships between different constraint sets as follows:
   One Set is a Sub-Set of the Other
   In this case the scenarios in the sub set are also a part of the super set. So all the feasible solutions for the sub set are also feasible for the super set. Since the super set has greater number of scenarios, it has more uncertainty. We can quantify this uncertainty from the information estimation module. Thus we can compare the two sets of constraints on the basis of amount of uncertainty in each.
   Two Constraint Sets Intersect
   In this case, the two constraint sets share some information and we can compare them on that basis. They essentially tell us, what happens if the future turns out to be different than what we assumed, but not entirely different.
   The Two Constraint Sets are Disjoint
   In this case there is nothing in common between the two sets so we cannot compare them. The two constraint sets are two entirely different pictures of the future.
Solve the Problem in the Capacity Planning and Inventory Optimization Module 5
This module creates an optimization problem for capacity planning and inventory optimization and solves it using the optimizer module. It uses the mathematical programming formulation for both the problems as discussed in chapter 2 for most of the cases. But the quadratic programming problems or quadratically constrained programming problems also arise if two types of “dual” quantities are variable such as price and demand. The module is also capable of handling non-convex problems using heuristics such as simulated annealing but they are still under development. The module is flexible to handle problems having any arbitrary objective function with any set of constraints. It provides decision support by giving the best/worst case bounds on the performance parameters in a hierarchy of scenario sets generated by the information estimation module.

Output Analyzer 6:

Once a problem is solved in the capacity planning or inventory optimization module, the solution can be viewed'in the output analyzer module. The output analyzer can not only display the output in a graphical form but the user can select parts of the solution in which he/she is interested and view only those. The user can zoom in or zoom out on any part of the solution. There is a query engine to help the user do this. The user can type in a query that works as a filter and shows only certain portions. The module has the capability of clustering similar nodes and showing a simplified structure for better comprehension. The clustering can be done on many criteria such as geographic location, capacity etc. and can be chosen by the user. This makes a large, difficult to comprehend structure into a simplified easy to analyze structure.

Auction Algorithms 8:

The auctions module performs auctions under uncertainty. Here the bids given by the bidders are fuzzy and indeed are convex polyhedra. The auctioneer has to make an optimal decision based on the fuzzy bids, and this can be done by LP/ILP if he/she has a linear metric. Based on the auctioneer decision, the bidders perform transformations on the polytopes formed by the bidding constraints to improve their chances to win in the next bidding round. If information content has to be preserved, these transformations are volume preserving, e.g. translations, rotations etc.

Other Features:

The constraints in the problems are guarantees to be satisfied, and the limits of constraints are thresholds. Events can be triggered based on one or more constraints being violated, and can be displayed to higher levels in the supply chain.

Similar to the auction module, we can treat the constraints as bids for negotiations between trading partners. There are guarantees on the performance if the constraints are satisfied. This can easily model situations where there are legally binding input criteria for a certain level of output service and can be useful in contract negotiations. Constraints can be designed by each party based on their best/worst case benefit.

The analysis of constraint sets in information analysis or constraint visualizer can not only be done by preparing a hierarchy of constraint sets but also by forming information equivalent constraint sets derived by performing random translations rotations, and dilations keeping volume fixed on a set of constraints.

Information analysis can also be done for the output information, by taking different output criteria and computing their joint min/max bounds. Details are skipped for brevity. Appendix C provides a detailed description of the software.

### EXAMPLES AND RESULTS

Here we shall illustrate the capabilities of our CP/IO package. We shall first discuss illustrative small examples, and then showcase results on large ones, with cost breakpoints, etc. We shall compare our results with theoretical estimates for capacity planning and the generalized EOQ formulations for Inventory optimization. We shall also illustrate how the capabilities merge tightly with the rest of the SCM package, especially the information content analysis module and data visualization and constraint analysis model.

Information vs. Uncertainty

In the following example we give an illustration of how our decision support works and how constraints are economically meaningful. We generate a hierarchy of constraint sets from a given constraint set and quantify the amount of information in each of them and show how guarantees on the output become loser and loser as uncertainty increases.

Let us take a small supply chain as given in the FIG. 11

There are 2 suppliers, 2 factories, 2 warehouses and 2 markets. There is only a single product, and hence 2 demand variables. The constraints that were derived on these 2 demand variables from historical data are as follows:
1. 171.43 dem_M0_p0+128.57 dem_M1_p0<=79285.71
2. 171.43 dem_M0_p0+128.57 dem_M1_p0>=42857.14
3. 57.14 dem_M0_p0+42.86 dem_M1_p0<=26428.57
4. 57.14 dem_M0_p0+42.86 dem_M1_p0>=14285.71
5. 175.0 dem_M0_p0+25.0 dem_M1_p0<=65000.0
6. 175.0 dem_M0_p0+25.0 dem_M1_p0>=22500.0
7. 0.51 dem_M0_p0−0.39 dem_M1_p0<=237.86
8. 0.51 dem_M0_p0−0.39 dem_M1_p0>=128.57
9. 300.0 dem_M0_p0<=105000.0
10. 300.0 dem_M0_p0>=30000.0

Constraints from 1 to 6 are revenue constraints as they are bounds on the sum of product of demand and price. Constraints 7 and 8 are competitive constraints and tell us that the market 0 and 1 are competitive. Constraints 9 and 10 give bounds on the value of demand in market 0. All the constraints when shown graphically look like in FIG. 12.

This set of constraints represents the case when all the 10 assumptions are acting, i.e., the revenue constraints are valid, the market is competitive and the bounds on demand in market 0 are acting.

If we delete constraint 8, the constraint set will look like in FIG. 13.

This set of constraints represents the case when only the revenue constraints and the bounds are acting. Here the market is not competitive. There is less number of constraints and the volume of the constraint polytope has increased signifying more uncertainty.

If we delete the constraints 9 and 10, then the constraint set looks like in FIG. 14.

Here only revenue constraints are valid, the market is not competitive and there are no bounds on the demands. The volume of the polytope has increased further thus increasing the amount of uncertainty.

If we delete 2 more constraints, the constraint set looks like in FIG. 15.

In this case, the market is not competitive, there are no bound constraints on the demands and fewer revenue constraints are valid. The uncertainty has increased and the number of constraints is lesser so the amount of information has decreased further.

If we delete 2 more revenue constraints, the constraint set looks like in FIG. 16.

In this case only 1 revenue constraint is valid, the volume of the feasible region has increased even more thus increasing the amount of uncertainty.

The following table summarizes the calculations for information content for all the constraint sets in the above hierarchy and also bounds for total cost, which is the objective function for this example.

TABLE 2
Summary of information analysis for hierarchical constraint sets

| | | | | Range of |
|---|---|---|---|---|
| | Information | Minimum | Maximum | output |
| Number of | Content in | cost | cost | Uncertainty |
| constraints | No. of bits | (% age) | (% age) | (% age) |
| 10 constraints | 1.84 | 100.00 | 128.38 | 28.38 |
| 9 constraints | 0.81 | 60.06 | 154.50 | 94.45 |
| 7 constraints | 0.73 | 60.06 | 158.72 | 98.66 |
| 4 constraints | 0.58 | 54.99 | 158.72 | 103.73 |
| 2 constraints | 0.44 | 54.92 | 161.77 | 106.85 |

From the table we can see that as the amount of information decreases, the range of output uncertainty increases. When all the 10 constraints are valid, the amount of information is 1.84 bits and the range for uncertainty in cost is 28.38%. When only 9 constraints are valid, the information content goes down to 0.81 bits and the range of output uncertainty increases to 94.45%. When only 2 constraints are valid, then the amount of information is just 0.44 bits and the range of output uncertainty is 106.85%. This is illustrated by the pareto curve as shown in the following graph.

This example illustrates how we generate a hierarchy of scenario sets that also hold economic meaning and quantify the amount of uncertainty in each of the scenario sets also see how our performance metric changes as the amount of uncertainty increases. This is an example of the decision support that we provide by analyzing different possibilities for the future.

Capacity Planning Results

In this section, we showcase the capabilities of our overall supply chain framework. We discuss cost optimization on small, medium, and large supply chains, both with and without uncertainty. Min-max design is also illustrated in one example. The complexity of the results clearly illustrates the importance of sophisticated decision support tools to understand results on even simplified examples like the ones shown. Our framework provides information estimation, constraint set graphical visualization, and output analysis modules for this purpose.

Examples on a Small Supply Chain

We first begin with an example which illustrates the way capacity planning is handled under uncertainty, and how the module ties into other parts of the decision support package, which offer analysis of inter-relationships of constraints, information content in the constraints, etc. Here we do a static one-shot optimization. This model can be extended to dynamic optimization with incremental growth, year/year capacity planning also.

A simple potential supply chain consisting of 2 suppliers (S0 and S1), 2 factories (F0 and F1), 2 warehouses (W0 and W1) and 2 markets (M0 and M1) is shown in FIG. 17.

The supply chain produces only 1 finished product p0. Since there are 2 markets, there are only 2 demand variables, demand for product p0 at market (dem_M0_p0) and demand for product p0 at market 1 (dem_M1_p0).

The nodes S0, F0, W0, and M0 and the links 1, 2 and 3 lie in one geographic region. The nodes S1, F1, W1, and M1 and the links 9, 10 and 11 lie in another geographic region. The links 3, 4, 5, 6, 7 and 8 connect the two regions and are twice the length of the links that lie in one region only.

The demand is uncertain and is bounded by the following demand constraints:
1. dem_M0_p0+dem M1_p0≦500
2. dem_M0_p0+dem M1_p0≧250
3. 2 dem_M0_p0−dem_M1_p0≦400
4. 2 dem_M0_p0−dem_M1_p0≧100
5. 5 dem_M1_p0−2 dem_M0_p0≦900
6. 5 dem_M1_p0−2 dem_M0_p0≧150
7. dem_M0_p0≦350
8. dem_M0_p0≧100

These constraints are derived from historical economic data and can be shown graphically as in FIG. 2.4.

The optimal point shown in the figure is the point at which sum of the demand variables is minimum, without considering the cost constraints. When cost is the objective function, the optimal point will change due to integrality constraints of the breakpoints. In this case the optimal can be far away from what is shown. But in cases where no breakpoints are acting, the optimal should be equal to the optimal shown in the FIG. 18.

The optimal point in this polytope, while doing a minimization should be as shown in the figure. At the optimal point, dem_M0_p0 is equal to 157 and dem_M1_p0 is equal to 93.

Based on this, six scenarios are described below. We will analyze the structure in these scenarios. In one set of scenarios, we explore the problems where the demand parameters are deterministic, i.e., they are known exactly, in advance. In another set of scenarios, we explore problems with uncertain demand. In all these scenarios, we assume that the factory and warehouse nodes are “OR” nodes. The edges have a maximum capacity of 500 and a minimum of 0.
1. The two demands are deterministic, i.e. they are known in advance and all the factories and warehouses have identical costs and all links have identical costs.
   Let us consider that the cost of both the factories is identical and is given by the following cost function:
      Breakpoint=just above {50}
      Fixed Costs={345, 350}
      Variable Costs={76, 78}
   The cost function for both the warehouses is as follows:
      Breakpoint=just above {75}
      Fixed Costs={150, 200}
      Variable Costs={10, 12}
   The cost function for all the links is the identical and is given by:
      Breakpoint=just above {250}
      Fixed Costs={200, 210}
      Variable Costs={55, 65}
   a. In the first case, let us consider that dem_M0_p0 and dem_M1_p0, both are equal to 500.
      Since both the demand parameters are exactly equal to 500 and the breakpoint in cost function for the links is 250, then the flow should be equally distributed among all the links, each link transporting 250 units. Also, since both factories are identical and both warehouses are identical, there should be symmetry in the supply chain.
      As predicted, the answer produced by our model is as in FIG. 19.
   b. In the second case, let us consider that dem_M0_p0 and dem_M1_p0, both are equal to 700.
      Since the demands are now equal to 700, and the factories, warehouses and links are identical and the breakpoint on the links is 250, the flow should be less than or equal to 250 in one set of links and greater than 250 in the other links so that the breakpoint is broken only in one set of links and not all, thus keeping the cost at minimum.
      As predicted, the answer produced by our model is as in FIG. 20.
2. All the factories and warehouses have identical costs and all links have identical costs. The demand is uncertain and the uncertainty is specified by the demand constraints given earlier. In this example, we show the best decision/best params, worst decision/worst params, and the min/max bound as obtained by sampling. The answers illustrate the complexities of interpreting the solution even for simple chains.
   The cost of both the factories is identical and is given by the following cost function:
      Breakpoint=just above {50}
      Fixed Costs={345, 350}
      Variable Costs={76, 78}
   The cost function for both the warehouses is as follows:
      Breakpoint=just above {75}
      Fixed Costs={150, 200}
      Variable Costs={10, 12}
   The cost function for all the links is the identical and is given by:
      Breakpoint=just above {250}
      Fixed Costs={200, 210}
      Variable Costs={55, 65}
   a. The breakpoint in the cost of the links is just above 250.
      Since the breakpoint is exactly equal to the sum of the 2 demands, then only one factory and only one warehouse are enough to supply both the markets, so only one factory and only one warehouse should remain operational with only a set of links working. In this case the breakpoints are not acting, so the optimal answer for the best/best case should give demands exactly equal to (157, 93).
      As predicted, the answer produced by our model is as in FIG. 21.
   b. The breakpoint in the cost of the links is 75.
      Since the breakpoint is now very small as compared to the sum of two demands, the flow will now spread out to both the factories and both warehouses and the flow on the links will be limited to 75 units as much as possible so the flow does not go beyond the breakpoint so as to minimize the cost.
      As predicted, the answer produced by our model for the best/best case is as in FIG. 22.
   For the worst/worst case, the answer is as in FIG. 23.

The cost in this case is =190460 units.

Taking samples of the demands and finding the worst case cost of solutions optimized for these demands: (the sampling method of Section 2.1.2), we get the following plot

The worst case cost of the Min-max solution does not exceed about 140000 units, the lowest point in this graph.

The demand is uncertain and the cost of factory F0 is very large as compared to the cost of factory F1 and all links and warehouses have identical costs.
The cost of the first factory is:
   Breakpoint=just above {50}
   Fixed Costs={1000, 1100}
   Variable Costs={1000, 1500}
The cost of the second factory is:
   Breakpoint 32 just above {50}
   Fixed Costs={345, 350}
   Variable Costs={76, 78}
The cost function for both the warehouses is as follows:
   Breakpoint=just above {75}
   Fixed Costs={150, 200}
   Variable Costs={10, 12}
The cost function for all the links is the identical and is given by:
   Breakpoint=just above {100}
   Fixed Costs={200, 210}
   Variable Costs={55, 65}

Since the cost of factory F0 is very large as compared to the cost of factory F1, all the flow will be directed through factory F1, factory F0 being un-operational. All the links that are connected to factory F0 will carry zero flow.

As predicted, the answer produced by our model is as in FIG. 24.

4. The demand is uncertain and the cost of warehouse WO is very large as compared to the cost of warehouse W1 and all links and factories have identical costs.
The cost function of both the factories is:
   Breakpoint=just above {50}
   Fixed Costs={345, 350}
   Variable Costs={76, 78}
The cost of the first warehouse is:
   Breakpoint=just above {50}
   Fixed Costs={1000, 1100}
   Variable Costs={1000, 1500}
The cost function for the second warehouse is as follows:
   Breakpoint=just above {75}
   Fixed Costs={150, 200}
   Variable Costs={10, 12}
The cost function for all the links is the identical and is given by:
   Breakpoint=just above {100}
   Fixed Costs={200, 210}
   Variable Costs={55, 65}

Since the cost of warehouse W0 is very large as compared to the cost of warehouse W1, all the flow will be directed through warehouse W1, warehouse W0 being un-operational. All the links that are connected to warehouse W0 will carry zero flow.

As predicted, the answer produced by our model is as in FIG. 25.

When the factories are “AND” nodes, the answer produced is as in FIG. 26.

5. The demand is uncertain and the cost of the cross-over links is very large as compared to the straight links and the factories and warehouses have identical costs.
The cost function of both the factories is:
   Breakpoint=just above {50}
   Fixed Costs={345, 350}
   Variable Costs={76, 78}
The cost function for both the warehouses is as follows:
   Breakpoint=just above {75}
   Fixed Costs={150, 200}
   Variable Costs={10, 12}
The cost function for all the straight links is the identical and is given by:
   Breakpoint=just above {100}
   Fixed Costs={200, 210}
   Variable Costs={55, 65}
The cost function for all the cross-links is given by:
   Breakpoint=just above {50}
   Fixed Costs={1000, 1100}
   Variable Costs={1000, 1500}

Since the cost of the cross-over links is very large as compared to straight links, all the flow will be through the straight links and the cross-over links will not be used. Also the breakpoint through the straight links is 100, so the flow through 1 region will be exactly equal to 100 and flow through the other region will be greater than 100.

As predicted, the answer produced by our model is as in FIG. 27.

6. The demand is uncertain, the cost of cross-over links is very large as compared to the straight links and cost of factories and warehouses in region 1 is very large as compared to those in region 2.
The cost of the first factory is:
   Breakpoint=just above {50}
   Fixed Costs={1000, 1100}
   Variable Costs={1000, 1500}
The cost of the second factory is:
   Breakpoint=just above {50}
   Fixed Costs={345, 350}
   Variable Costs={76, 78}
The cost of the first warehouse is:
   Breakpoint=just above {50}
   Fixed Costs={1000, 1100}
   Variable Costs={1000, 1500}
The cost function for the second warehouse is as follows:
   Breakpoint=just above {75}
   Fixed Costs={150, 200}
   Variable Costs={10, 12}
The cost function for all the straight links is the identical and is given by:
   Breakpoint=just above {100}
   Fixed Costs={200, 210}
   Variable Costs={55, 65}
The cost function for all the cross-links is given by:
   Breakpoint=just above {50}
   Fixed Costs={1000, 1100}
   Variable Costs={1000, 1500}

Since the cost of the cross-over links is very large as compared to straight links, all the flow will be through the straight links and the cross-over links will not be used. Also the factory and warehouse in region 1 are much more costly as compared to the factory and warehouse in region 2, so the factory and warehouse in region 1 will also not be used. So a 2—regional supply chain will be reduced to a 1—regional supply chain, supplying markets in 2 regions.

As predicted, the answer produced by our model is as in FIG. 28.

Examples on a Medium Sized Supply Chain

A simple potential supply chain consisting of 10 suppliers (S0 . . . S9), 10 factories (F0 . . . F9), 10 warehouses (W0 . . . W9) and 10 markets (M0 . . . M9) is shown in the FIG. 29.

The supply chain produces only 1 finished product p0. Since there are 10 markets, there are only 10 demand variables, demand for product p0 at market (dem_M0_p0) and demand for product p0 at market 1 (dem_M1_p0) and so on till dem_M9_p0.

All the demand variables have a range with a minimum of 100 units and a maximum of 5000 units. We try to minimize the total cost of operation of the supply chain, while also answering the questions of where and how many factories should be built, where and how many warehouses should be built and what should be the capacity of each of them. This is described with the help of following examples:

7. The cost of straight links is much less as compared to the cost of cross links. All nodes are OR nodes. All edges have a maximum capacity of 500 units and a minimum of O.

Let us consider that the cost of all the factories is identical and is given by the following cost function:
Breakpoint=just above {100}
Fixed Costs={345, 350}
Variable Costs={76, 78}
The cost function for all the warehouses is as follows:
   Breakpoint=just above {100}
   Fixed Costs={150, 200}
   Variable Costs={10, 12}
The cost function for all the straight links is identical and is given by:
   Breakpoint=just above {100}
   Fixed Costs={200, 210}
   Variable Costs={55, 65}
The cost function for all the cross links is identical and is given by:
   Breakpoint=just above {100}
   Fixed Costs={1000, 1100}
   Variable Costs={1100, 1300}
All the links can transport a maximum of 500 units and a minimum of 0 units.
The demands at all the markets can be at least 100 and at most 5000.

Since the cost of cross links is very high as compared to the cost of straight links, all the flow should be pushed through the straight links and the cross links should not be used. Also all demand variables should be pushed to their least value, i.e. 100 units.

As predicted, the answer produced by our model is as in FIG. 30.

8. The cost of straight links is much less as compared to the cost of cross links and the cost of even numbered factories and warehouses is very large when compared to the cost of odd numbered factories and warehouses. All nodes are OR nodes. All edges have a maximum capacity of 500 units and a minimum of 0.

Let us consider that the cost of all the even numbered factories is identical and is given by the following cost function:
Breakpoint=just above {100}
Fixed Costs={345, 350}
Variable Costs={76, 78}
The cost of all odd numbered factories is given by:
   Breakpoint=just above {100}
   Fixed Costs={1000, 1100}
   Variable Costs={1100, 1300}
The cost function for all the even numbered warehouses is as follows:
   Breakpoint=just above {100}
   Fixed Costs={150, 200}
   Variable Costs={10, 12}
The cost of all odd numbered warehouses is given by:
   Breakpoint=just above {100}
   Fixed Costs={1000, 1100}
   Variable Costs={1100, 1300}
The cost function for all the straight links is identical and is given by:
   Breakpoint=just above {100}
   Fixed Costs={200, 210}
   Variable Costs={55, 65}
The cost function for all the cross links is identical and is given by:
   Breakpoint=just above {100}
   Fixed Costs={1000, 1100}
   Variable Costs={1100, 1300}

The cost of even numbered factories and even numbered warehouses is very small compared to the cost of odd numbered factories and odd numbered warehouses. So the odd numbered factories and warehouses should not be used in order to minimize the cost. Since the cost of cross links is very high as compared to the cost of straight links, all the flow should be pushed through the straight links and the cross links should not be used. Also all demand variables should be pushed to their least value, i.e. 100 units. If all the straight links are used, then the demand at odd numbered markets will not be satisfied as all odd factories and warehouses are closed. So a few cross links must be open to transfer goods to odd numbered markets. A few even numbered factories must produce more to supply these markets. Also the maximum capacity of the links is 500, so cross links from more than 1 warehouse will be open.

As predicted, the answer produced by the software is as in FIG. 31.

9. If all factories in example 2 are AND nodes. The cost function for all factories, warehouses and links are the same as in example 2. The demand constraints and capacity constraints are also same.

In this case the answer produced is as in FIG. 32.

10. Multi-commodity flow—Instead of one finished product, the chain produces 3 products now. There is only 1 raw material for all the 3 products. The cost of straight links is much less as compared to the cost of cross links and the cost of even numbered factories and warehouses is very large when compared to the cost of odd numbered factories and warehouses. All nodes are OR nodes. All edges have a maximum capacity of 1500 units and a minimum of 0. All the demand variables have a range with a minimum of 300 units and a maximum of 5000 units. All nodes are OR nodes.

Let us consider that the cost of all the even numbered factories is identical and is given by the following cost function:
Breakpoint=just above {100}
Fixed Costs={345, 350}
Variable Costs={76, 78}
The cost of all odd numbered factories is given by:
   Breakpoint=just above {300}
   Fixed Costs={1000, 1100}
   Variable Costs={1100, 1300}
The cost function for all the even numbered warehouses is as follows:
   Breakpoint=just above {100}
   Fixed Costs={150, 200}
   Variable Costs={10, 12}
The cost of all odd numbered warehouses is given by:
   Breakpoint=just above {300}
   Fixed Costs={1000, 1100}
   Variable Costs={1100, 1300}
The cost function for all the straight links is identical and is given by:
   Breakpoint=just above {300}
   Fixed Costs={200, 210}
   Variable Costs={55, 65}
The cost function for all the cross links is identical and is given by:
   Breakpoint=just above {300}
   Fixed Costs={1000, 1100}
   Variable Costs={1100, 1300}

The cost of even numbered factories and even numbered warehouses is very small compared to the cost of odd numbered factories and odd numbered warehouses. So the odd numbered factories and warehouses should not be used in order to minimize the cost. Since the cost of cross links is very high as compared to the cost of straight links, all the flow should be pushed through the straight links and the cross links should not be used. Also all demand variables should be pushed to their least value, i.e. 300 units. If all the straight links are used, then the demand at odd numbered markets will not be satisfied as all odd factories and warehouses are closed. So a few cross links must be open to transfer goods to odd numbered markets. A few even numbered factories must produce more to supply these markets. Also the maximum capacity of the links is 1500, so cross links from more than 1 warehouse will be open.

As predicted, the answer produced by the software is as in FIG. 33.

If all factories in CASE 4 are AND nodes. The cost function for all factories, warehouses and links are the same as in CASE 4. The demand constraints and capacity constraints are also same.

In this case the answer produced is as in FIG. 34.

Example on a Large Supply Chain

Let us consider a large supply chain consisting of 10 suppliers, 20 factories, 75 warehouses and 100 market places. One finished product is flowing through the chain so there are 100 demand variables. All the demand variables have a range with a minimum of 100 units and a maximum of 5000 units. We try to minimize the total cost of operation of the supply chain, while also answering the questions of where and how many factories should be built, where and how many warehouses should be built and what should be the capacity of each of them. This is described with the help of following example:

Let us consider that the cost of all the even numbered factories is identical and is given by the following cost function:
Breakpoint=just above {100}
Fixed Costs={345, 350}
Variable Costs={76, 78}
The cost of all odd numbered factories is given by:
   Breakpoint=just above {100}
   Fixed Costs={1000, 1100}
   Variable Costs={1100, 1300}
The cost function for all the even numbered warehouses is as follows:
   Breakpoint=just above {100}
   Fixed Costs={150, 200}
   Variable Costs={10, 12}
The cost of all odd numbered warehouses is given by:
   Breakpoint=just above {100}
   Fixed Costs={1000, 1100}
   Variable Costs={1100, 1300}
The cost function for all the straight links is identical and is given by:
   Breakpoint=just above {100}
   Fixed Costs={200, 210}
   Variable Costs={55, 65}
The cost function for all the cross links is identical and is given by:
   Breakpoint=just above {100}
   Fixed Costs={1000, 1100}
   Variable Costs={1100, 1300}

The cost of even numbered factories and even numbered warehouses is very small compared to the cost of odd numbered factories and odd numbered warehouses. So the odd numbered factories and warehouses should not be used in order to minimize the cost. Since the cost of cross links is very high as compared to the cost of straight links, all the flow should be pushed through the straight links and the cross links should not be used. Also all demand variables should be pushed to their least value, i.e. 100 units. Since there are only 20 factories to supply 75 warehouses and the cost of odd factories is very large as compared to even factories, so only a very small number of odd factories can stay open and several cross links must be used in order to supply to all the open warehouses. Now, there are only 75 warehouses to supply 100 markets and the cost of odd warehouses is very large as compared to the cost of even warehouses, so all even warehouses must stay open. Some odd warehouses may have to work as there is demand at all the 100 markets. Several cross links will have to stay open.

As predicted, the answer produced by the software is as follows:
All even factories are open, but only 5 out of 10 odd factories are open.
All even warehouses are open but only 5 out of 37 odd warehouses are open.
Most of the cross—over links are not used and only a few at the last level are being used.
All demand variables are equal to 100 units.

The following table summarizes several capacity planning examples run by us. From the statistics in the table, we can see that the scale of problems tackled ranges from small to fairly large. All of them were integer linear programming problems.

TABLE 3
Capacity planning example statistics

| | Problem | | | | | | | Time |
|---|---|---|---|---|---|---|---|---|
| S | sup- | facto- | ware- | mar- | prod- | break- | | take |
| no. | pliers | ries | houses | kets | ucts | points | Variables | (seconds |
| 1. | 2 | 2 | 2 | 2 | 1 | 1 | 120 | 0.6 |
| 2. | 10 | 10 | 10 | 10 | 1 | 1 | 1640 | 1.27 |
| 3. | 10 | 10 | 50 | 100 | 1 | 1 | 28470 | 3179.41 |
| 4. | 10 | 20 | 75 | 100 | 1 | 1 | 46680 | 885.74 |
| 5. | 2 | 2 | 2 | 2 | 1000 | 0 | 119746 | 0.77 |
| 6. | 5 | 5 | 5 | 5 | 1000 | 0 | 260015 | 18.66 |
| 7. | 10 | 10 | 50 | 100 | 10 | 1 | 284070 | 26957.20 |
| | | | | | | | | (aborted |
| 8. | 10 | 10 | 10 | 10 | 1000 | 0 | 970030 | 600.77 |

Inventory Optimization Results

We begin by optimizing the inventory of a small supply chain consisting of only 3 nodes. The supply chain consisting of one supplier node S0, one factory node F0 and one market node M0 is shown in FIG. 35.

We present the bounds (best decision/best case params—worst decision/worst case params is skipped for brevity—contact author for details), as well as bounds for sampled solutions used to determine the Min-Max as per Section Supply Chain Model: Details. We have also correlated our answers in simple cases with the extended EOQ theory in Section Theory and Model.
1. The supply chain processes one product and inventory optimization has to be done over 12 time periods. For the factory F0 the holding cost is linear with a fixed cost incurred at 0. The fixed cost is 0 and the variable cost is 2 per unit inventory per time period. There is a fixed ordering cost incurred every time an order is placed to supplier S0 and is equal to 1000. The initial inventory is 0. The demand is uncertain but the following constraints on the demand are given:
   1. dem_M0_p1_t0+dem_M0_p1_t1+dem_M0_p1_t2+dem_M0_p1_t3+dem_M0_p1_t4+dem_M0_p1_t5+dem_M0_p1_t6+dem _M0_p1_t7+dem_M0_p1_t8+dem_M0_p1_t9+dem_M0_p1_t10+dem_M0_p1_t11≦=2000.0
   2. dem_M0_p1_t0+dem_M0_p1_t1+dem_M0_p1_t2+dem_M0_p1_t+dem_M0_p1_t4+dem_M0_p1_t5+dem_M0_p1_t6+dem_M0_p1_t7+dem_M0_p1_t8+dem_M0_p1_t9+dem_M0_p1_t10+dem_M0_p1_t11>=1000.0
   3. dem_M0_p1_t0+dem_M0_p1_t1+dem_M0_p1_t2+dem_M0_p1_t3+dem_M0_p1_t4+dem_M0_p1_t5+dem_M0_p1_t6+dem_M0_p1_t7+dem_M0_p1_t8+dem_M0_p1_t9+dem_M0_p1_t10+>=500
   4. dem_M0_p1_t0+dem_M0_p1_t1+dem_M0_p1_t2+dem_M0_p1_t3+dem_M0_p1_t4+dem_M0_p1_t5+dem_M0_p1_t6+dem_M0_p1_t7+dem_M0_p1_t8+dem_M0_p1_t9+dem_M0_p1_t10<=1800
   5. dem_M0_p1_t10+dem_M0_p1_t11>=200
   6. dem_M0_p1_t10+dem_M0_p1_t11<=400
   7. dem_M0_p1_t2−dem_M0_p1_t1>=10
   8. dem_M0_p1_t1−dem_M0_p1_t0>=20
   9. dem_M0_p1_t3−dem_M0_p1_t4−dem_M0_p1_t5−dem_M0_p1_t6−dem_M0_p1_t7−dem_M0_p1_t8>=100
   10. dem_M0_p1_t0>=50
   11. dem_M0_p1_t1>=50
   12. dem_M0_p1_t2>=50
   13. dem_M0_p1_t3>=50
   14. dem_M0_p1_t4>=50
   15. dem_M0_p1_t5>=50
   16. dem_M0_p1_t6>=50
   17. dem_M0_p1_t7>=50
   18. dem_M0_p1_t8>=50
   19. dem_M0_p1_t9>=50
   20. dem_M0_p1_t10>=50
   21. dem_M0_p1_t11>=50

We intend to find the ordering policy that minimizes the total cost. The problem is solved without recourse in a single step. Since the ordering cost is far less than the holding cost, the optimal solution will contain inventory and orders will be infrequent. The solution given by the software is as in FIG. 36.

The total cost is 4460.0. Orders are placed in only 3 out of 12 time periods. The inventory flow equations all hold.
2. The supply chain now processes two products and inventory optimization has to be done over 12 time periods. For the first product the holding fixed cost is 0 and the variable cost is 2 per unit inventory per time period. There is a fixed ordering cost incurred every time an order is placed to supplier SO and is equal to 1000. For the second product, the holding fixed cost is 1500 and variable cost is also 1500, while the fixed ordering cost is 100. The initial inventory for both the products is 0. The demand is uncertain but is bounded by the same constraints as in example 1. We intend to find the policy that minimizes the total cost. The solution is obtained in a single step. Since for the first product, the costs are exactly as in example 1, the solution should be same. For the second product, the holding cost is far greater than the ordering cost, so the inventory should be kept at 0 and orders should be made frequently. The solution generated by our software is exactly as predicted and is given in FIGS. 37 and 38.
   The total cost is 5560.0. For the first product, the solution matches the solution of example 1 and for the second product, the inventory is maintained at 0 and the order quantity for a time period matches the demand in that time period.
3. The inventory optimization is now done using the sampling method. Holding cost is 1/unit inventory and ordering cost is 10000/order. There is only a single product. 500 samples of demand are taken and candidate solutions for each demand sample are computed using the without recourse method. The scatter plot for the maximum and minimum values of cost for each sample is given in FIG. 39.
   The maximum cost goes up as more samples are taken and the minimum goes down. The maximum and minimum of the cost over all samples approach the absolute maximum and minimum (best/best, worst/worst) of the without recourse solution. From the scatter plot, the performance of the Min-max solution can be bounded at about 460,000 units.
4. The supply chain is same as in example 1. Now in addition there are inventory constraints also. The holding cost is linear with a fixed cost incurred at 0. The fixed cost is 0 and the variable cost is 2 per unit inventory per time period. There is a fixed ordering cost incurred every time an order is placed to supplier S0 and is equal to 1000. The initial inventory is 0.
   The inventory constraints are as follows:
   Inventory of product p1 at all time steps is smaller than 100 units.

Inv_p1_t1≦100, for all i from 0 to 11.
The total cost in this case is: 5740.00. The frequency of ordering is more and inventory does not exceed 100 units at any time step as shown in FIG. 40.
5. In the above example if the inventory is constrained across time steps instead of being constrained in each time step as follows:

Σ(Inv_{—}p1_{—}t1)≦500, for all i from 0 to 11.

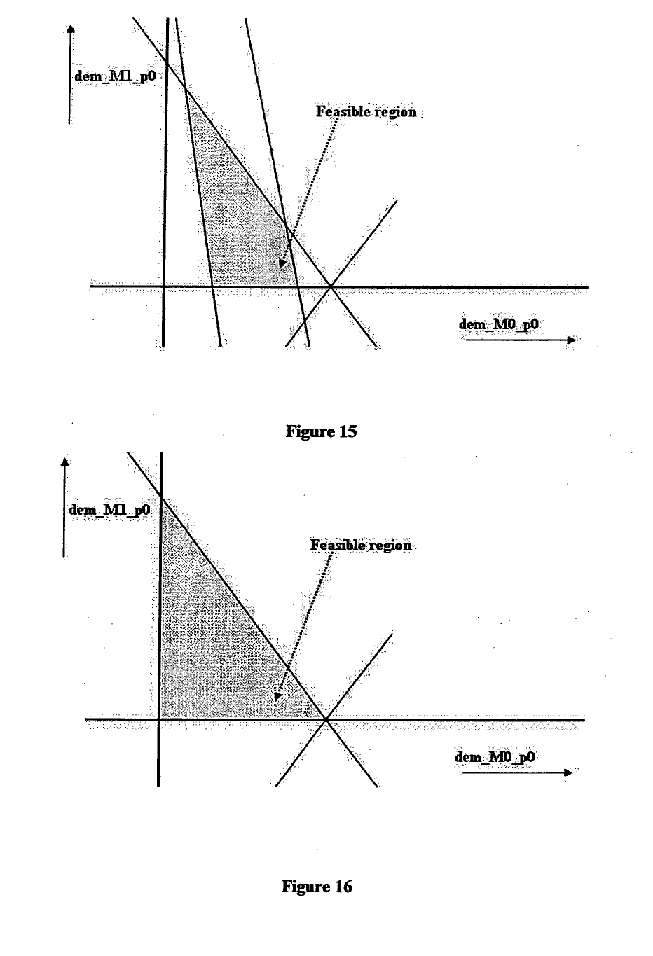

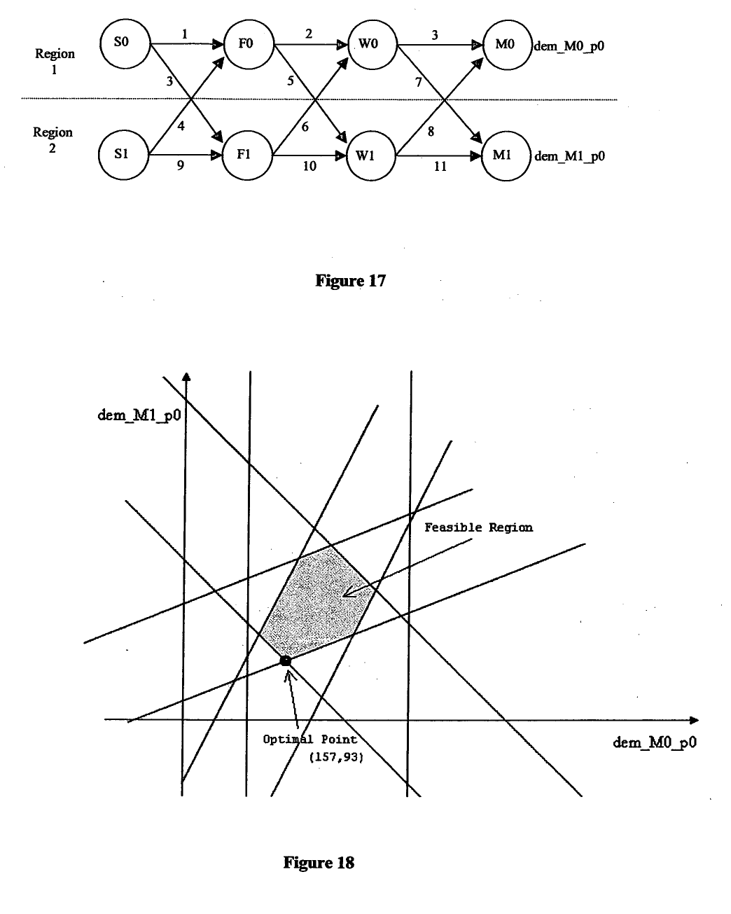

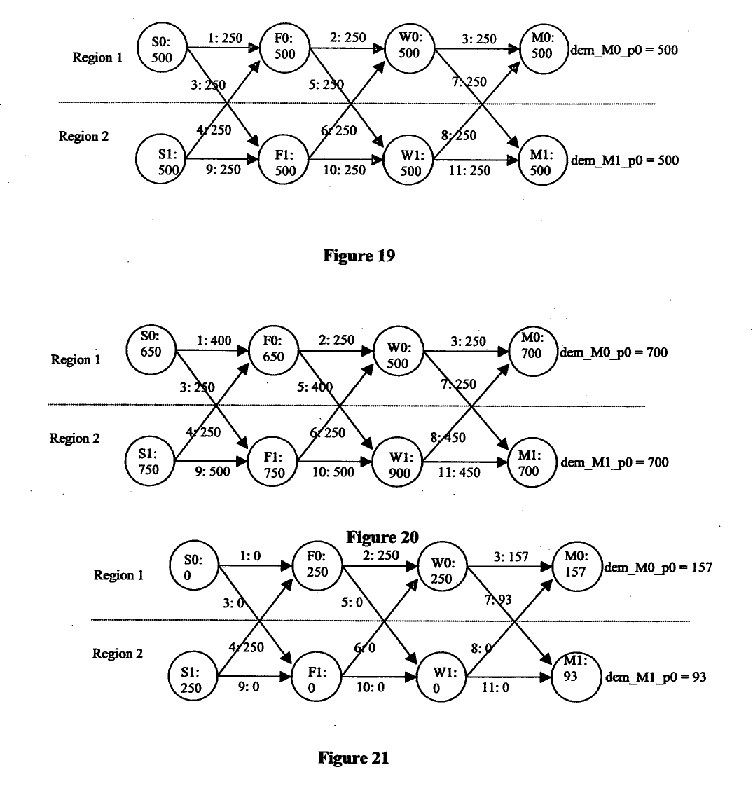

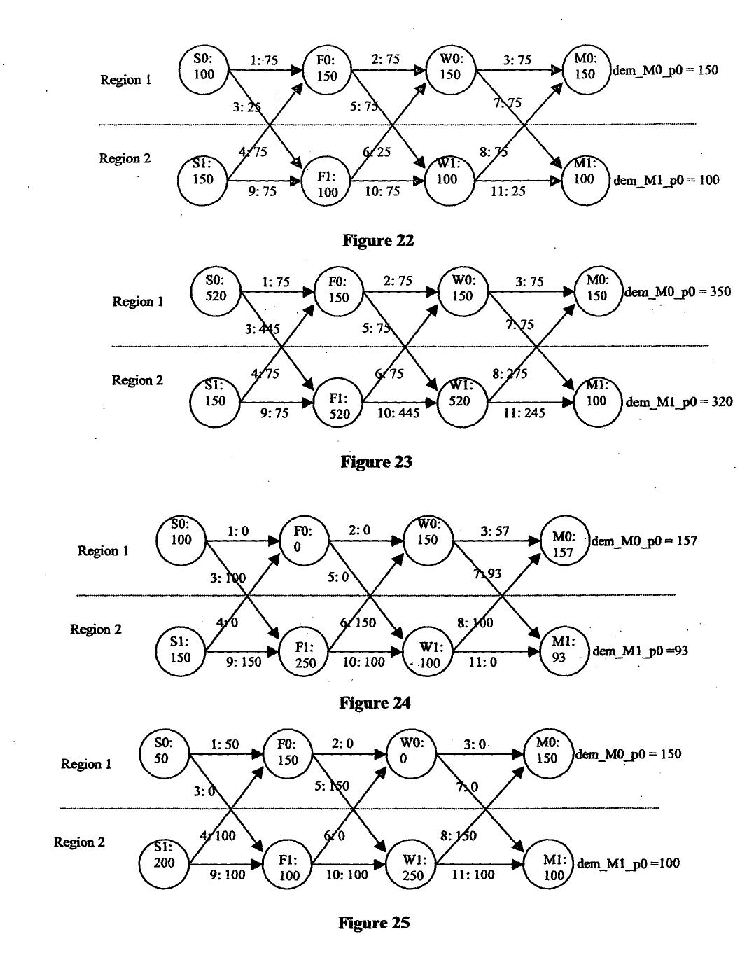

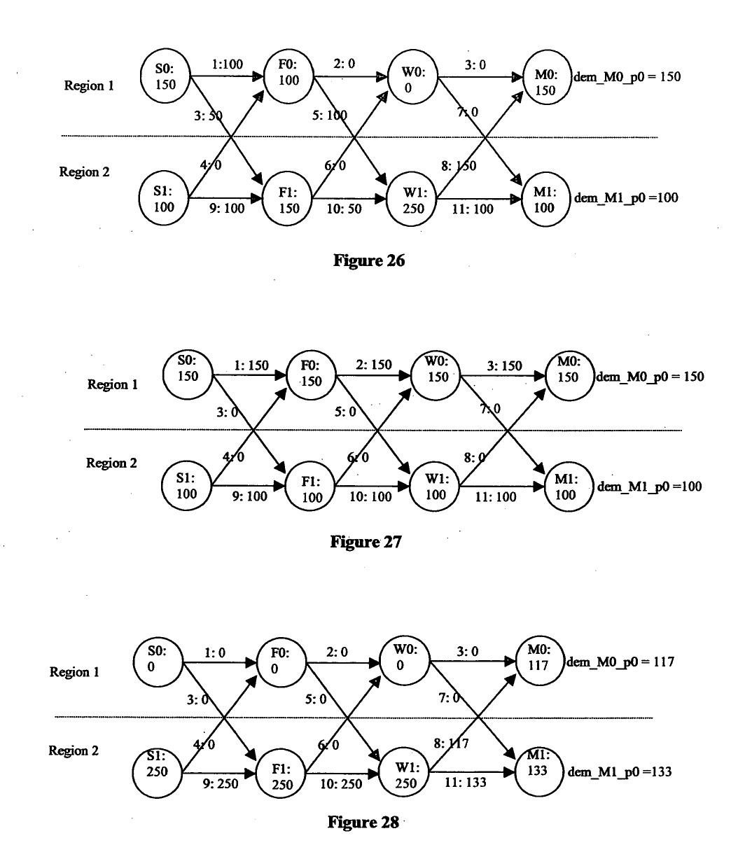

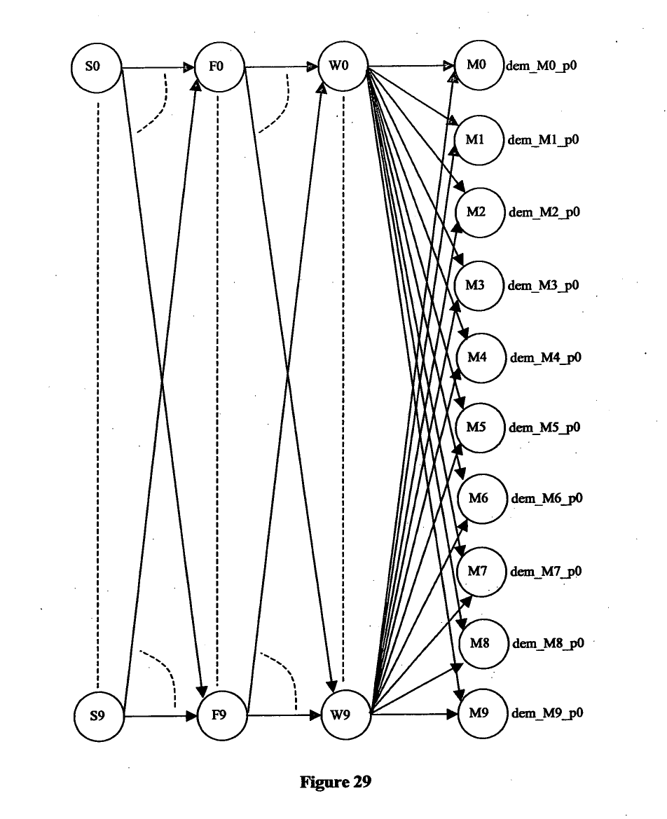

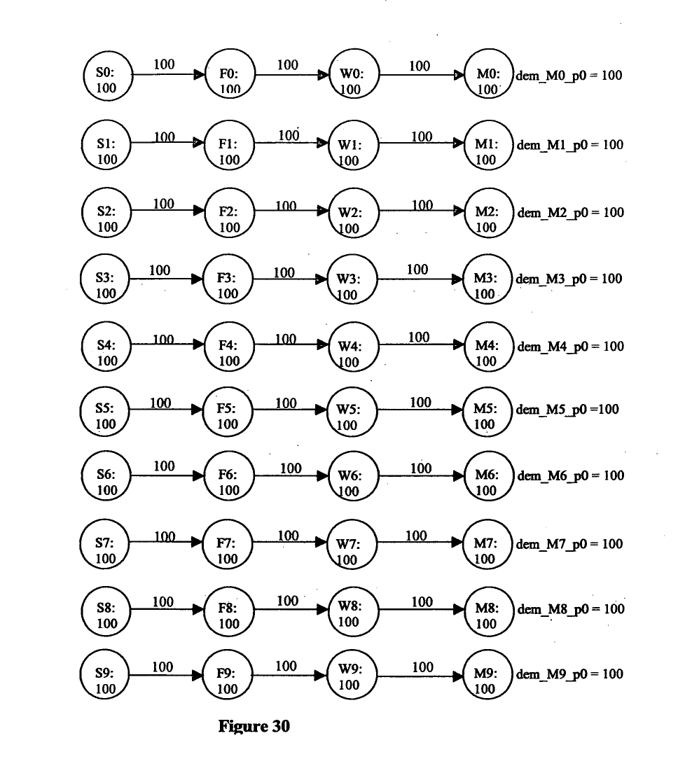

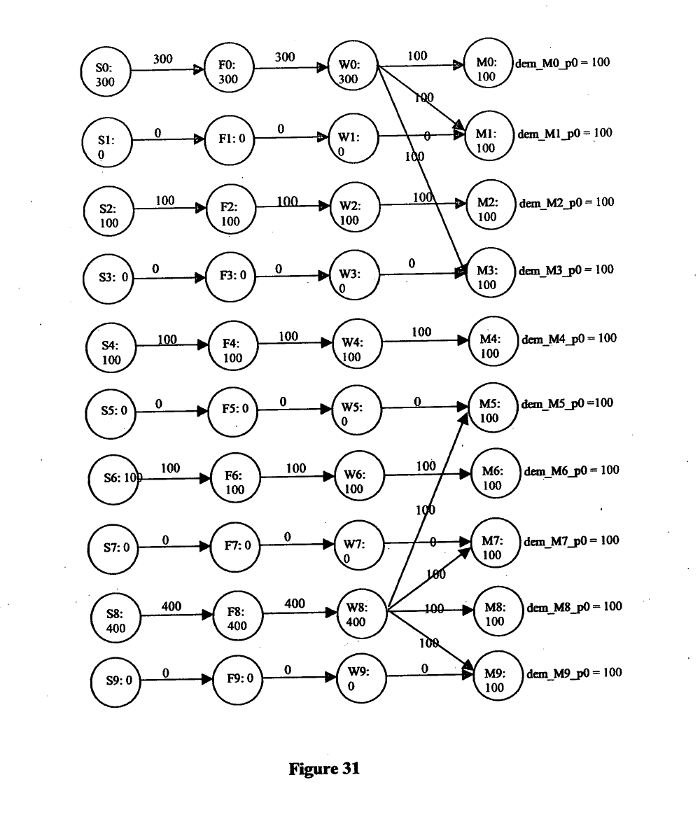

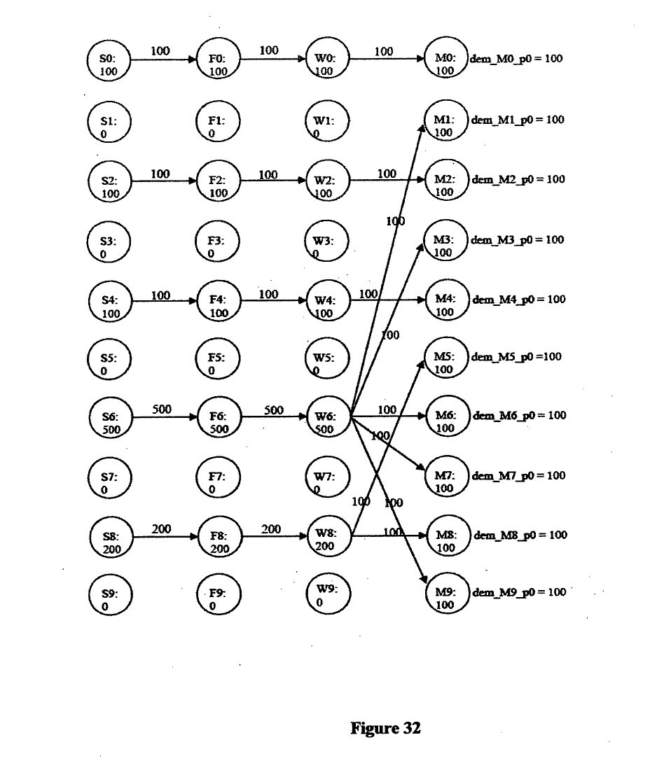

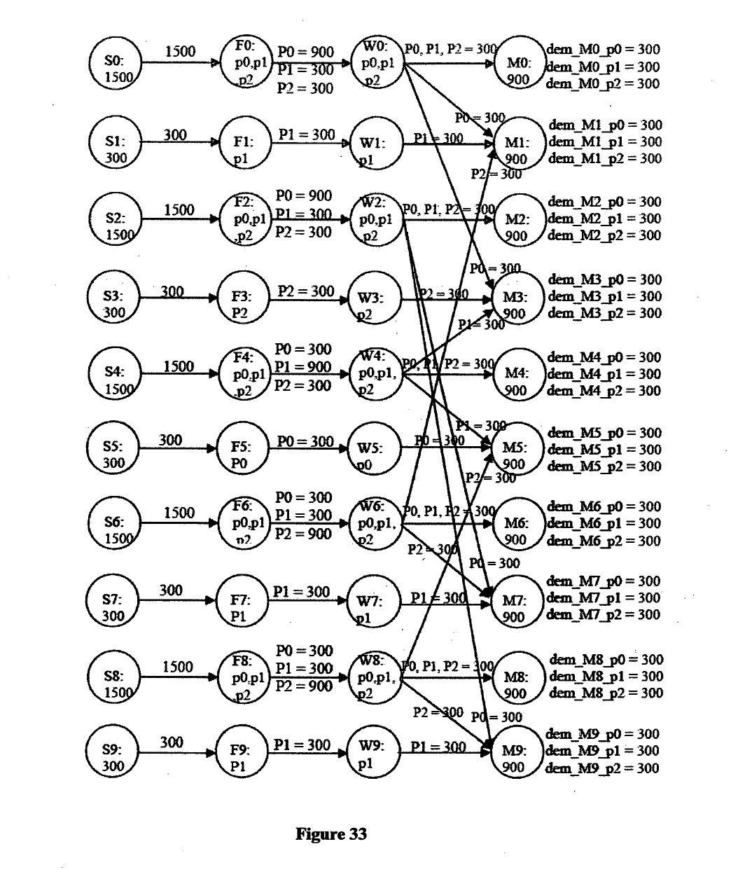

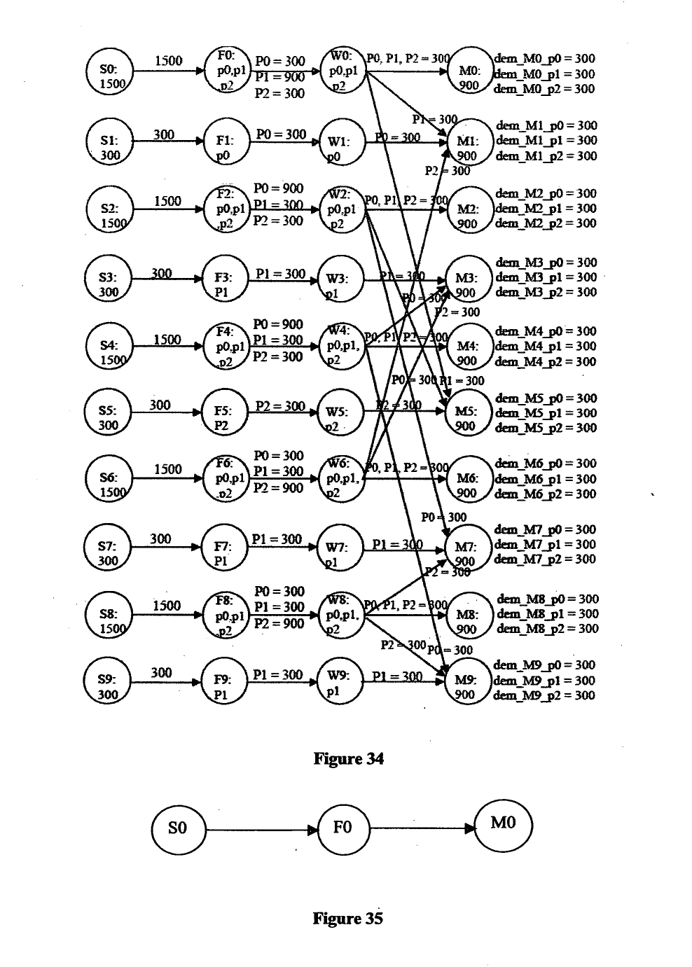

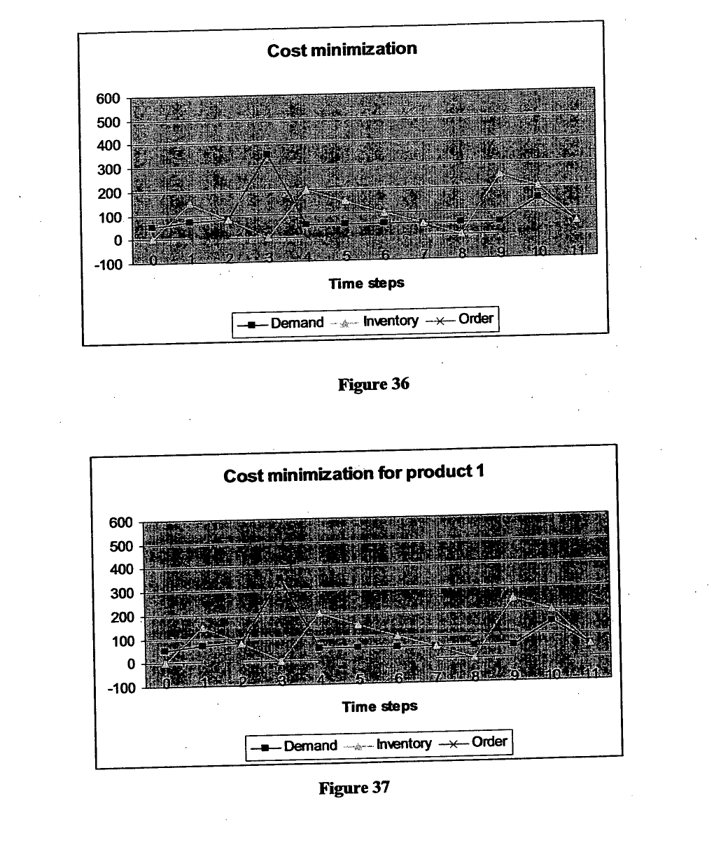

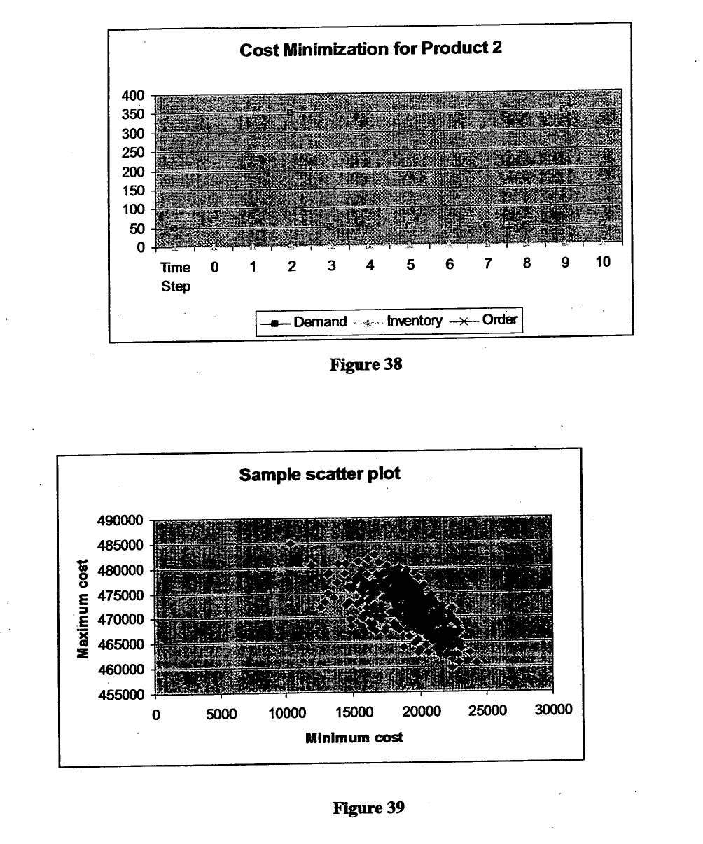

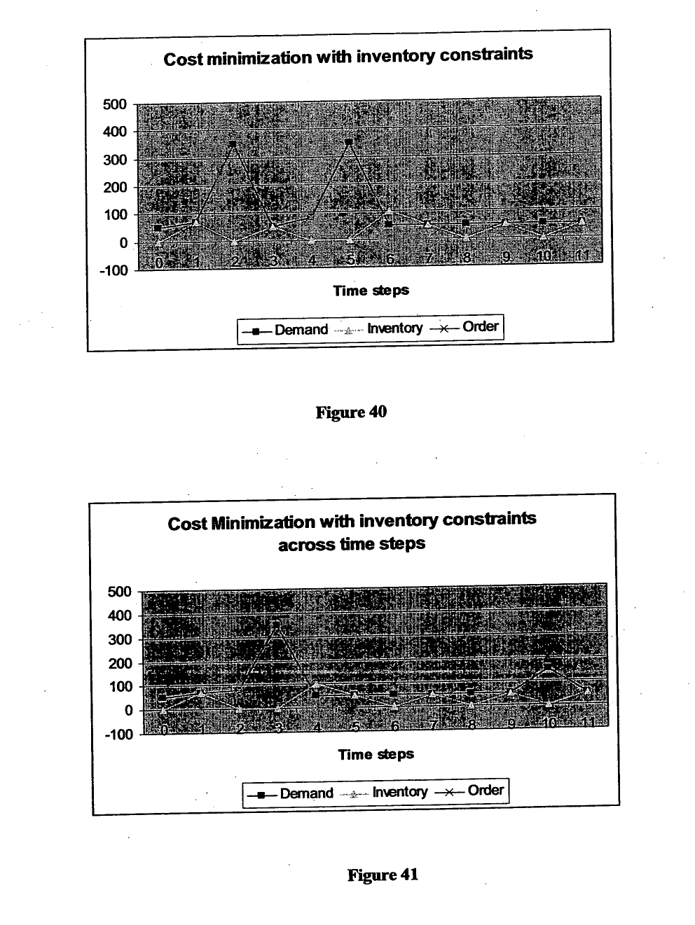

The total cost in this case is 5740.00 again but the solution produced is as in FIG. 41.

From these inventory constraint examples, the flexibility of our approach should be clear.
6. Suppose the supply chain is same as in example 1 and now we want to solve the problem using the iterative approach. As noted earlier the holding cost is linear with a fixed cost incurred at 0. The fixed cost is 0 and the variable cost is 2 per unit inventory per time period. There is a fixed ordering cost incurred every time an order is placed to supplier S0 and is equal to 1000. This time, we want to optimize the inventory levels for only 6 time periods, one time period being equal to 2 months. The example illustrates how the solution changes as the realized demands are plugged in. The demands for the 6 time periods are constrained within the following constraints:
dem_M0_p1_t0+dem_M0_p1_t1+dem_M0_p1_t2+dem_M0_p1_t3+dem_M0_p1_t4+dem_M0_p1_t5>=400
dem_M0_p1_t0+dem_M0_p1_t1+dem_M0_p1_t2+dem_M0_p1_t3+dem_M0_p1_t4+dem_M0_p1_t5<=1000
dem_M0_p1_t1−dem_M0_p1_t3>=100
dem_M0_p1_t0−dem_M0_p1_t2>=20
dem_M0_p1_t2+dem_M0_p1_t3>=300
dem_M0_p1_t3>=100
dem_M0_p1_t4>=100
dem_M0_p1_t5>=100

The solution at the first time step for the above problem is given as follows:

Suppose the demand for time step 0=100

Now we fix dem_M0_p1_t0=100 and solve the problem again. The solution that we get this time is:

Now suppose that the demand for time step 1 turned out to be 350.

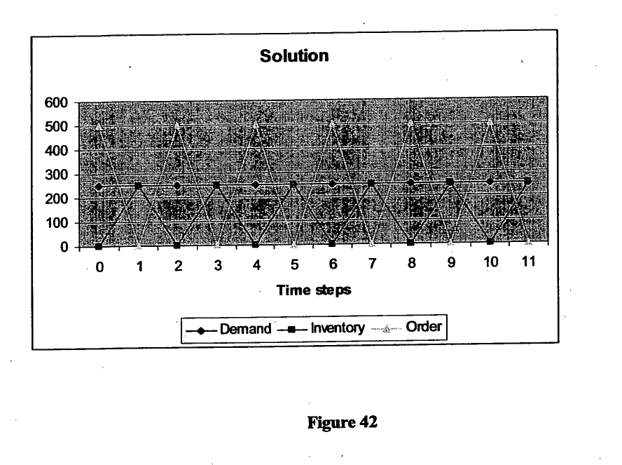

Now we fix dem_M0_p1_t1=350 and solve the problem again. The solution that we get this time is:
7. The following example illustrates comparison of our model with EOQ formulation. There is 1 product in the supply chain and following data is given:
   Annual demand=3000,
   Fixed ordering cost=1000
   Annual holding cost per unit=24
   EOQ=500,
   Optimal cost for this EOQ=1200
   Using our formulation, the following constraint is derived:
   Σdemands=3000
   demᵢ−demᵢ₊₁=0, for all i=time steps
   There are 12 demand variables, 1 for each month.
   The minimum cost by our formulation=1200
   The solution is given in FIG. 42, and corresponds to the EOQ. We have also regressed it with multiple commodities, but details are skipped for brevity:

The following table summarizes several inventory optimization examples run by us. From the statistics in the table, we can see that the scale of problems tackled ranges from small to medium. All of them were integer linear programming problems. The number of time steps in a problem blow up its size.

TABLE 4
Inventory Optimization example statistics

| Solved | | | | | Time | | | Minimum | Maximum |
|---|---|---|---|---|---|---|---|---|---|
| using | Suppliers | Factories | Markets | Products | steps | Variables | Constraints | cost | cost |
| Sampling | 1 | 1 | 1 | 1 | 12 | 132 | 240 | 4856 | 11012 |
| technique | | | | | | | | | |
| Sampling | 1 | 1 | 1 | 1 | 12 | 132 | 240 | 5.5 | 3690000 |
| technique | | | | | | | | | |
| Sampling | 1 | 1 | 1 | 2 | 50 | 1100 | 2200 | 60146 | 98100 |
| technique | | | | | | | | | |
| Sampling | 1 | 1 | 1 | 1 | 100 | 1100 | 2500 | 79680 | 99100 |
| technique | | | | | | | | | |
| Sampling | 1 | 1 | 1 | 10 | 12 | 1320 | 2380 | 74976 | 110120 |
| technique | | | | | | | | | |
| Without | 1 | 1 | 1 | 10 | 12 | 1320 | 2380 | 59470 | 110120 |
| Recourse | | | | | | | | | |
| Sampling | 1 | 1 | 1 | 25 | 24 | 6600 | 11950 | 449644 | 575600 |
| technique | | | | | | | | | |
| Without | 1 | 1 | 1 | 25 | 24 | 6600 | 11950 | 268900 | 575600 |
| Recourse | | | | | | | | | |
| Without | 1 | 1 | 1 | 2 | 50 | 1100 | 1950 | 13769 | |
| Recourse | | | | | | | | | |
| Without | 1 | 1 | 1 | 2 | 50 | 1100 | 1900 | 4996.43 | |
| Recourse | | | | | | | | | |
| Without | 1 | 1 | 1 | 25 | 24 | 6600 | 11950 | 268900 | |
| Recourse | | | | | | | | | |
| Without | 1 | 1 | 1 | 25 | 24 | 6600 | 11380 | 509673 | |
| Recourse | | | | | | | | | |
| Without | 1 | 1 | 1 | 25 | 24 | 6600 | 11400 | 485100 | |
| Recourse | | | | | | | | | |
| Without | 5 | 5 | 5 | 7 | 12 | 9520 | 9310 | 63028 | |
| Recourse | | | | | | | | | |
| Without | 20 | 20 | 20 | 2 | 12 | 31880 | 24080 | 22000 | |
| Recourse | | | | | | | | | |

Conclusions

The convex polyhedral formulation of specifying uncertainty is not only a powerful but also a natural way to describe meaningful constraints on supply chain parameters such as demand. This is a very convenient way to model co-relations between the uncertain parameters in terms of substitutive and complementary effects. Using this uncertainty can be represented as simple linear constraints on the uncertain parameters. The optimization problem can be formulated as a linear programming problem and powerful solvers such as CPLEX can be used to solve fairly large problems.

This approach of modeling uncertain and performance parameters as linear equations is explored in this thesis and results in theory have been found to match the results in application. The decision support system designed as a part of this research has wide applicability and utility. It has the unique capability of not only specifying the uncertainty in a more meaningful way but also to give a quantification of the amount of uncertainty in a set of assumptions. Based on this it can compare two different sets of assumptions, that are two different views of the future. It can also analyze the effects of increasing degree of uncertainty on the performance metric. The methods have been applied on semi-industrial scale problems of up to a million variables.

Appendix A

A Detailed Capacity Planning Example with Equations:

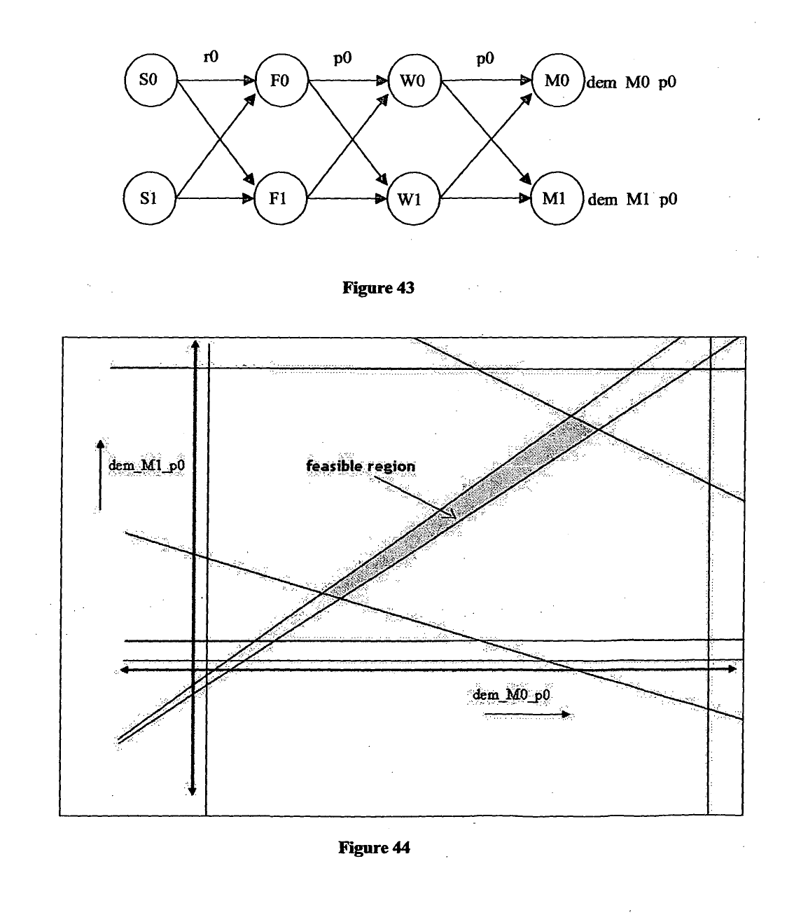

The supply chain in FIG. 43 consists of 2 suppliers, 2 plants, 2 warehouses and 2 market locations. There is only 1 raw material and 1 finished product. We want to minimize the total cost of the supply chain while satisfying the demand for the product at the markets. There are capacity constraints at the suppliers, factories and the warehouses and on the links between them. Also the flow in the supply chain is conserved at each node. The demand is uncertain but bounded.

The Fixed Costs for Building:
Factory 0=892
Factory 1=207
Warehouse 0=995
Warehouse 1=64

Cost Function for All Other Costs:
1 break point at=400
Fixed costs: 200, 400 for intervals, before the breakpoint and after the breakpoint respectively.
Variable costs: 200, 300 for intervals, before the breakpoint and after the breakpoint respectively.

The Objective Function is:
Fixed Capital Expense
   +Fixed Operational Expense
      +Variable Operational Expense
         +Fixed transportation cost
         +Variable transportation cost

→

892 u0+207 u1+995 v0+64 v1+200 I0_F0_p0+400 I1_F0_p0+200 I0_F1_p0+400 I1_F1_p0+200 I0_W0_p0+400 I1_W0_p0+200 I0_W1_p0+400 I1_W1_p0+200 z0_F0_p0+100 z1_F0_p0+200 z0_F1_p0+100 z1_F1_p0+200 z0_W0_p0+100 z1_W0_p0+200 z0_W1_p0+100 z1_W1_p0+200 I0_S0_F0_{—r0+}400 I1_S0_F0_r0+200 I0_S0_F1_r0+400 I1_S0_F1_r0+200 I0_S1_F0_r0+400 I1_S1_F0_r0+200 I0_S1_F1_r0+400 I1_S1_F1_r0+200 I0_F0_W0_P0+400 I1_F0_W0_p0+200 I0_F0_W1_p0+400 I1_F0_W0_p0+200 I0_F1_W0_p0+400 I1_F1_W0_p0+200 I0_F1_W1_p0+400 I1_F1_W1_p0+200 I0_W0_M0_p0+400 I1_W0_M0_p0+200 I0_W0_M1_p0+400 I1_W0_M1_p0+200 I0_W1_M0_p0+400 I1_W1_M0_p0+200 I0_W1_M1_P0+400 I1_W1_M1_p0+200 z0_S0_F0_r0+100 z1_S0_F0_r0+200 z0_S0_F1_r0+100 z1_S0_F1_r0+200 z0_S1_F0_r0+100 z1_S1_F0_r0+200 z0_S1_F_r0+100 z1_S1_F1_r0+200 z0_F0_W0_p0+100 z1_F0_W0_p0+200 z0_F0_W1_p0+100 z1_F0_W1_p0+200 z0_F1_W0_p0+100 z1_F1_W0_p0+200 z0_F1_W1_p0+100 z1_F1_W1_p0+200 z0_W0_M0_p0+100 z1_W0_M0_p0+200 z0_W0_M1_p0+100 z1_W0_M1_p0+200 z0_W1_M0_p0+100 z1_W1_M0_p0+200 z0_W1_M1_p0+100 z1_W1_M1_p0

The Constraints are as Follows:

Indicator Variables for Factory 0 (Due to the Cost Function):
1. 1000000000 I0_F0_p0−Q_F0_p0>=0
2. 1000000000 I0_F0_p0−Q_F0_p0<1000000000
3. 1000000000 I1_F0_p0−Q_F0_p0>=−400
4. 1000000000 I1_F0_p0—Q_F0_p0<999999600

Flow Variables for Factory 0 (Due to the Cost Function):
1. z0_F0_p0−Q_F0_p0>=0
2. z0_F0_p0>=0
3. z1_F0_p0−Q_F0_p0>=−400
4. z1_F0_p0>=0

Indicator Variables for Factory 1 (Due to the Cost Function):
1. 1000000000 I0_F1_p0−Q_F1_p0>=0
2. 1000000000 I0_F1_p0−Q_F1_p0<1000000000
3. 1000000000 I1_F1_p0−Q_F1_p0>=−400
4. 1000000000 I1_F1_p0−Q_F1_p0<999999600

Flow Variables for Factory 1 (Due to the Cost Function):
1. z0_F1_p0−Q_F1_p0>=0
2. z0_F1_p0>=0
3. z1_F1_p0−Q_F1_p0>=−400
4. z1_F1_p0>=0

Indicator Variables for Warehouse 0 (Due to the Cost Function):
1. 1000000000 I0_W0_p0−Q_W0_p0>=0
2. 1000000000 I0_W0_p0−Q_W0_p0<1000000000
3. 1000000000 I1_W0_p0−Q_W0_p0>=−400
4. 1000000000 I1_W0_p0−Q_W0_p0<999999600

Flow Variables for Warehouse 0 (Due to the Cost Function):
1. z0_W0_p0−Q_W0_p0>=0
2. z0_W0_p0>=0
3. z1_W0_p0−Q_W0_p0>=−400
4. z1_W0_p0>=0

Indicator Variables for Warehouse 1 (Due to the Cost Function):
1. 1000000000 I0_W1_p0−Q_W1_p0>=0
2. 1000000000 I0_W1_p0−Q_W1_p0<1000000000
3. 1000000000 I1_W1_p0−Q_W1_p0>=−400
4. 1000000000 I1_W1_p0−Q_W1_p0<999999600

Flow Variables for Warehouse 1 (Due to the Cost Function):
1. z0_W1_p0−Q_W1_p0>=0
2. z0_W1_p0>=0
3. z1_W1_p0−Q_W1_p0>=−400
4. z1_W1_p0>=0

Indicator Variables for Edge Between Supplier 0 and Factory 0 (Due to the Cost Function):
1. 1000000000 I0_S0_F0_r0−Q_S0_F0_r0>=0
2. 1000000000 I0_S0_F0_r0−Q_S0_F0_r0<1000000000
3. 1000000000 I1_S0_F0_r0−Q_S0_F0_r0>=−400
4. 1000000000 I1_S0_F0_r0−Q_S0_F0_r0<999999600

Indicator Variables for Edge Between Supplier 0 and Factory 1 (Due to the Cost Function):
1. 1000000000 I0_S0_F1_r0−Q_S0_F1_r0>=0
2. 1000000000 I0_S0_F1_r0−Q_S0_F1_r0<1000000000
3. 1000000000 I1_S0_F1_r0−Q_S0_F1_r0>=−400
4. 1000000000 I1_S0_F1_r0−Q_S0_F1_r0<999999600

Indicator Variables for Edge Between Supplier 1 and Factory 0 (Due to the Cost Function):
1. 1000000000 I0_S1_F0_r0−Q_S1_F0_r0>=0
2. 1000000000 I0_S1_F0_r0−Q_S1_F0_r0 <1000000000
3. 1000000000 I1_S1_F0_r0−Q_S1_F0_r0 >=−400
4. 1000000000 I1_S1_F0_r0−Q_S1_F0_r0 <999999600

Indicator Variables for Edge Between Supplier 1 and Factory 1 (Due to the Cost Function):
1. 1000000000 I0_S1_F1_r0−Q_S1_F1_r0>=0
2. 1000000000 I0_S1_F1_r0−Q_S1_F1_r0<1000000000
3. 1000000000 I1_S1_F1_r0−Q_S1_F1_r0>=−400
4. 1000000000 I1_S1_F1_r0−Q_S1_F1_r0<999999600

Flow Variables for Edge Between Supplier 0 and Factory 0 (Due to the Cost Function):
1. z0_S0_F0_r0−Q_S0_F0_r0>=0
2. z0_S0_F0_r0>=0
3. z1_S0_F0_r0−Q_S0_F0_r0>=−400
4. z1_S0_F0_r0>=0

Flow Variables for Edge Between Supplier 0 and Factory 1 (Due to the Cost Function):
1. z0_S0_F1_r0−Q_S0_F1_r0>=0
2. z0_S0_F1_r0>=0
3. z1_S0_F1_r0−Q_S0_F1_r0>=−400
4. z1_S0_F1_r0>=0

Flow Variables for Edge Between Supplier 1 and Factory 0 (Due to the Cost Function):
1. z0_S1_F0_r0−Q_S1_F0_r0>=0
2. z0_S1_F0_r0>=0
3. z1_S1_F0_r0−Q_S1_F0_r0>=−400
4. z1_S1_F0_r0>=0

Flow Variables for Edge Between Supplier 1 and Factory 1 (Due to the Cost Function):
1. z0_S1_F1_r0−Q_S1_F1_r0>=0
2. z0_S1_F1_r0>=0
3. z1_S1_F1_r0−Q_S1_F1_r0>=−400
4. z1_S1_F1_r0 22 =0

Indicator Variables for Edge Between Factory 0 and Warehouse 0 (Due to the Cost Function):
1. 1000000000 I0_F0_W0_p0−Q_F0_W0_p0>=0
2. 1000000000 I0_F0_W0_p0−Q_F0_W0_p0<1000000000
3. 1000000000 I1_F0_W0_p0−Q_F0_W0_p0>=−400
4. 1000000000 I1_F0_W0_p0−Q_F0_W0_p0<999999600

Indicator Variables for Edge Between Factory 0 and Warehouse 1 (Due to the Cost Function):
1. 1000000000 I0_F0_W1_p0−Q_F0_W1_p0>=0
2. 1000000000 I0_F0_W1_p0−Q_F0_W1_p0<1000000000
3. 1000000000 I1_F0_W1_p0−Q_F0_W1_p0>=−400
4. 1000000000 I1_F0_W1_p0−Q_F0_W1_p0<999999600

Indicator Variables for Edge Between Factory 1 and Warehouse 0 (Due to the Cost Function):
1. 1000000000 I0_F1_W0_p0−Q_F1_W0_p0>=0
2. 1000000000 I0_F1_W0_p0−Q_F1_W0_p0<1000000000
3. 1000000000 I1_F1_W0_p0−Q_F1_W0_p0>=−400
4. 1000000000 I1_F1_W0_p0−Q_F1_W0_p0<999999600

Indicator Variables for Edge Between Factory 1 and Warehouse 1 (Due to the Cost Function):
1. 1000000000 I0_F1_W1_p0−Q_F1_W1_p0>=0
2. 1000000000 I0_F1_W1_p0−Q_F1_W1_p0<1000000000
3. 1000000000 I1_F1_W1_p0−Q_F1_W1_p0>=−400
4. 1000000000 I1_F1_W1_p0−Q_F1_W1_p0<999999600

Flow Variables for Edge Between Factory 0 and Warehouse 0 (Due to the Cost Function):
1. z0_F0_W0_p0−Q_F0_W0_p0>=0
2. z0_F0_W0_p0>=0
3. z1_F0_W0_p0−Q_F0_W0_p0>=−400
4. z1_F0_W0_p0>=0

Flow Variables for Edge Between Factory 0 and Warehouse 1 (Due to the Cost Function):
1. z0_F0_W1_p0−Q_F0_W1_p0>=0
2. z0_F0_W1_p0>=0
3. z1_F0_W1_p0−Q_F0_W1_p0>=−400
4. z1_F0_W1_p0>=0

Flow Variables for Edge Between Factory 1 and Warehouse 0 (Due to the Cost Function):
1. z0₁₃ F1_W0_p0−Q_F1_W0_p0>=0
2. z0_F1_W0_p0>=0
3. z1_F1_W0_p0−Q_F1_W0_p0>=−400
4. z1_F1_W0_p0>=0

Flow Variables for Edge Between Factory 1 and Warehouse 1 (Due to the Cost Function):
1. z0_F1_W1_p0−Q_F1_W1_p0>=0
2. z0_F1_W1_p0>=0
3. z1_F1_W1_p0−Q_F1_W1_p0>=−400
4. z1_F1_W1_p0>=0

Indicator Variables for Edge Between Warehouse 0 and Market 0 (Due to the Cost Function):
1. 1000000000 I0_W0_M0_p0−Q_W0_M0_p0>=0
2. 1000000000 I0_W0_M0_p0−Q_W0_M0_p0<1000000000
3. 1000000000 I1_W0_M0_p0−Q_W0_M0_p0>=−400
4. 1000000000 I1_W0_M0_p0−Q_W0_M0_p0<999999600

Indicator Variables for Edge Between Warehouse 0 and Market 1 (Due to the Cost Function):
1. 1000000000 I0_W0_M1_p0−Q_W0_M1_p0>=0
2. 1000000000 I0_W0_M1_p0−Q_W0_M1_p0<1000000000
3. 1000000000 I1_W0_M1_p0−Q_W0_M1_p0>=−400
4. 1000000000 I1_W0_M1_p0−Q_W0_M1_p0<999999600

Indicator Variables for Edge Between Warehouse 1 and Market 0 (Due to the Cost Function):
1. 1000000000 I0_W1_M0_p0−Q_W1_M0_p0>=0
2. 1000000000 I0_W1_M0_p0−Q_W1_M0_p0<1000000000
3. 1000000000 I1_W1_M0_p0−Q_W1_M0_p0>=−400
4. 1000000000 I1_W1_M0_p0−Q_W1_M0_p0<999999600

Indicator Variables for Edge Between Warehouse 1 and Market 1 (Due to the Cost Function):
1. 1000000000 I0_W1_M1_p0−Q_W1_M1_p0>=0
2. 1000000000 I0_W1_M1_p0−Q_W1_M1_p0<1000000000
3. 1000000000 I1_W1_M1_p0−Q_W1_M1_p0>=−400
4. 1000000000 I1_W1_M1_p0−Q_W1_M1_p0<999999600

Flow Variables for Edge Between Warehouse 0 and Market 0 (Due to the Cost Function):
1. z0_W0_M0_p0−Q_W0_M0_p0>=0
2. z0_W0_M0_p0>=0
3. z1_W0_M0_p0−Q_W0_M0_p0>=−400
4. z1_W0_M0_p0>=0

Flow Variables for Edge Between Warehouse 0 and Market 1 (Due to the Cost Function):
1. z0_W0_M1_p0−Q_W0_M1_p0>=0
2. z0_W0_M1_p0>=0
3. z1_W0_M1_p0−Q_W0_M1_p0>=−400
4. z1_W0_M1_p0>=0

Flow Variables for Edge Between Warehouse 1 and Market 0 (Due to the Cost Function):
1. z0_W1_M0_p0−Q_W1_M0_p0>=0
2. z0_W1_M0_p0>=0
3. z1_W1_M0_p0−Q_W1_M0_p0>=−400
4. z1_W1_M0_p0>=0

Flow Variables for Edge Between Warehouse 1 and Market 1 (Due to the Cost Function):
1. z0_W1_M1_p0−Q_W1_M1_p0>=0
2. z0_W1_M1_p0>=0
3. z1_W1_M1_p0−Q_W1_M1_p0>=−400
4. z1_W1_M1_p0>=0

Constraints to Ensure that Only Open Factories and Warehouses Function:

I0_S0_F0_r0+I0_S0_F0_r0+I1_S0_F0_r0+I1_S0_F0_r0−1000000000 u0<=0

I0_S0_F1_r0+I0_S0_F1_r0+I1_S0_F1_r0+I1_S0_F1_r0−1000000000 u1<=0

I0_F0_W0_p0+I0_F0_W0_p0+I1_F0_W0_p0−1000000000 v0<=0

I0_F0_W1_p0+I0_F0_W1_p0+I1_F0_W1_p0−1000000000 v1<=0
→Here u0 is 1 if factory 0 exists, 0 otherwise.
→u1 is 1 if factory 1 exists, 0 otherwise.
→v0 is 1 if warehouse 0 exists, 0 otherwise.
→v1 is 1 if warehouse 1 exists, 0 otherwise.

Capacity Constraints (Given by the User):

Edge Between Supplier 0 and Factory 0:
1. Q_S0_F0_r0>=4535
2. Q_S0_F0_r0<=93609813

Edge Between Supplier 0 and Factory 1:
1. Q_S0_F1_r0>=4274
2. Q_S0_F1_r0<=19070062

Edge Between Supplier 1 and Factory 0:
1. Q_S1_F0_r0>=921
2. Q_S1_F0_r0<=14437756

Edge Between Supplier 1 and Factory 1:
1. Q_S1_F1_r0>=9957
2. Q_S1_F1_r0<=76629831

Edge Between Factory 0 and Warehouse 0:
1. Q_F0_W0_p0>=1957
2. Q_F0_W0_p0<=197189448

Edge Between Factory 0 and Warehouse 1:
1. Q_F0_W1_p0>=3022
2. Q_F0_W1_p0<=190392801

Edge Between Factory 1 and Warehouse 0:
1. Q_F1_W0_p0>=9454
2. Q_F1_W0_p0<=79483308

Edge Between Factory 1 and Warehouse 1:
1. Q_F1_W1_p0>=8825
2. Q_F1_W1_p0<=99524702

Edge Between Warehouse 0 and Market 0:
1. Q_W0_M0_p0>=6464
2. Q_W0_M0_p0<=163561187

Edge Between Warehouse 0 and Market 1:
1. Q_W0_M1_p0>=3541
2. Q_W0_M1_p0<=178544040

Edge Between Warehouse 1 and Market 0:
1. Q_W1_M0_p0>=7474
2. Q_W1_M0_p0<=10900342

Edge Between Warehouse 1 and Market 1:
1. Q_W1_M1_p0>=3082
2. Q_W1_M1_p0<=13876161

Supplier Nodes:
1. 0<=Cap_S0<=534735816
2. 0<=Cap_S1<=381408084

Flow Constraints (Flow Conservation Equations):

Supplier Nodes:
1. Q_S0_F0_r0+Q_S0_F1_r0−Cap_S0=0
2. Q_S1_F0_r0+Q_S1_F1_r0−Cap_S1=0

Market Nodes:
1. Q_W0_M0_p0+Q_W1_M0_p0−dem_M0_p0=0
2. Q_W0_M1_p0+Q_W1_M1_p0−dem_M1_p0=0

Factory Nodes:
1. Q_F0_p0−Q_F0_W0_p0−Q_F0_W1_p0>=0
2. Q_S0_F0_r0+Q_S1_F0_r0−Q_F0_W0_p0−Q_F0_W1_p0=0
3. Q_F1_p0−Q_F1_W0_p0−Q_F1_W1_p0>=0
4. Q_S0_F1_r0+Q_S1_F1_r0−Q_F1_W0_p0−Q_F1_W1_p0=0

Warehouse Nodes:
1. Q_W0_p0−Q_W0_M0_p0−Q_W0_M1_p0>=0
2. Q_F0_W0_p0+Q_F1_W0_p0−Q_W0_M0_p0−Q_W0_M1_p0=0
3. Q_W1_p0−Q_W1_M0_p0−Q_W1_M1_p0>=0
4. Q_F0_W1_p0+Q_F1_W1_p0−Q_W1_M0_p0−Q_W1_M1_p0=0

Demand Constraints:
1. dem_M0_p0>=1122
2. dem_M0_p0<=45509450
3. dem_M1_p0>=6783
4. dem_M1_p0<=53581444
5. 6.923887022853304 dem_M0_p0+33.163918704963514 dem_M1_p0>=20000000
6. 6.923887022853304 dem_M0_p0+33.163918704963514 dem_M1_p0<=2000000000
7. 11.517273952114914 dem_M0_p0−15.487092252566281 dem_M1_p0>=56935.68695949227
8. 11.517273952114914 dem_M0_p0−15.487092252566281 dem_M1_p0<=77186.99316999305
9. 41.699138412828816 dem_M1_p0>=99264.59885597059
   All indicator variables are integer variables.
   The problem is a mixed integer optimization problem.
   The objective function is linear.
   The allowable demand region is shown by FIG. 44.

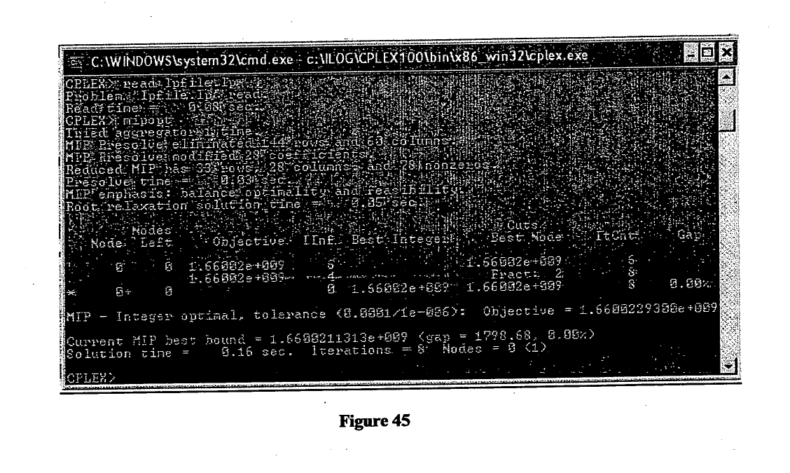

The Output of this Mixed Integer Linear Program is as Given by FIG. 45

The final objective solution is =1660022930.0

The values of the demand variables are:
1. dem_M0_p0=637034.303627008
2. dem_M1_p0=470066.4776889405

→These both lie in the feasible region.

The total demand is: 1107100.781

The Quantity Flowing Through Each Edge:

Total flow between warehouses and markets =1107100.781

Total flow between factories and warehouses =1107100.781

Total flow between suppliers and factories =1107100.781

The flow between supplier 0 and factory 0=4535

The flow between supplier 1 and factory 0=921

Total=5456

The flow between factory 0 and warehouse 0=2434

The flow between factory 0 and warehouse 1=3022

Total=5456

The flow between supplier 0 and factory 1=1091687.781

The flow between supplier 1 and factory 1=9957

Total=1101644.781

The flow between factory 1 and warehouse 0=1092819.781

The flow between factory 1 and warehouse 1=8825

Total=1101644.781

The flow between factory 0 and warehouse 0=2434

The flow between factory 1 and warehouse 0=1092819.781

Total=1095253.781

The flow between warehouse 0 and market 0=6282693036

The flow between warehouse 0 and market 1=466984.4777

Total=1095253.781

The flow between factory 0 and warehouse 1=3022

The flow between factory 1 and warehouse 1=8825

Total=11847

The flow between warehouse 1 and market 0=8765

The flow between warehouse 1 and market 1=3082

Total=11847

→There is flow conservation at each node.

Appendix B

Information Analysis

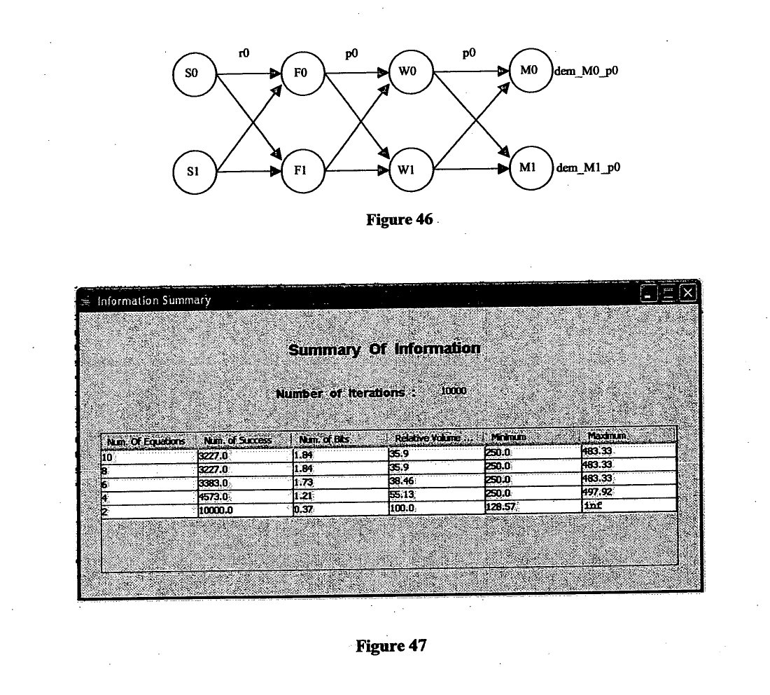

A simple supply chain consisting of 2 suppliers (S0 and S1), 2 factories (F0 and F1), 2 warehouses (W0 and W1) and 2 markets (M0 and M1) is shown in FIG. 46.

The supply chain produces only 1 finished product p0. Since there are 2 markets, there are only 2 demand variables, demand for product p0 at market (dem_M0_p0) and demand for product p0 at market 1 (dem_M1_p0).

Future demand cannot be known in advance, so the 2 demand variables are the uncertain parameters. While Stochastic Programming would represent this uncertainty in form of probability distributions, we represent it with simple linear/non-linear constraints derived form meaningful economic data. The following 10 constraints were derived from demand data.
1. 171.43 dem_M0_p0+128.57 dem_M1_p0<=79285.71
2. 171.43 dem_M0_p0 +128.57 dem_M1_p0>=42857.14
3. 0.51 dem_M0_p0−0.39 dem_M1_p0<=237.86
4. 0.51 dem_M0_p0−0.39 dem_M1_p0>=128.57
5. 57.14 dem_M0_p0+42.86 dem M1_p0<=26428.57
6. 57.14 dem_M0_p0+42.86 dem M1_p0>=14285.71
7. 300.0 dem_M0_p0<=105000.0
8. 300.0 dem_M0_p0>=30000.0
9. 175.0 dem_M0_p0+25.0 dem_M1_p0<=65000.0
10. 175.0 dem_M0_p0+25.0 dem_M1_p0>=22500.0

The objective function was set to be the sum of the 2 demand variables (total demand):
dem_M1_p0+dem_M2_p0

This objective function was optimized for different scenarios, all the predicted demand constraints being valid in the first scenario and only 2 demand constraints being valid in the last scenario. In this way we analyze how the output changes when we go from a more restrictive scenario to a less restrictive one.

The maximum as well as the minimum value was found for the objective function in each scenario. The FIG. 47 is a screenshot from the supply chain management software and shows the results for all the scenarios.
Num. of equations represents the number of equations that were assumed to be valid.
Num. of successes represents the number of points that were lying within the convex polytope formed by the valid constraints, out of all the sample points taken, in a statistical sampling method to evaluate polytope volume.
Num. of bits is the number of bits required to represent the information contained by the valid constraints.
Relative volume is the volume of the convex polytope formed by the constraints in the current scenario relative to the volume of the polytope formed by the constraints in the last scenario (reflects the relative total number of scenarios in the current scenario to the last one).
Minimum is the minimum value of the objective function (may reduce and never increases as constraints are dropped)
Maximum is the maximum value of the objective function (may increase but never reduces as constraints are dropped).

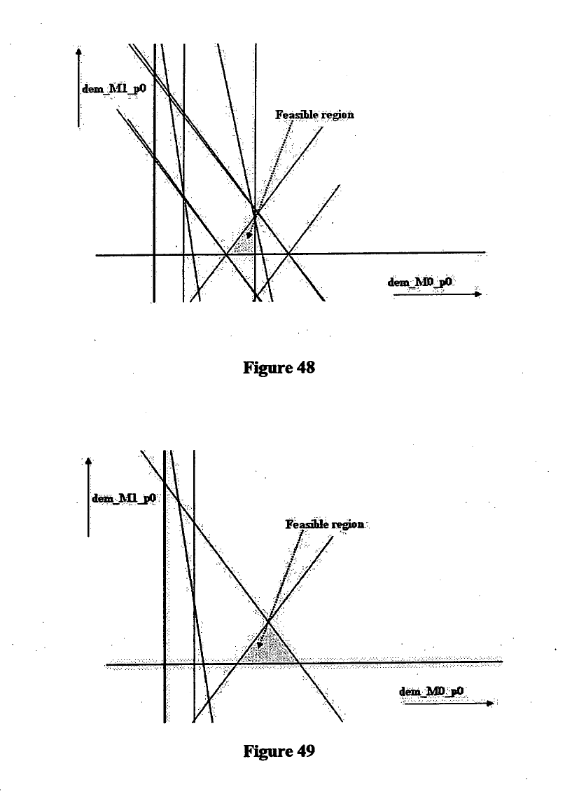

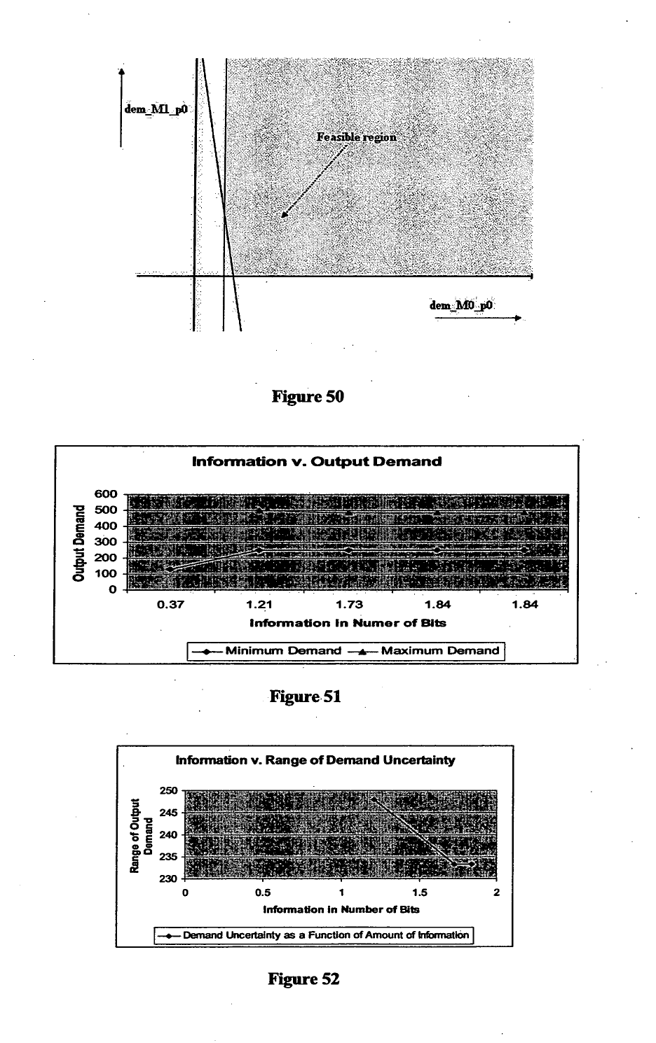

The following is a description of how output maximum and minimum change when the constraints are dropped:
1. The first row of the screenshot in figure (b) results when all the 10 constraints are assumed to be valid. Here the information as estimated from the polyhedral volume (I=−log2 (VCP/Vmax), where VCP is the volume of the convex polytope enclosed by these constraints, Vmax is a normalization volume, reflecting all the possible uncertainties in the absence of any constraints) is 1.84 bits, the minimum demand is 250 and maximum is 483.33.
   The graph in FIG. 48 shows all the constraints for this scenario.
2. In the second and the third row, the output maximum and minimum do not change. This is because in this particular example, the feasible region did not change when 4 constraints were dropped.
4. In the next row, 2 more constraints are dropped and only 4 constraints are valid now. The information content goes further down to 1.21 bits Minimum demand remains same but the maximum goes up to 497.92.
   The graph in FIG. 49 shows all the constraints for this scenario.
5. In the last row, only 2 constraints are valid and the constraint set is no longer bounded.
   The minimum goes down to 128.57 and the maximum becomes unbounded.
   The graph in FIG. 50 shows all the constraints for this scenario.
   This analysis can not only be done for demand variables but also for other objective functions. The same problem was also solved with the total cost of the supply chain as an objective function. The following table tabulates the results for both the objective functions. The minimum cost of the first scenario is taken as 100%. Results for total cost in all other scenarios are represented relative to the minimum cost of the first scenario.

| | | Minimization | | Maximization | |
|---|---|---|---|---|---|
| Num. of | Information | Minimum | dem_M0_p0 + | Maximum | dem_M0_p0 + |
| equations | content | cost | dem_M1_p0 | cost | dem_M1_p0 |
| 10 | 1.84 | 100.00% | 250 | 128.38% | 483.33 |
| 8 | 1.84 | 54.92% | 250 | 597.22% | 483.33 |
| 6 | 1.73 | 54.92% | 250 | 597.22% | 483.33 |
| 4 | 1.21 | 54.92% | 250 | 597.22% | 497.92 |
| 2 | 0.37 | 54.92% | 128.57 | 597.22% | inf |

The graph in FIG. 51 shows the change in the values of the demand objective function with respect to the information content. The maximum demand increases as constraints are dropped. It does not decrease. The minimum demand decreases as constraints are dropped. It does not increase.

The graph in FIG. 52 shows the change in the range of output demand objective function as constraints are dropped. We can see that the range of output increases with decrease in the information content.

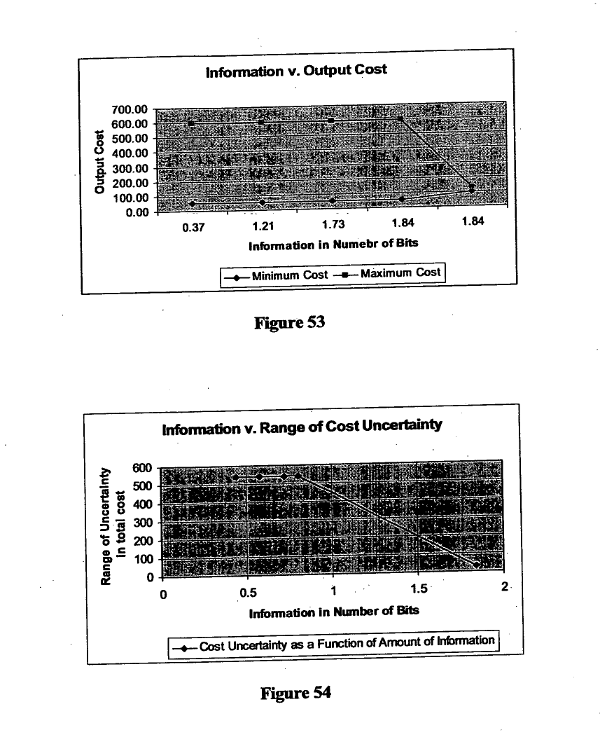

Similarly, the graphs in FIGS. 53 and 54 show the trend for the cost objective function. The maximum cost either increases or remains the same as constraints are dropped. It never decreases. The minimum cost either decreases or remains the same as constraints are dropped. It never increases. And thus the range of uncertainty in cost can only increase and never decrease with the dropping of constraints.

Appendix C

SCM Software

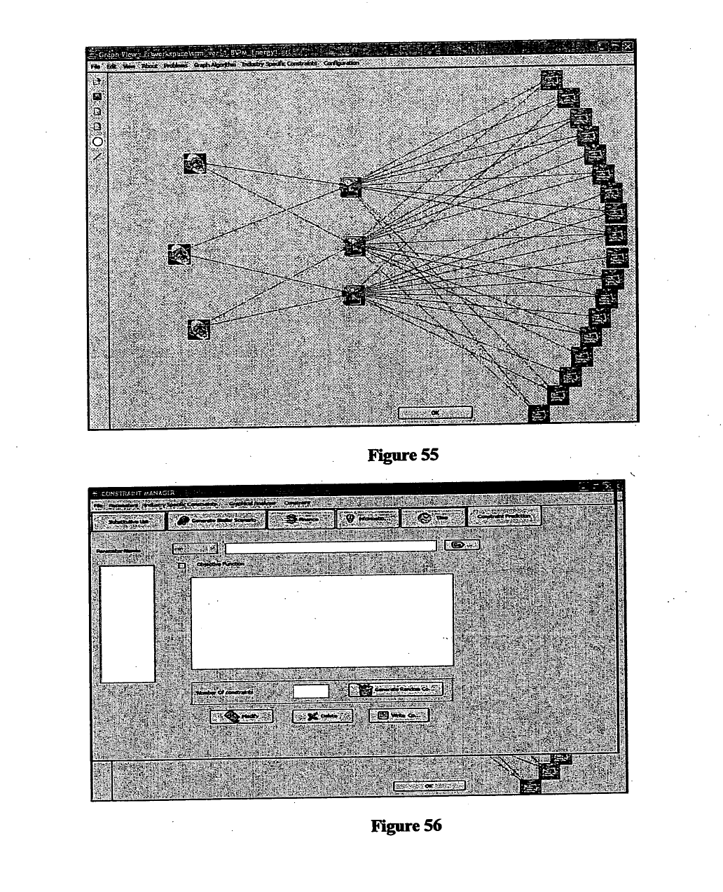

The first screen in the SCM software is the SCM graph viewer and is shown in FIG. 55. Here the supply chain can be seen as a graph with nodes and edges and the values of different parameters in the chain can be entered.

The user can click on the different components in the graph and enter the values of parameters of his/her choice. There are 4 types of nodes in the chain: supplier, factory, warehouse and market. Each of these nodes has their own set of parameters. All parameters are maintained as attribute-value pairs. The value of a parameter might be known or might be uncertain. If the value is known, it is entered through this GUI. If the value is uncertain, then constraints for that parameter are generated in the constraint manager module.

All parameters in this system are multi-commodity, and time and location dependent in general. Any set of parameters can enter into a constraint, a query, an assertion, etc.

All queries in this system are specifiable in Backus-Naur-Panini form, composed of atomic operators − arithmetic <,>,=, set theoretic − subset, disjoint, intersection, . . . − operating on variables indexed by time, commodity or location ids.

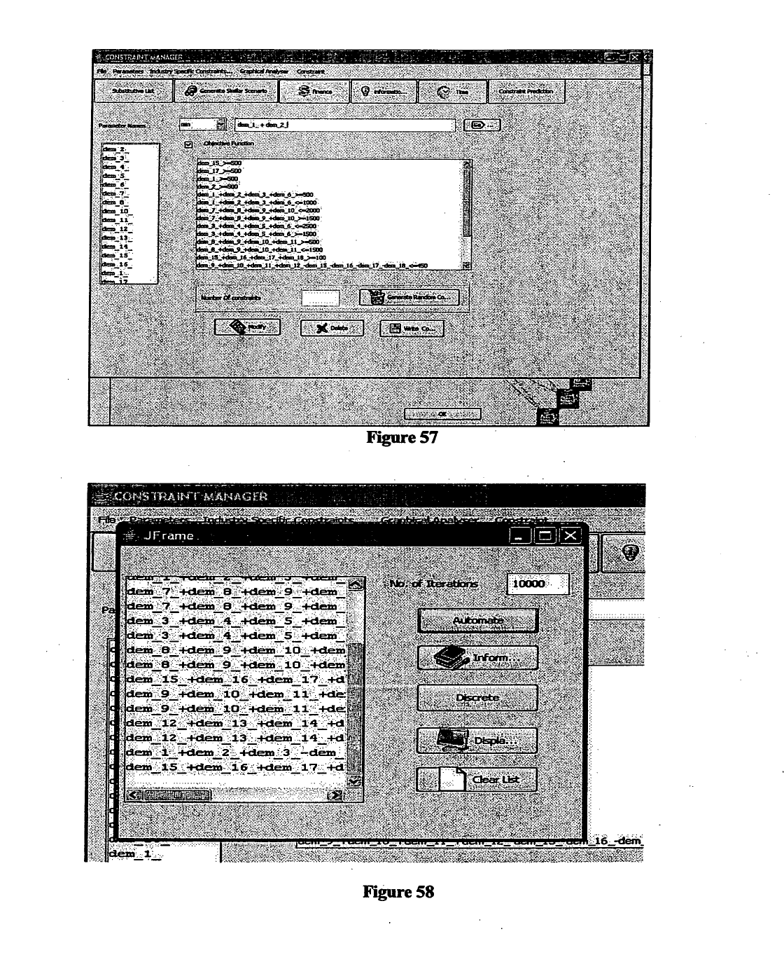

The screen shot in FIGS. 56 and 57 show the constraint manager module. Here the set of parameters for which constraints have to be generated are chosen, for example demand parameters, supply parameters etc. The constraints can be predicted from historical time series data or can be manually entered.

The set of constraints that is generated in this module can be given as input to the information estimation module for estimating the amount of information content or generating hierarchical scenario sets from this set of constraints and analyzing them. These constraints can also be perturbed using translations, rotations, etc, keeping total volume and/or information constant, increased or decreased.

The constraints here are guarantees to be satisfied, and the limits of constraints are thresholds. Events can be triggered based on one or more constraints being violated and can be displayed to higher levels in the supply chain. We can have a hierarchy of supply chain events that are triggered as a constraint is violated.

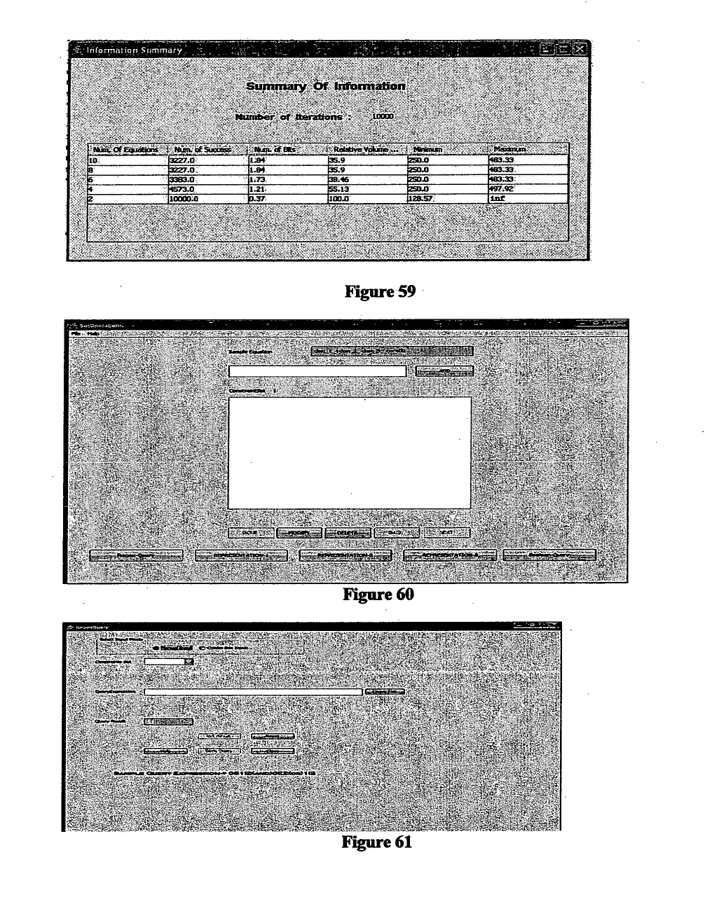

The information estimation module shown in FIGS. 58 and 59 can estimate the information content in number of bits in the given set of constraints. It can also do a hierarchical analysis and produce an output such as below. In addition to producing a hierarchy of constraint sets, the module is also capable of creating equivalent constraint sets. By equivalent, we mean containing the same amount of information. This can be done by performing random translations or rotations on a set of constraints, using possibly:
1. QR factorization of random matrices to generate a random orthogonal matrix, which is used to transform the linear constraints representing the polytope. This corresponds to a rotation in a high dimensional space of the constraint set.
2. General transformation Matrix, with Det=1, or −1.
3. Information content can be changed using transformations with non unity determinants.

This summary of information provides the information content and the bounds on the output for every set of constraints in the hierarchy.

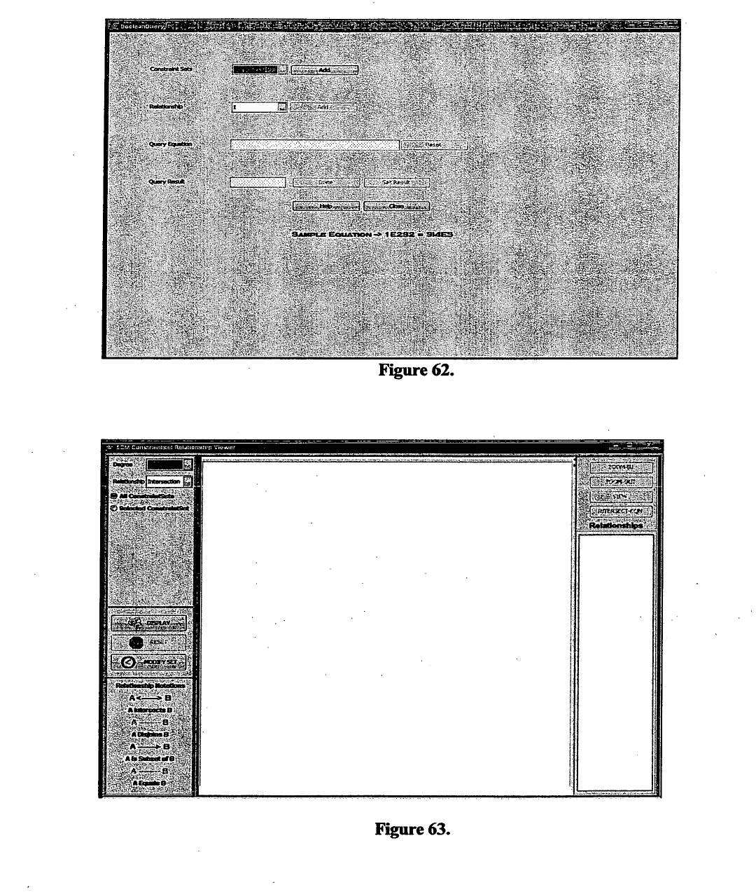

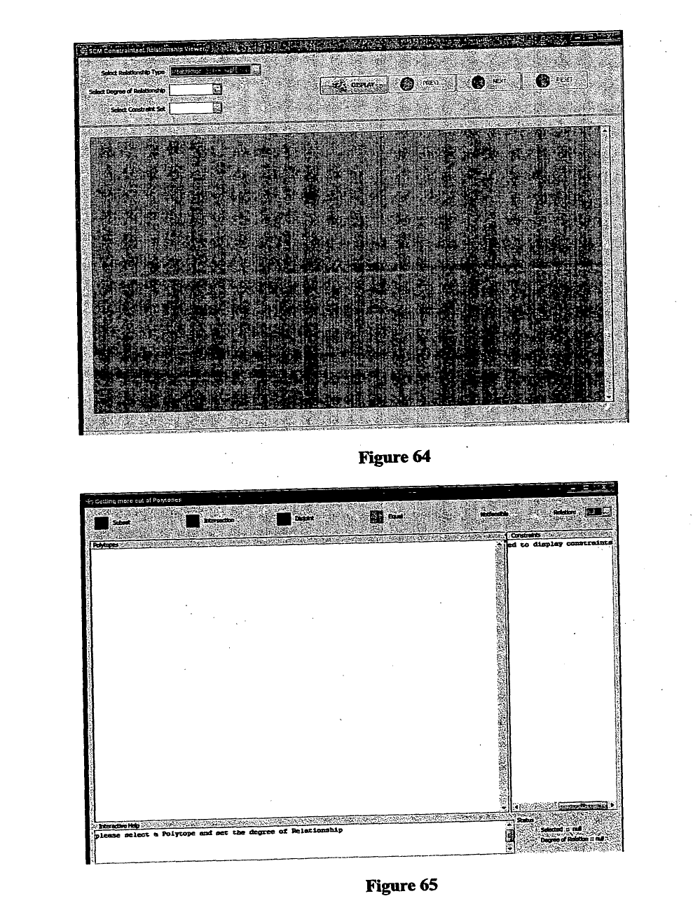

The set of constraints from the constraint manager module can also be given as input to the graphical visualizer module which is shown in FIGS. 60 to 65. The graphical visualizer module displays the constraint equations in a graphical form that is easy to comprehend. Here the user can not only look at the set of assumptions given by him, but also compare one set of assumptions with another set. This module finds relationships between different constraint sets as follows:
One set is a sub-set of the other
Two constraint sets intersect
The two constraint sets are disjoint
A general query based on the set-theoretic relations above can also be given. For example, the query A Subset (B Intersection C)? checks if the intersection of B and C is encloses A.

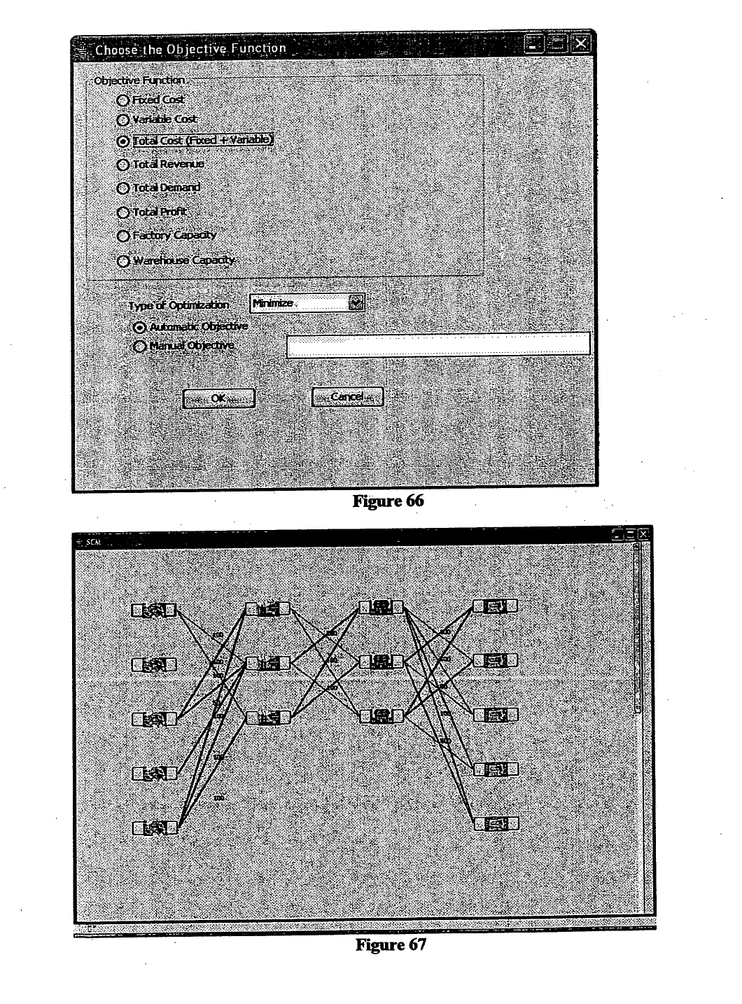

The set of constraints from the constraint manager module can also be given as input to the capacity/inventory planning module and some optimization can be performed on the supply chain structure subject to these constraints. The type of optimization can be selected by the user. For example, the user can select the objective function and the type of optimization from the screen in the capacity planning module shown in FIG. 66.

Once the problem has been specified, an LP file is generated and sent to CPLEX solver to solve it. The output of the CPLEX solver is read by the output analyzer module and displayed to the user.

The output analyzer shown in FIG. 67 can not only display the output in a graphical form but the user can select parts of the solution in which he/she is interested and view only those. The user can zoom in or zoom out on any part of the solution. There is a query engine to help the user do this. The user can type in a query that works as a filter and shows only certain portions, satisfying the query (a query is a general Backus-Naur-Panini form specifiable expression composed of atomic operators). The module has the capability of clustering similar nodes and showing a simplified structure for better comprehension. The clustering can be done on many criteria such as geographic location, capacity etc. and can be chosen by the user. This makes a large, difficult to comprehend structure into a simplified easy to analyze structure.

The Backus-Naur-Panini form specifying the query language for the graphical visualizer as well as the output analyzer is based on atomic operations in the relational algebra used by both of them. The constraint visualizer uses set theoretic relational algebra between the polytopes as subset, intersection and disjointness relations. For the output analyzer, relational algebra can be developed in terms of the portions of the solution that the user wants to display. For example, display the factories whose capacity is more than 500 units, or display all the suppliers, factories and warehouses that supply market 5 etc.

The auctions module is another application of the intuitive specification of uncertainty. Here the constraints are not on demands, supplies etc. but on the bids and on the profit of the auctioneer etc. Bids are constraints sent by the bidders to the auctioneer, who selects the best set of bids according to his/her optimization criterion (min/max revenue, etc). In response the bids are changed by the bidders in the next round.

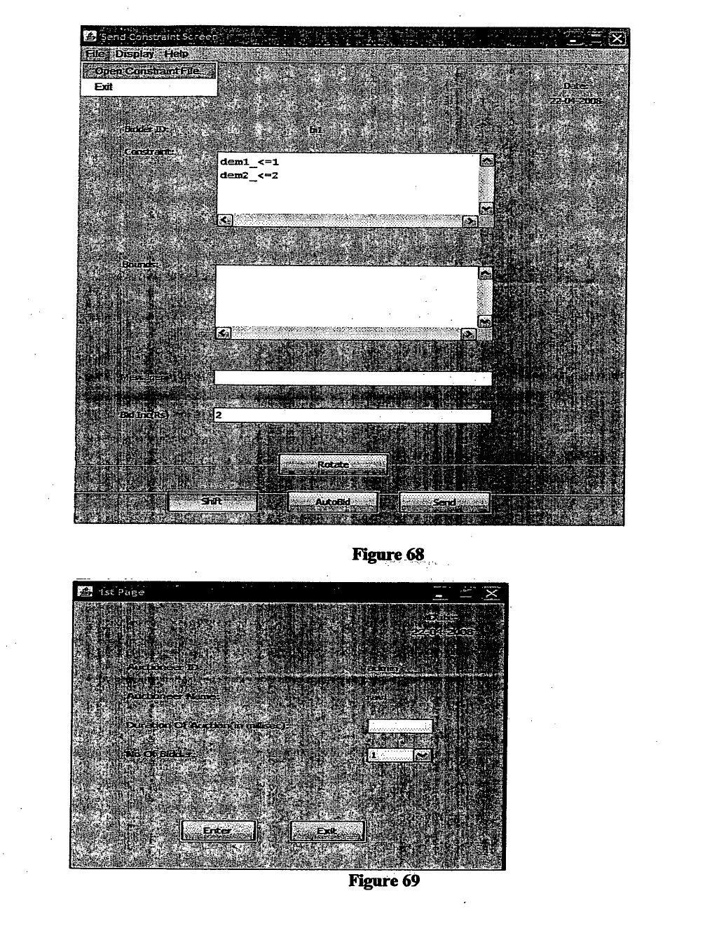

The screen shot for the bidder is given in FIG. 68. The bidder can form a set of constraints and send it to the auctioneer.

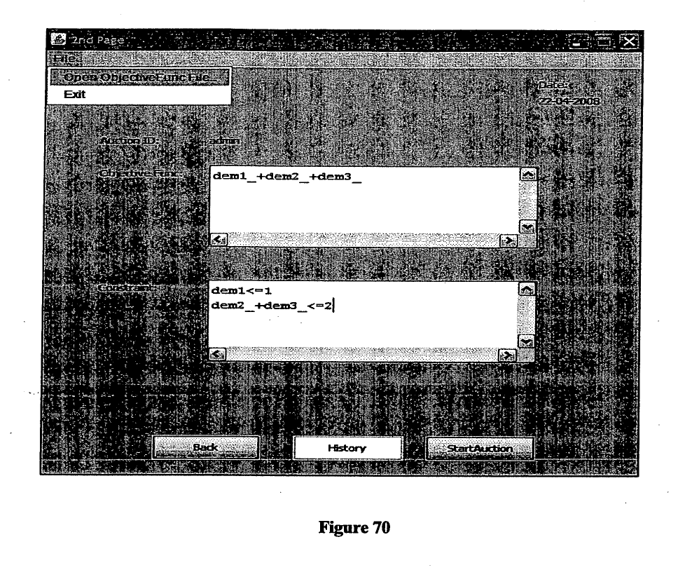

The screen shots for the auctioneer are given in FIGS. 69 and 70.

Similar to the auction module, we can treat the constraints as bids for negotiations between trading partners (or legally binding input criteria for a certain level of output service). This can be the basis for contract negotiations. Constraints can be designed by each party based on their best/worst case benefit.

Appendix D

Constraint Prediction and Scenario Set Generation

Constraint Prediction

For a given statistical or historical data, the best constraint set which represents the smallest polytope (or satisfying another criterion) should be derived. Linear programming techniques are used to solve the problem, analogous to well known least squares techniques.

We first recall the least square technique. Say we have a set of data, (xᵢ,yᵢ). If there exists a linear relationship between the variables x and y, we can plot the data and draw a “best-fit” straight line through the data. This relationship is governed by the familiar equation y=mx+b. We can then find the slope, m, and y-intercept, b, for the data. Linear regression explains this relationship with a straight line fit to the data. The linear regression model postulates that

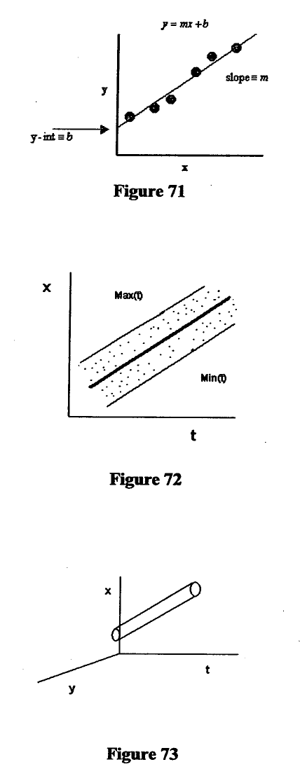

Y=a+bX+e

Where the “residual” e is a random variable with mean zero. The coefficients a and b are determined by the condition that the sum of the square residuals is as small as possible (see FIG. 71.).

Now, we consider the problem of constraint prediction. Considering a set of data for a single dimension x over time t, and taking time as a variable. If the data are approximately linear with time, we can represented it as a straight line.

k2<=a₁t+a₂x<=k1

where the coeffs a1 and a2 are such that the line tightly encloses the data (k1 and k2 are close to each other). See FIG. 72.

In the case of two dimensions x and y, over time t, the scatter plot can be represented by a cylinder that moves in time. See FIG. 73.

Likewise if there are N variables, potentially changing over time, the plot will represent a convex polytope that will slide over time. For N dimensions, an N+1 dimensional solid will be plotted. The constraint prediction problem is to determine one or more constraints which represent this sliding polytope. This is discussed further below.

Assume that we have data x1, x2, x3, . . . These datapoints could be samples of demand of one commodity over time, multiple commodities at one or more times, etc. Let the constraints be of the form

Min<=a₁x₁+a₂x₂+ . . . <=Max

Here x₁ , x₂ . . . are known from the given data. The constraint which is best has to be found i.e. we have to determine the set of coefficients a1, a2, . . . , which result in the smallest difference between Max and Min (we have to do a normalization, to avoid the trivial solution a₁=a₂= . . . =0, more of this later).

For concreteness, let us slightly change our notation and define x₁(0), x₂(0), . . . as samples of demand, supply, etc of commodities 1, 2, . . . at time 0—they are samples of the parameters at time 0. These are obtained from observations, historical records, etc.

Let V be the vector of coefficients V=a₁, a₂, a₃, a₄, . . . We have:

Let us define A(k)=a₁* x₁(k)+a₂*x₂(k)+ . . . , where x₁(k), x₂(k) are the samples of the uncertain parameter values at time k

We Have

A(0)=a₁*x₁(0)+a₂*x₂(0)+ . . .

A(1)=a₁*x₁(1)+a₂*x₂(1)+ . . .

A(2)=a₁*x₁(2)+a₂*x₂(2)+ . . .

These equations can be put in matrix form as:

A=[X]*V,

where [X] is the Matrix of X values, each row of which corresponds to a time instant, each column of which is a different parameter.

We need to find the V which minimizes the maximum spread of [X]*V (L_{∞} norm, others metrics can also be used). This can be done by the LP

Minᵥ(Z₁−Z₂)

[X]*V<=Z₁

Z₂<=[X]*V

Normalization constraints on V.

The normalization constraints, are used to avoid the trivial all-zero answer. These constraints can be chosen in various ways, such that the sum of all coefficients is unity, the sum of squares is unity, etc. If the sum of all coefficients is unity, we have

1^{T}V=1

Where 1^{T} is the all ones vector.

These normalization constraints refer to apriori information about the convex polytope. The can even be structural constraints—we can determine the best substititute/complementary/revenue constraints. If other (convex) metrics are used, the optimization can be handled by convex optimization well known in the state-of-art. An example with the L₂ norm is (* is dot product)

Minᵥ (Z₁^{T*}Z₁)

Z₁=[X]*V

Normalization constraints on V.

Since there are many possible normalization constraints, there are many possible answers for the vector of constraint coefficients V. How many constraints should we derive? One answer is to choose them such the volume of the convex polytope formed by these constraints is close to the minimal volume possible—that of the convex hull. Other methods are also possible. Using the constraints comprising the convex hull directly may not be meaningful in the application context—may result in constraints which are neither substitutes nor complements, etc.

A 3-D Example:

Consider a matrix with each row having data values for different dimensions (exemplarily demand for different products) and each column representing the data values for different instances of time.

X₁ c11 c12 c13 . . .

X₂ c21 c22 c23 . . .

X₃ c31 c32 c33 . . .

Then the data will be best represented as per the L_{∞} norm, by the following constraints.

Z₁>=c11x₁+c21x₂+c31x₃+ . . . >=z₂

Z₁>=c12x₁+c22x₂+c32x₃+ . . . >=z₂

Z₁>=c13x₁+c23x₂+c33x₃+ . . . >=z₂

provided cij's are chosen to minimize the objective function z₁−z₂.

Scenario Set Generation

A set of constraints represents a closed polytope in an n-dimensional space, and can be represented by the equation

Ax<=B

where A is the matrix of constraint coefficients, B the right hand side, and x the parameter vector. If a linear transformation is made on X, using a transformation matrix Q,

x=Qx′

the transformed polytope is given by

(AQ)x′<=b

Different choices of Q lead to different constraints, which have different impacts on the optimization, and results in different levels of cost/profit/ . . . etc for the supply chain.

Information is preserved if the transformation is volume preserving—in this case Determinant(Q) has to +1 or −1. Information content can be increased by using a contracting Q (Det(Q)<=1), and reduced by using an expanding Q (Det(Q)>=1). In the above we have assumed that the reference volume is invariant always. This may correspond to (say) hard limits on parameter values.

Of course, changing constraints while preserving information content can be achieved by rigid body translations also.

Suppose we have a set of constraints (S₁) which encloses a volume (V₁). Now we want to generate another set of constraints (S₂) which has the same information content as the reference set S₁. For this to be true, the volume enclosed by S₂ i.e. V₂ should be equal to V₁. To obtain such a required set of constraints from a reference set one way is to perform geometric transformations on the constraint set. The transformation applied can be of three types:
1. keeping shape constant
2. distorting the shape keeping the number of constraints constant
3. distorting the shape and changing the number of constraints also—this introduces new edges in the convex polytope corresponding to the constraints.

In the first case, we utilize an orthogonal transformation (see below), in the second a general linear transformation with determinant +/−1, and the third case a general nonlinear transformation. Of course, an arbitrary translation can also be performed, and this keeps volume constant. We shall not mention the use of translations below, but assume it by implication below.

Case 1: Rigid Body Rotation i.e. Rotation While Keeping Shape Constant

We can rotate a polytope in an n-dimensional space by multiplying it with an orthogonal matrix with determinant +1. If we want to generate a large number of rotated polytopes (corresponding to rotated constraints sets as per the description), we need to generate a number of random matrices. To achieve this we will multiply the original constraint matrix A, with a randomly generated orthogonal matrix. An exemplary procedure followed to obtain a random orthogonal matrix is briefly explained in procedure A.
Procedure A:
   1. Generate any random square matrix (n x n).
   2. Perform QR decomposition on this randomly generated matrix. (M=QR, where Q is orthogonal, R is upper triangular)
   3. Check for the determinant of the Q component of the matrix. For a rigid rotation without inversions, the determinant should be +1. If the determinant is −1, the rotation will in general have a possible inversion. The determinant is calculated using LU decomposition or other methods well known in the state-of-art
The new constraint set (AQX<=B) generated by multiplying A with Q represents the original constraint set (Ax=B), rotated by a random amount in N-dimensions.

Case 2: Distorting the Shape While Keeping Volume Constant

We can transform a polytope in the n-dimensional space and at the same time change its shape but keep the volume constant by multiplying it with any matrix of determinant +1. To obtain a random transformation, we generate a random matrix and modify it to have determinant unity as exemplified by the following procedure:
Procedure B:
   1. Generate any random matrix (n x n).
   2. Calculate the determinant of the matrix using LU decomposition.
   3. Find the n^{th} root of the determinant. And divide all the elements of the matrix by this n^{th} root. The matrix thus obtained will have a determinant +1.

After we have obtained the transformation matrix, we need to multiply it with the reference matrix. The procedure has been explained in procedure C, and corresponds to using A′=AQ, in addition to checking for non-negativity constraints for the variables which are restricted to have only non-negative values (e.g. total demand, supply, cost etc).
Procedure C:
   1. Get the rotation matrix using procedure A or B as required.
   2. Multiply it with the reference matrix.
   3. Check whether any positively constrained parameter has scaled to negative quadrant, or any unallowed region represented using linear constraints (this can be done by an LP). If so translate the polytope so that the parameter completely lies in the positive quadrant. Translation can clearly be used for a variable to move it to lie between any desired bounds (e.g. −100 to 200), as long as the range of the variable fits inside the range of the bounds (300).

Case 3: Introducing New Constraints Keeping Volume Constant

This case corresponds to a general nonlinear transformation on the constraint polytope, and can take a variety of forms. An illustrative example was given earlier in FIG. 47 (triangle having same area as the original square).

We stress that transformations need not keep volume constant. We can have transformation which increase volume and lower information content, by replacing A with (AQ), where Det(Q)<1, decrease volume and increase information content, by replacing A by (AQ) where Det(Q)>1, etc.

An Illustrative Example:

Application of Constraint Transformations

Here we specify one possible application of constraint transformation—there are many others also.

We take an example from supply chain management Keeping the example as simple as possible, we consider that there is a company that needs to decide on profitability, having demand for only two products dem_1 for product 1 and dem_2 for product 2. The demands represented in x and y axis in a two dimensional space are dem_1 and dem_2 respectively.

Consider a scenario described by following equations:

dem_{—}1>=0

dem_{—}2>=0

dem_{—}1<=50

dem_{—}2<=10

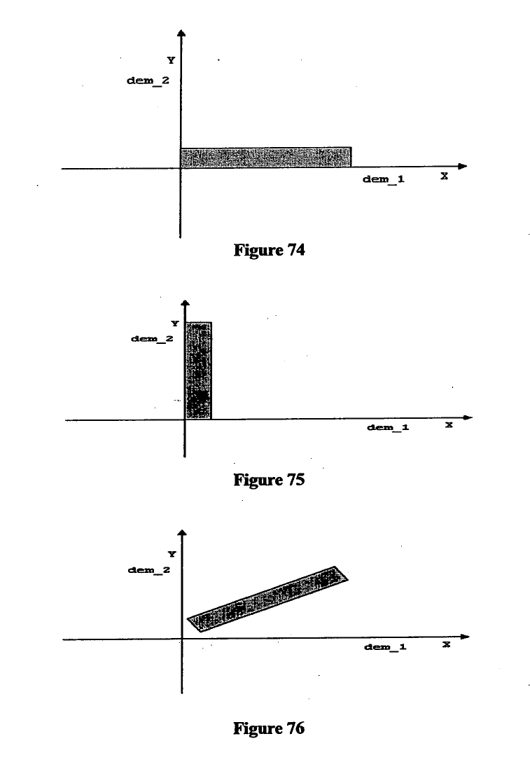

The above scenario can be graphically represented as in FIG. 74.

Assume that for the company, the profit depends primarily on product 1 and that the demand of that product i.e. dem_1 is uncertain; product 2 has negligible impact on the profit for the company (it could be sold at cost itself). But in this scenario the company has some information which is certain; and would like to stick to that information. From the figure it is clear that dem_1 has a higher degree of uncertainty, resulting in profit uncertainty. The company would like to have a better estimate of its profit and hence would like to reduce the uncertainty in the profit by reducing the uncertainty in the demand of product 1, while keeping the total uncertainty under which the company's policies are designed constant (this may be a minimum requirement for safe operation). This can be achieved by operating in a regime, which corresponds to rotating the scenario set in the two dimensional plane. Ideally, the situation after rotation should have minimum value of dem_1 i.e. there should be a rotation of 90 degrees.

Clearly the scenario reflected by this new set of constraints was not predicted by the market survey, and requires measures for this to occur in practice. Whether this scenario is achievable in practice depends on how much control the company, a consortium formed from multiple companies, or possibly regulatory bodies have on the market (this is outside the scope of this discussion). This situation can be illustrated as in FIG. 75.

However, a scenario between the worst case and best case can also be obtained. One such case is depicted in FIG. 76.

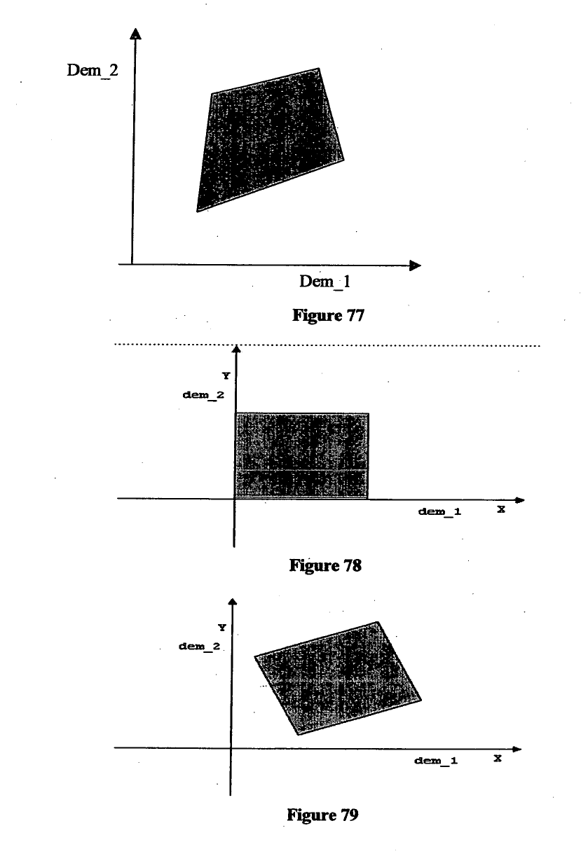

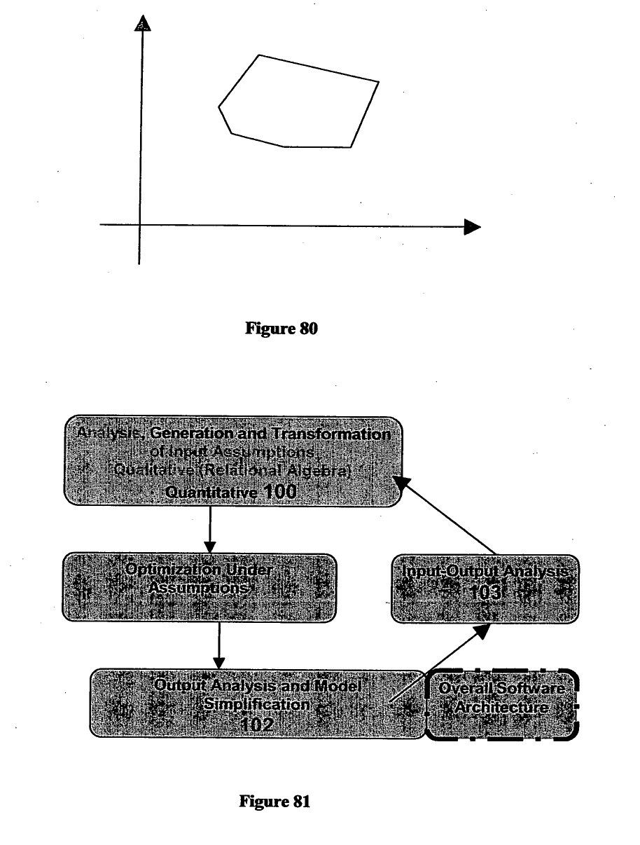

Another way by which the user can obtain new set of scenarios keeping volume fixed is by distorting the constraint polytope as shown in FIGS. 77 to 80. Some of the possible resulting scenarios can be represented as follows in the two dimensional plane (the last one has two more constraints).

It is also clear that these same transformations can be generalized to increasing the volume and decreasing the information content, and vice versa.

Starting from an initial set of constraints, this procedure enables us to generate many constraints, which have the same information content, or less information content, or more information content.

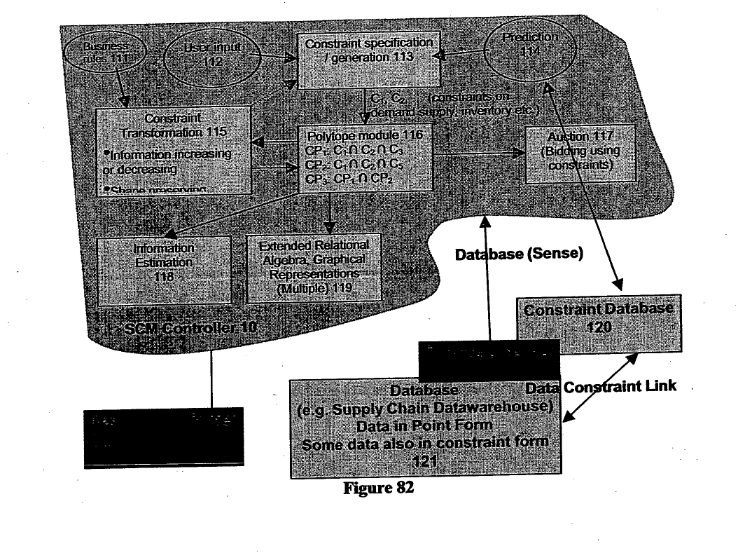

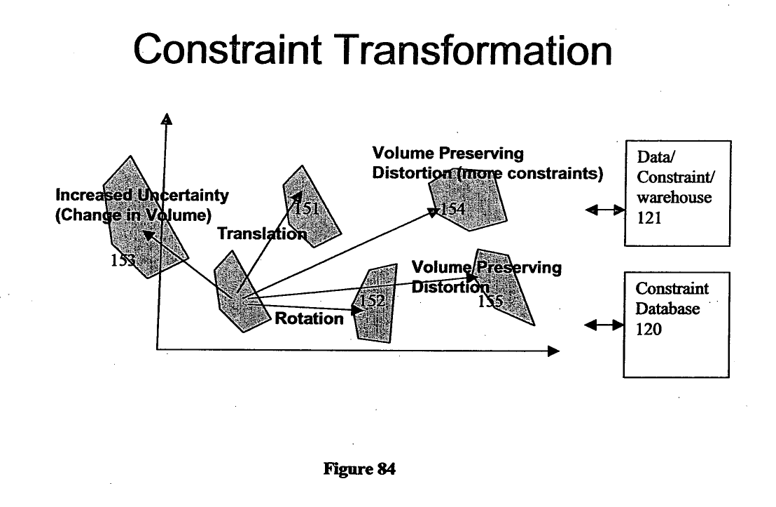

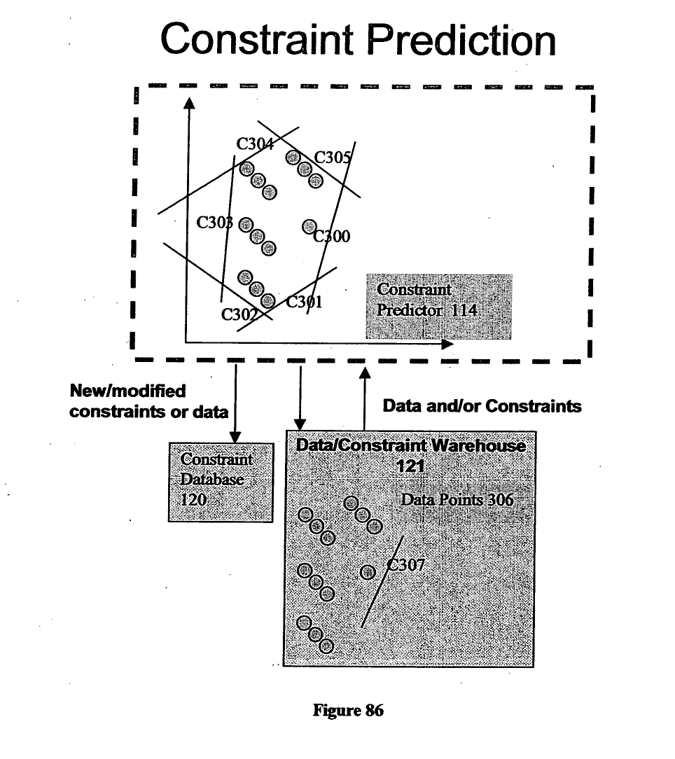

The procedures of constraint prediction and transformation can exemplarily read/write data/constraints from a data/constraint warehouse, or a constraint database, as exemplified by data/constraint warehouse 121 and constraint database 900 in FIG. 82, data/constraint warehouse 121 and constraint database 120 in FIG. 84 , or data/constraint warehouse 121 and constraint database 120 in FIG. 86

### I. DETAILS OF AN EMBODIMENT OF THE INVENTION

Based on the principles outlined in the description above, and the details of the embodiment in the Software Architecture section, we present further discussion of possible embodiments and applications of the invention, which is capable of real time data analysis and control for a supply chain and similar entity. The description here describes both the functional elements, and the mapping of parts of these functional elements to the elements of the embodiment already described in the Software Architecture section and elsewhere. Also described is the operation of the embodiment, including embodiments of flow of control amongst these elements.

This embodiment addresses the central problem of decision support systems under uncertainty, for supply chain management and similar fields, and presents a novel application of robust programming [I] combined with information theory to supply chains and similar fields. Issues addressed by the embodiment include:
1. How do I do future planning without making ad-hoc assumptions about demand, supply, etc?
2. Is there a way to avoid detailed probability distributions used by stochastic programming methods, or ad-hoc robust programming constraints?
3. Can I quantify assumptions about the future?
4. Can I compare and relate two different assumptions about the future?
5. Can I optimize over these assumptions, and relate the optimization outputs to the inputs?

The embodiment is capable of giving an affirmative answer to these questions. It can be employed in multifarious domains, including
Supply Chains
E-commerce
Mobile Search
Telecommunication
MCAD/ECAD packages
Banking and Risk Assessment
Medical data analysis about causative factors/triggers for diseases?
General Optimization

In each domain, we have domain specific constraints forming the assumption set.

The entire embodiment can be instantiated as a monolithic software entity, in HARDWARE, or a modularized service using exemplarity SOA/SAAS software methodologies.

1. Functional Components of Decision Support System

The invention in one embodiment proceeds in 4 functionally distinct phases, which are detailed subsequently. These phases can be iterated with changes in the input assumptions, optimization, etc till an adequate answer to the decision problem is attained. We note that depending on the application, one or more phases can be skipped and/or the order in which they are called changed. In the description below, only the functions of these phases (not their implementation/embodiment) is specified. Details of a specific embodiment are specified subsequently in the Section “Supply Chain Controller”, with additional details in the section “SCM Software Architecture” and figures and screenshots therein in the description.
Input Assumption Analysis Phase (module 100 in FIG. 81): In this input assumptions phase 100 of FIG. 81, a wide variety of input assumptions can be input, transformed, predicted from historical data, and compared. Each input assumption is a set of linear/non-linear constraints, a convex polytope if constraints are linear.
Optimization Under Assumptions (module 101 in FIG. 81): In this optimization phase 101, optimizations are undertaken under a wide variety of input assumptions, both for capacity planning and inventory optimizations.
Output Analysis (phase 102): The multidimensional output is analyzed/simplified in the output analysis phase 102, in a wide variety of ways, and simple models are derived, based on clustering nodes, products, etc or other methods.
Input-Output analysis phase 103: The relation between the input and outputs is compared in the input-output analysis phase 103. Specifically
   The uncertainty in the output is compared to that in the input.

2. Application in a Supply Chain Controller

The embodiment can be applied in a supply chain controller 10 as shown in FIG. 82. The input analysis package (including all functions of constraint generation—user-input in module 112, prediction from database data in prediction module 114, transformations in module 115, etc, extended relational algebra engine 119, and the information estimator 118), and the response optimizer module 122 form the core of supply chain controller 10. This controller is provided
1. Access to data/constraint warehouse 121, and constraint database 120, where the state of the supply chain is stored. The state of the supply chain is the set of all quantities impacting and impacted by the supply chain, is available in data/constraint warehouse 121.
2. Constraints which have to be always satisfied by the state of the supply chain system. For example, the minimum guaranteed supply has to be above a threshold, inventory of a particular product has to be between min and max limits, the total maintained inventory has to be between min and max limits, the total cash outflow has to be limited, etc. These constraints may reside in the constraint database 120 or a data/constraint warehouse 121, or in the memory of the computer system hosting the controller. In an exemplary embodiment, data is accessed from the data warehouse 121. Constraints which the data has to satisfy are available in the controller memory (and possibly stored in the same data/constraint warehouse 121, or another constraint database 120). For the data to be correlated with the constraints, an appropriate linking system (indexing) between the data warehouse data and the constraint data has to be available.

The SCM controller 10 analyzes the data to see if one or more constraints are satisfied and/or violated. Depending on the results, actions determined by response optimizer 122 and exemplified by the trigger-reorder action described in FIG. 89 (generalized basestock) are undertaken. The particular action determined by response optimizer 122 is determined by methods including business rules in the optimization phase 101 of FIG. 81. The output analysis 102 and input-output analysis 103 phases of FIG. 81 can be used to analyse the features of the determined actions of the supply chain and the resultant state of the system, and correlate it to the constraints which have to be satisfied.

3. Input Analysis Phase

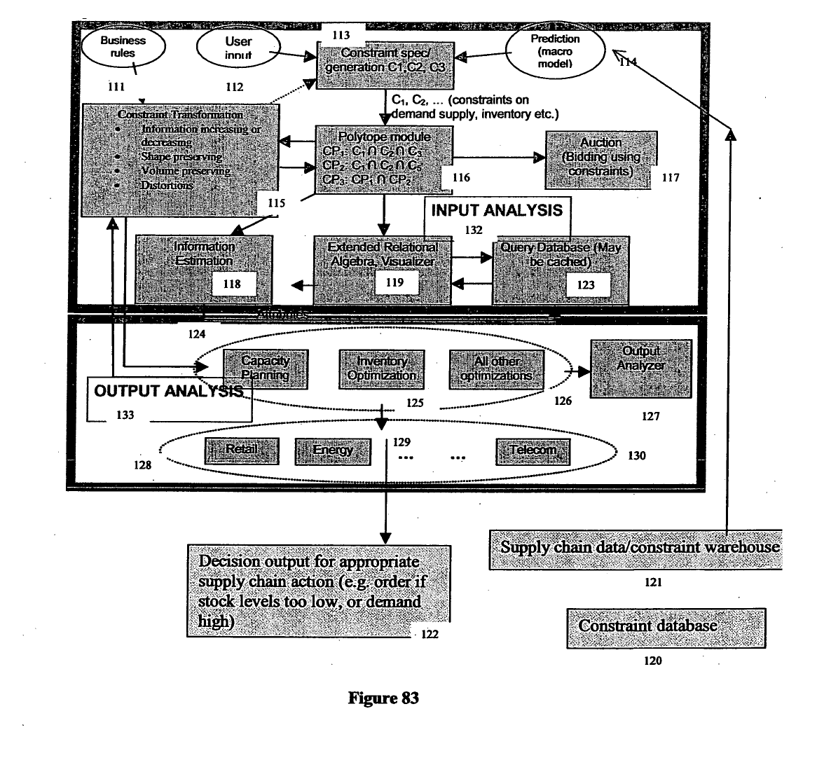

The operation of the input analysis phase (100 in FIG. 81) is further described in FIG. 83, which depicts input analysis module 132. First, a set of constraints is created, based on either
User Input 112, creating constraints in constraint specification/generation module 113.
Prediction 114 from historical time series data, plus a-priori information about the constraints. In other language, the input analysis engine 132 looks at the database 121 and creates a model of its contents—these are the constraints derived from the point data. In this embodiment, the predictor is a database-modeling engine, which transforms point data into constraints.
Transformation 115 from pre-existing constraints, preserving information content (or increasing/decreasing it), using rotations, translations, distortions as outlined in the description above.

Each set of constraints in polytope module 116 (exemplarily forming a polytope if all constraints are linear) is an assumption about the supply chains operating conditions, exemplarily in the future. Multiple sets of constraints can be created (CP1, CP2, CP3, in polytope module 116), referring to different assumptions about the future.

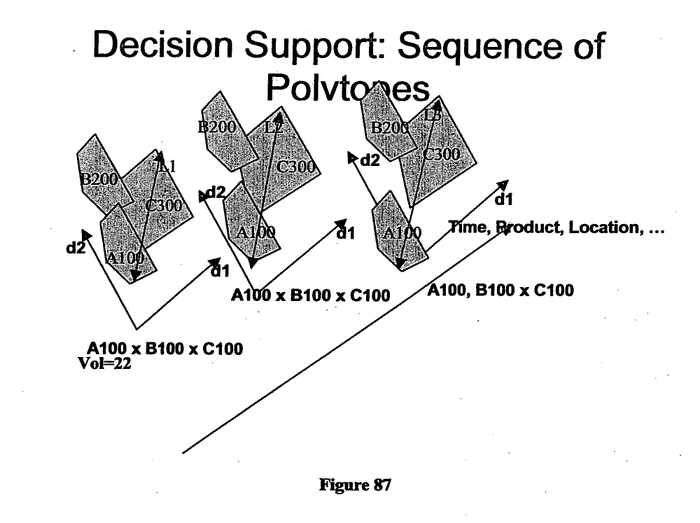

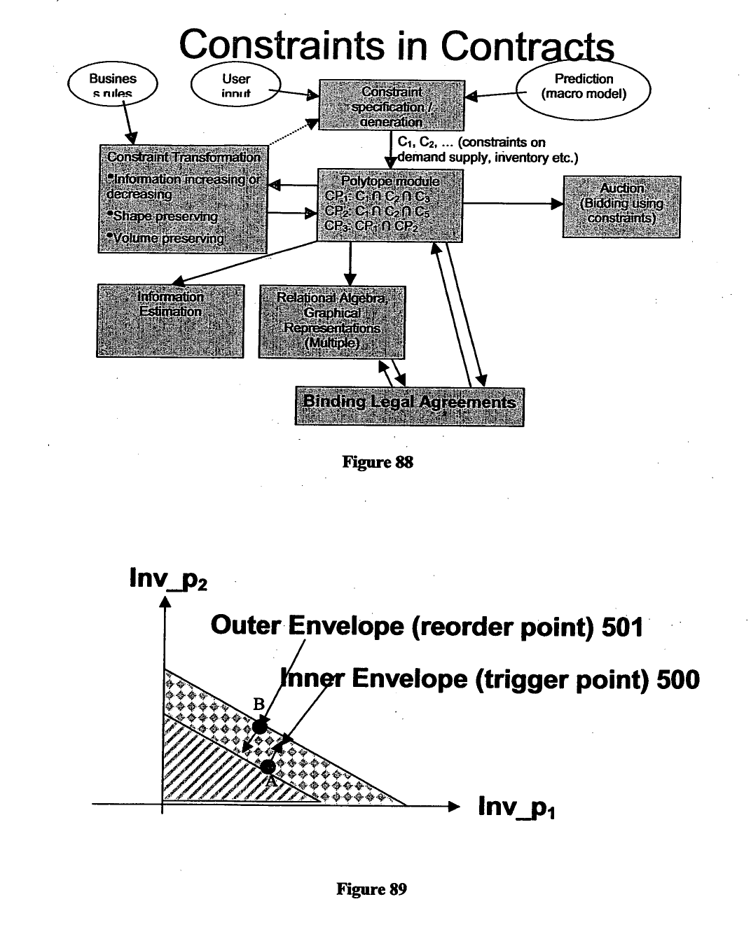

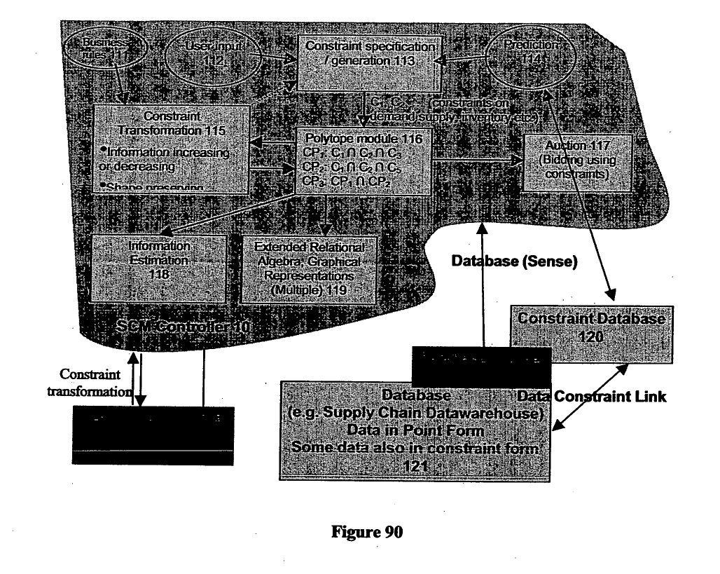

Then, analysis, done in the input analyzer 132 s performed using the following steps (not necessarily in this order)
1. Analysis of each assumption (polytope) by itself for information content—this is the information estimator 118 as described in our earlier PCT application published under No. WO/2007/007351.
2. Analysis of different assumptions (polytopes) in extended relational algebra module 119 to determine if
   Are two assumptions totally different—disjoint sets?
   Do they have something in common—intersecting?
   Is one a superset of the other, which is more general?
Input analyzer 132 performs this analysis and depicts a graphical output as exemplarily described in our Patent Application 1677/CHE/2008, and depicted in FIG. 87, and further explained subsequently.
3. In the case of constraints sets (polytopes) evolving with time, or other index variables, the extended relational algebra module 119, plots the evolution of the relations between the polytopes. While this can be solved by repeatedly calling the basic algorithms outlined above, these can be considerably speeded up by using methods of incremental linear programming, wherein small changes in constraints sets do not necessarily change the basis globally.
4. Metric-based Analysis: In addition to set theoretic properties, metric-based properties (distance, volume) can also be evaluated in extended relational algebra engine 119, to obtain further information.
   1. In the case of polytopes A and B, it is of interest to determine how far apart they are. This can be solved by the linear program given below. C_{A}/B_{A} is the constraint set/right hand side for A, C_{B}/B_{B} for B, and X is a point in A and Y in B.

A={X:C_{A}X<=B_{A}}

B={Y:C_{B}Y<=B_{B}}

Min∥X−Y∥

C_{A}X<=B_{A}

C_{B}Y<=B_{B}
Maximizing instead of minimizing finds the points in the two polytopes farthest from each other, and this can be used to normalize the minimum distance. Instead of the min of absolute value another norm like the L₂ norm can be used also, using convex optimization. Note that this can be used even if the polytopes are intersecting (min is always zero, and max can be determined)
In addition to the min/max distance between polytopes, the distances between two random points inside each, distance between analytic centers (using convex optimization), distances between each polytope and any or all the constraints of the other, etc can all be found using techniques well-known in the state-of-art (having runtimes polynomial in the problem size).
2. In the case of A being a subset of B, we need to know how smaller (relatively) A is compared to B. This can be estimated from volume estimation methods, comparing the volume of A to B by sampling algorithms.
3. In the case of A and B being neither disjoint nor subsets, we would like to know what percentage of A and B are in the intersection, which can be analyzed using volume estimation methods, using either A or B as a normalizing volume.
In addition to the distances and volumes, projections of the polytope along the axes or random directions can be used to determine their geometric relations.
The relational algebra relations (subset, disjoint, intersecting), together with associated min/max distances between polytopes, and their volume, form the basis for input analysis, and these are depicted in FIG. 87, and further explained subsequently.
In a real time supply chain, inputs are read from the supply chain data/constraint warehouse 121 and/or constraint database 120 FIG. 83, which is updated in real time. The answers from input analysis can be used to trigger responses 122 in FIG. 83, where exemplarily orders are triggered if stock levels are too low, or demand levels are high.

A. Input Analysis Database

Input Analysis operates on sets of constraints derived from exemplarily historical data in a supply chain data/constraint warehouse 121 or constraint database 120 (containing earlier formed constraints) in FIG. 83. The constraints are arbitrary linear or convex constraints, in demand, supply, inventory, or other variables, each variable exemplarily corresponding to a product, a node and a time instant. The number of variables in the different constraints (constraint dimensionality) need not be the same. Zero dimensional constraints (points) specify all parameters exactly. One-dimensional constraints restrict the parameters to lie on a straight line, two dimensional ones on a plane, etc.

These constraint sets are the atomic constituents of an ensemble of polytopes (if all constraints are linear), which are made using combinations of them, as shown in the examples below. We assume that C1, C2 and C3 are linear constraints, and C4 is a quadratic constraint over supply chain variables, such as:
C1: 100<=dem1+dem2<=200 (total demand for products 1 and 2 is between 100 and 200 together)
C2: −200<=dem3−dem4<=200 (demand for products 3 and 4 track each other within 200 units)
C3: 4000<=3*dem3+5*dem 4<=6000 (total warehouse space occupied by product 3 (one unit of which take 3 units of space) and product 4 (one unit of which takes 5 units of space) is between 4000 and 6000
C4: 8000<=p1*dem 1+p2*dem 2+p4*dem4−c3*Inv_3<=10000 (the total revenue incurred in selling product 1 at price p1 (itself a variable), product 2 at price p2 and product 4 at price p4, minus the expense incurred in keeping Inventory of product 3 is between 8000 and 10000)
C5: 200<=p1+p2+p4<=300 [The sum of selling price of products 1, 2 and 4 is between 200 and 300]

P1=C1 AND C2

P2=C1 AND C3

P3=P1 AND P2

Q4=P1 AND C4

The first polytope is formed by constraints C1 and C2, the second one by C1 and C3, but the third polytope is succinctly written as the intersection of P1 and P2. Q4 is the intersection of a quadratic constraint and P1, and hence is not a polytope, but a general constraint region. The set of all the polytopes (or general constraint regions, of various dimensions), together with the constraints forms a database of constraints and their compositions viz. polytopes, part of which is attached to polytope module 116 (but not shown to avoid cluttering the diagram), and part of which is in query database 123. This database of constraints drives the complete decision support system. These constraints and polytopes can be time dependent also. The constraint database is stored in a compressed form, by using one or more of:
1. Standard Compression Techniques like Lempel-Ziv.
2. Optimizing Polytope Representation in terms of other polytopes, i.e. using the most succinct representation, determined using algebraic simplification.

Then these polytopes are analyzed to determine their qualitative and quantitative relations with each other, as outlined in the description above.

Database Optimizations.

In addition to one-shot analyses of relationship between polytopes, decision support systems have to support repeated analyses of different relations made up of the same constraint sets. Let A, B, C, D, and X be constraint sets (polytopes or general constraint sets under nonlinear constraints). Then in a decision support system, we would like to verify the truth of

A≠φ

B≠φ

C≠φ

A⊂B

A⊂C

B⊂C

X=B×C

D=A×X∪B

B×(A×X)=φ

A×(B×C)−D=B

One method is to explicitly compute these expressions ab-initio from the relational algebra methods presented in the thesis. However, the existence of common subexpressions between the X=B×C, and A×(B×C)−D enables us to pre-compute the relation X=B×C (this is an intersection of two constraint sets, which can be obtained by methods like those described our patent application 1677/CHE/2008), and use it directly in the relation A×(B×C)−D. Common sub-expression elimination methods (well known in compiler technology) can be used to profitably identify good common subexpressions. These methods require the costs of the atomic operations to determine a good breakup of a large expression into smaller expression, and these costs are the costs of atomic polytope operations (disjoint, subset, and intersection) as outlined in the description above. These costs depend of course on the sizes of the constraint sets—the number of variables, and constraints, etc.

These precomputed relations are stored in a query database 123 in FIG. 82, and read off when required. The database can exemplarily be indexed by a combination of the expression's operators and operands, which is equivalent to converting the literal expression string into a numeric index, using possibly hashing. Caching strategies are used to quickly retrieve portions of this database which are frequently used Since the atomic operations on polytopes are time consuming, pre-computation has the potential of considerably increasing analysis speed. This pre-computation can be done off-line, before the actual analysis is performed.

We note that the relational algebra operators—subset, disjoint, intersection can be used at the conditions in a relational database generalized join. If X and Y are tables containing constraint sets (polytopes), the generalized join X [symbol] [symbol] Y, is defined as all those tuples (x,y), such that x (a constraint set in X) is a subet of, disjoint from, or intersecting y (a constraint set in Y) respectively. This extends the relational databases to handle the richer relational algebra of polytopes (or general convex bodies if nonlinear convex constraints are allowed).

Exemplary Application of Input Analyzer

Below we give an example of the utility of the Input Analyzer embodiment of this invention. Consider the task of optimizing a supply chain for unknown future demand. Depending on the future prediction model, the teams involved in the prediction, etc, very different answers can be obtained. For example, for expansion of a retail chain, some future assumptions are possibly:
The total sales of the company will increase by at least Rs 1000 crores to no more than Rs 2000 crores, AND
The product mix will be no more than 5% different from what it is. AND
The industry revenue will experience a minimum of 3% and a maximum of 10% growth.

### OR

The product mix will migrate by at least 10% to higher paying products, AND
The total disposable income available to spend on goods by the customers will not change by more than 10% AND
The industry profit will experience a minimum of 4% and a maximum of 20% growth.

The first set of assumptions is over variables (Company Sales, Product Mix, Industry Revenue. The second set is over variables (Product Mix, Consumer Disposable Income, Industry Profit). The only variable common is the Product Mix. Clearly optimization under these two sets of assumptions is likely to yield very different answers. Which is correct? The relational algebra engine helps us resolve this dilemma by examining first, if these two sets of assumptions have anything in common (intersecting), or are totally different (disjoint). Then the common set can be separated, and the differences examined for further analysis as outlined in the description.

3.1 More Constraints: Constraint Transformations and Prediction

A key feature of this embodiment is the ability to generate new sets of constraints (new polytopes if the constraints are linear), which are information equivalent to a pre-existing constraint. Polytopes which have more or less information can also be generated. This is performed as discussed in the description, and restated below:

From a set of constraints represented in linear form as

Ax<=b

We can generate many other equivalent ones, using a variety of methods. If we use linear transformations x=Qy on the co-ordinate axes, we rewrite the constraints as

AQ y<=b.

In the y space, the constraint matrix is (AQ). If Q is orthogonal, this is a rotation, and the volume is preserved. The polytope in the y-space corresponds to the polytope in the x-space rotated by an angle specified by Q. Alternatively, we can view this as a new rotated polytope in the x-space itself, and this is the convention used here. If Q is not orthogonal, but has Det(Q)=+/−1, the volume is preserved, but shape is distorted. Similarly, a polytope can be translated—any translation preserves volume.

Polytopes with different number of constraints can be equivalent in information content and volume (see above).

As an example, consider polytope 150 in FIG. 84. A translation results in a new constraint set, the polytope 151, which has exactly the same volume and information content. A rotation plus a translation results in polytope 152. A volume increase reduces information content, and yields polytope 153. A non-orthogonal transformation with unit determinant is used to yield distorted polytope 155. A general nonlinear transformation yields more sides, resulting in the polytope 154, having the same volume and information content as polytope 150. All these constraints can be read from/stored in data/constraint warehouse 121 or constraint database 120.

All these constraints sets form an ensemble of information labeled constraint sets, and are placed in the same or a different database, in an exemplarily compressed form

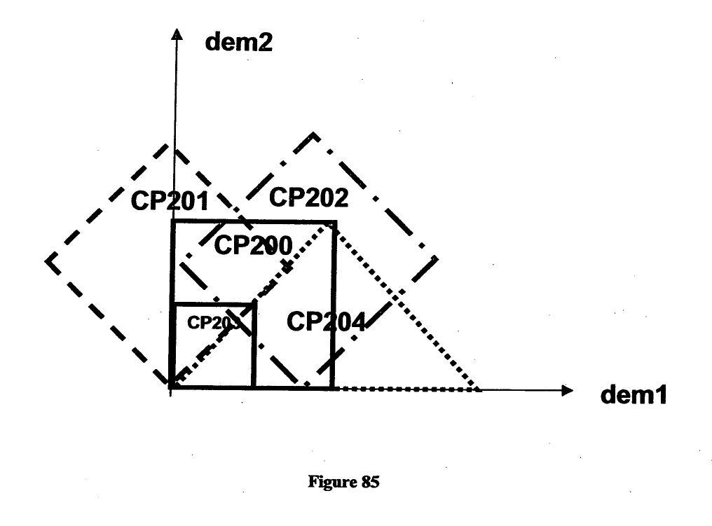

As an example of the constraint transformation facility, consider the polytopes in FIG. 85. The polytope CP200 of unit area (for simplicity in 2D) is defined by

CP200: 0=dem1<=1; 0<=dem2<=1;

This can be transformed using a 45 degree rotation to the polytope CP201 in FIG. 85.

CP201: 0<=[dem1−dem2]<=−√2; 0<=[dem1+dem2]<=√2;

The matrix Q used here is

$$Q = [ \begin{matrix}\frac{1}{\sqrt{2}} & \frac{1}{\sqrt{2}} \\ - \frac{1}{\sqrt{2}} & \frac{1}{\sqrt{2}}\end{matrix} ] \qquad ( 0.1 )$$

A further translation by 1/√2 in the positive dem1 direction, results in this polytope moving to the first quadrant only, resulting in CP202 in FIG. 85.

CP202: 0<=[dem1−dem2]<=−√2+1/√2; 0<=[dem1+dem2]<=√2+1/√2;

CP200, CP201, and CP202 all have the same volume and information content. A polytope with 2 bits more information content can be generated by scaling CP200 by a factor of ½ in each dimension, yielding CP203 in FIG. 85:

CP203: 0<=dem1<=½; 0<=dem2<=½;

Another information equivalent polytope is the triangle CP204 in FIG. 85

CP204: 0<=dem1<=2;0<=x−y;−2<=−x−y(x+y<=2)

Since the number of sides is different between CP204 and the others, it is not generated by a linear; but by a nonlinear transformation from CP200.

These constraint transformations furnish one method to enhance an existing constraint database. Prediction of constraints from historical data is another method to enhance an existing constraint database.

The constraints can be inferred using several methods as outlined in the description, to minimize the L₁ or other norms, representing the spread of the data along the direction perpendicular to the constraints. The constraints need not apriori have arbitrary direction, but the allowable directions can be restricted using constraints on the constraint coefficients themselves.

In FIG. 86, data points 306om data/constraint warehouse 121 are accessed by constraint predictor 114. Some constraints C307 can also exist in data/constraint warehouse 121, and these are also accessed if required. This data is used by the constraint predictor to generate new constraints C300, C301, C302, C303 C304 and C305, which are sent back to the data/constraint warehouse 121, or a separate constraint database 120. These new constraints are used in the subsequent phases of the invention. The mathematical equations for generating these constraints rely on linear or convex optimization, and have been described at the beginning of Appendix D.

3.2 Decision Support Over Time or Other Index

The relations between polytopes (constraints sets, which can be general convex or nonconvex bodies under nonlinear/nonconvex constraints) can be analyzed as a time series by the extended relational algebra engine 119 in FIG. 83, with the relationship between the polytopes evolving with time (or other index variable). FIG. 87 shows the time series output of the relational algebra engine 119 (in FIG. 83), in a simplified form.

The polytopes A100, B200, and C300, are evolving with time. These three can exemplarily represent three different future evolving views of a supply chain future. The evolution of this set theoretic relationship is shown in FIGS. 87. A100, B200 and C300 intersect at the first time step. This can be depicted as per the discussion on the diagrammatic representation in Patent 1677/CHE/2008 (with lines between intersecting constraint sets, etc) employed by the relational algebra engine 119 in FIG. 83, but this is not shown to keep the figure clear. The set theoretic relation is rather indicated in textual form, as A100×B100×C300 in the first timestep. The intersection continues in the next step, and in the third step, A100 becomes disjoint, indicated as A100, B200×C300.

In addition, labeled lines L1, L2, and L3 in FIG. 87 specify the evolving distance between selected points polytopes A100 and C300. These selected points can be the maximum distance between a point in A100 and C300, the minimum distance, or an alternative distance like that between the analytic centers. This is accomplished by solving convex optimizations outlined below. Additionally, the volume of the convex polytope A100 is computed by the information estimator 118 in FIG. 83, and is shown in FIG. 87 below the relation A100×B200×C300 only for the first time step (to avoid cluttering the figure).

Quantitative information about how far disjoint polytopes are can be used to obtain insight into how different various assumption sets are. The LP formulation (repeated here from the discussion in Patent 1677/CHE/2008) can be used for this purpose:
In the case of polytopes A and B, one can get an estimate of how far apart they are. This can be solved by the linear program given below. CA/BA is the constraint set/right hand side for A, CB/BB for B, and X is a point in A and Y in B.

A={X:C_{A}X<=B_{A}}

B={Y:C_{B}Y<=B_{B}}

Min∥X−Y∥

C_{A}X<=B_{A}

C_{B}Y<=B_{B}
Maximizing instead of minimizing finds the points in the two polytopes farthest from each other, and this can be used to normalize the minimum distance. Instead of the min of absolute value another norm like the L₂ norm can be used also, using convex optimization. Note that this can be used even if the polytopes are intersecting (min is always zero, and max can be determined). n addition to the min/max distance between polytopes, the distances between two random points inside each, distance between analytic centers (using convex optimization), distances between each polytope and any or all the constraints of the other, etc can all be found using techniques well-known in the state-of-art (having runtimes polynomial in the problem size). These methods can be extended to arbitrary convex bodies (not just polytopes) and can be extended to non-convex general regions by decomposing them into convex regions.

The relational algebra relations (subset, disjoint, intersecting), together with associated min/max distances between polytopes, and polytope volume/information content, forms the basis for input analysis. The sequence depicted need not be with respect to time, but can be w.r.t product id, node id, etc.

Note that determining the set theoretic relationship and distances between evolving constraint sets requires repeatedly solving linear programs Intazurental linear programming techniques (e.g. those that keep the same basis) well known in the state-of-art can be used to reduce computation time.

As has been mentioned previously, we reiterate that the methods are applicable to arbitrarily shaped constraint sets, not just polytopes or convex bodies.

3.4 Significance of Constraints

The constraints used can have multiple interpretations. For example, they could be used as demand validity constraints, i.e. the acceptable set of demands for guarantees on the supply chain performance to hold, similarly supply validity constraints, inventory validity constraints (relations limiting the inventory of each kind of product in the chain), price validity constraints, etc. We use the word “guarantees on performance”, since the approach here in one manifestation is a performance bounding approach. In another manifestation, using information on probability distribution of the parameters, converted to constraints specifying average or k^{th} percentile contours, the guarantees can be guarantees of average or k^{th} percentile performance.
If one or more constraints are violated (e.g. inventory falls below a threshold), and the supply chain guarantees are no longer valid, then an appropriate action (immediate orders, etc) has to be undertaken. Thus the constraints serve as triggers for supply chain response (possibly in real time). As compared to the state-of-art, multidimensional correlated constraints (not necessarily linear) can be incorporated for the triggers, and this is described subsequently (generalized basestock).
The current state of the system and the margin existing with respect to the constraints can be depicted in a GUI.
All the above can be implemented in a hardware device, or as a software service implemented using SOA/SAAS methodologies, doing real time control.
The above hardware device can be a mobile phone, augmented with appropriate software. Thus the supply chain (or similar entity being controlled) can be monitored/controlled using commonly available hardware devices.

Constraints can also be used as contract conditions, during auctions or similar multi-agent optimization strategies. For example, consider a contract between a supplier and buyer, where quantities d1 and d2 respectively of two products are traded at discounted prices p1 and p2. The discount holds provided a certain minimum is traded (acceptable to seller, else the price will have to increase) and a certain maximum amount is traded (acceptable to buyer, else he asks for a larger discount). If the min/max amounts are [100/200] for product 1, and [180/250] for product 2 we would say

p1 and p2 hold if

180<=d2<=250

Instead of specifying independent maxima/minima for products 1 and 2, our general constraints can specify correlated conditions between products 1 and 2, as

p1 and p2 hold if

350<=d1+d2<=400

This constraint recognizes the fact that to some extent, a smaller d1 (less than 100, the minimum amount in the previous example) can be compensated by a larger d2 (greater than 250) and vice versa. The above can be generalized to arbitrary constraints used as preconditions, and arbitrary post conditions also specified as constraints. Contracts can be changed during negotiations between trading partners.

3 Optimization Phase

Using methods outlined in the description in the Capacity Planning and the Inventory Optimization sections, the optimizer optimizes one or more supply chain metrics, based on the information under the constraints. The results are generalizations of classical supply chain policies, like (s,S) basestock. The use of linear and integer linear programming techniques has been outlined in the description, and optimal policies based on repeatedly solving linear/integer-linear optimizations, under the uncertainty constraints have been described, both for capacity planning and inventory optimization. Another class of policies is described in FIG. 89, which are embodiments of the trigger-response reorder system in the description in the Other Features sub-section. These we shall call generalized basestock policies.

First, consider a 2-D example of a correlated constraint between inventory of product 1 and product 2 as:

Inv_{—}p1+Inv_{—}p2<=1000,

Inv_p1>=0; Inv_p2>=0; We assume no backorders

A generalized basestock-style inventory policy using this constraint can be defined as follows. First, this set of constraints defines a polytope. From this polytope, we generate two polytopes, an inner polytope 500 in FIG. 89, which represents the point at which inventory of one or more goods has fallen too much, and an outer polytope 501 in FIG. 89, which represents the amount [symbol] ed. The inner and ou [symbol] S, respectively of an (s,S) basestock policy. The original constraint is not shown in FIG. 89, to avoid cluttering the diagram. In detail, the generalized basestock policy is as follows (see FIG. 89):

Generalized Basestock w.r.t Inventory Variables.
If the operating point point A, is inside the outer polytope 501 in FIG. 89 (this should always be the case), but outside the inner polytope 500 in FIG. 89 (inventory has not fallen too much): no order
Else (operating point inside inner polytope 500), order the minimum necessary (plus margin to prevent immediate violations) to move the operating point to the closest point on the outer polytope 501, but not touching any point of the inner polytope 500—this is point B).

This generalizes basestock policies, which are based on single goods. The constraint region can be an arbitrary polytope, and may have many faces. The basic difference from a standard (s,S) policy is that the thresholds and reorder point of each product, keep changing, as a function of available inventory of the other products. In FIG. 89, if there is a lot of inventory of product 2, very little of product 1 is ordered, since it is known that demand (say) of product 1 will be small if there is a lot of product 2. Conversely, with little inventory of product 2, the supply chain ensures that there is a lot of product 1 available, by reordering large quantities

In general, if the polytope is based on demand/supply/inventory/price! . . . variables, the same policy can be generalized to specify a triggering polytope. If the state of the supply chain system, moves to the boundary of the triggering polytope, a re-order (or other supply chain event) is triggered. The reorder event moves the supply chain state to a optimal point on a reorder point polytope. An optimal point on the reorder point boundary is chosen to optimize some metric, e.g. cost, total inventory, profit, etc. The policy is not restricted to polytopes specified by linear constraints, but also general convex bodies specified by convex constraints and also general non-convex bodies.

Hardware or modularized SOA/SAAS implementations are possible of above.

4 Input Output Analysis

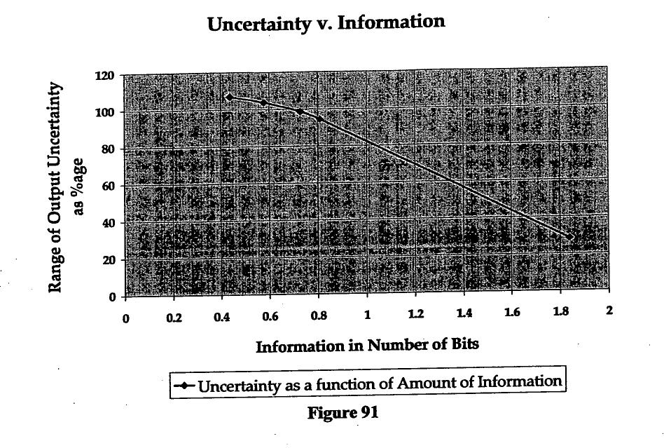

The bounds on one or more outputs can be compared with the input uncertainty, yielding insight into supply chain metric sensitivity to input assumptions, as fully described in the description of FIG. 91 “Screenshot of the input-output analyzer for a small supply chain”, in the examples and results section, subsection “Information versus Uncertainty”.

As described in Appendix D, the constraints themselves can be transformed to improve the metric, using all the transformation facilities described above. The total output information can be estimated based on multiple metrics, and compared with the total input information.

Glossary
Problems with Uncertainty: Problems where some of the parameters or variables may be randomly distributed, may be erroneous (or “noisy”) or may be unknown or unavailable for the optimization
Scenario: One set of values taken by a set of the parameters is called a scenario. Depending on the amount of uncertainty, the varying parameter sets will create a small/large ensemble of scenarios.
Convex polytope: The convex polyhedral formed by the constraints.
Breakpoint: A breakpoint in cost is in terms of the quantity. We have a fixed cost and a variable cost up to a certain quantity. Once the quantity processes increases beyond that point, a new fixed cost is incurred and we may have a different variable cost. That specific amount of quantity is known as a breakpoint. There can be as many breakpoints in cost.
Time period/step: One unit of time considered in the optimisation. It can be as large as a year or as small as an hour.
Planning horizon: The number of time periods (days, weeks, months etc.) over which planning has to be done.
Recourse: Corrective action taken when the true values of parameters are known.
Information Content: The total information content in the scenario set is calculated in terms of number of bits required to represent that information. Equating the information to the Shannon's surprisal, it can be shown that the information content becomes I=−log2 (V_{CP}/Vₘₐₓ), where V_{CP} is the volume of the convex polytope enclosed by these constraints, Vₘₐₓ is a normalization volume, reflecting all the possible uncertainties in the absence of any constraints.

### BIBLIOGRAPHIC REFERENCES

[1] Ahmed, S., King, A., Parija, G. (2000): A Multi-Stage Stochastic Integer Programming Approach for Capacity Expansion under Uncertainty
[2] Ahuja, Magnanti, Orlin: Network Flows, Theory, Algorithms and Applications, Prentice Hall, 1993.
[3] Arrow, K., Harris, T., Marschak, J. (1951): Optimal inventory policy, Econometrica, 19, 3, pp. 250-272
[4] Ben-Tal, A., Nemirovski, A. (1998): Robust convex optimization, Mathematics of Operations Research, 23, 4
[5] Ben-Tal, A., Nemirovski, A. (1999): Robust solutions of uncertain linear programs, Operations Research Letters, 25, pp. 1-13
[6] Ben-Tal, A., Nemirovski, A. (2000): Robust solutions of linear programming problems contaminated with uncertain data, Mathematical Programming, 88, pp. 411- 424
[7] Bersekas, D., Linear network optimization- Algorithms and codes, MIT press
[8] Bertsekas, D., Dynamic programming and optimal control, Volume 1, Athena Scientific, 2005
[9] Bertsimas, D., Sim, M. (2004): The price of robustness, Operations Research, 52, 1, pp. 35-53
[10] Bertsimas, D., Thiele, A. (2006): A robust optimization approach to supply chain management, Operations Research, 54, 1, pp. 150-168
[11] Bertsimas, D., Thiele, A. (2006): Robust and Data-Driven Optimization: Modern Decision-Making Under Uncertainty
[12] Boyd, S., Vandenberghe, L.: Convex Optimization, Cambridge University Press 2007
[13] Clark, A., Scarf H. (1960): Optimal Policies for a Multi-Echelon Inventory Problem, Management Science, 6, 4, pp. 475-490
[14] Dvoretzky, A., Kiefer, J., Wolfowitz, J. (1952): The inventory problem, Econometrica, pp. 187-222
[15] El-Ghaoui, L., Lebret, H. (1997): Robust solutions to least-squares problems to uncertain data matrices, SIAM Journal Matrix Anal. Appl., 18, pp. 1035-1064
[16] Harris, F., (1913): How many parts to make at once, Factory, The magazine of management
[17] Ravindran, A. R. (editor), Operations research and management science handbook, CRC press
[18] Kazancioglu, E., Saitou, K., (2004): Multi-period Robust Capacity Planning Based On Product And Process Simulations, Proceedings of the Winter Simulation Conference 2004
[19] Powell, W. B. (2007): Approximate dynamic programming for high-dimensional problems, Winter Simulation Conference 2007 tutorial
[20] Powell, W. B. (2007): Approximate dynamic programming, Wiley, John & Sons, Incorporated
[21] Prasanna, G. N. S.: Traffic Constraints instead of Traffic Matrices: A New Approach to Traffic Characterization, Proceedings ITC 2003.
[22] Prasanna, G. N. S., Aswal, A., Chandrababu, A., Paturu, D. (2007): Capacity Planning Under Uncertainty: A Merger of Robust Optimization and Information Theory applied to Supply Chain Management, Proceedings ORSI Annual Convention, 2007
[23] Paraskevopoulos, D., Karakitsos, E., Rustem, B., (1991): Robust Capacity Planning under Uncertainty, Management Science, 37, 7, pp. 787-800
[24] Santoso, T., Ahmed, S., Goetschalckx, M., Shapiro, A. (2003): A stochastic programming approach for supply chain network design under uncertainty
[25] Shapiro, A. (2008): Stochastic programming approach to optimization under uncertainty, Mathematical Programming, 112, 1, pp. 183-220
[26] Shapiro, A., Kleywegt, A. (2000): Stochastic optimization, Chapter 101
[27] Soyster, A. L. (1973): Convex programming with set-inclusive constraints and applications to inexact linear programming, Operations Research, 21, 5, pp. 1154-1157
[28] Swaminathan, J. M., Tayur, S. R. (2003): Models for supply chains in e-business. Management Science, 49, 10, pp. 1387-1406
[29] Topaloglu, H.: An approximate dynamic programming approach for a product distribution problem
[30] Whitin, T. M., (1952): Inventory Control in Theory and Practice, The Quarterly Journal of Economics, 66, 4, pp. 502-521

1.-30. (canceled)

31. A Computer implemented Decision Support method, comprising the step of feeding information in the form of at least one constraint set defined over a space of parameters, with a parameter being a multidimensional vector, with a constraint set having at least one constraint defined over said parameters, with allowable parameters satisfying all the constraints in at least one said constraint set, and offering facilities for at least one of:
a. determining at least one of set-theoretic relations, inclusive of subset, disjoint, and intersection, or at least one of metric relations, inclusive of maximum and minimum distances, between a first said constraint set and a said second constraint set, in an extended relational algebra engine;
b. transformation of a first said constraint set to obtain a second said constraint set having the same, greater, or smaller multidimensional volume using at least one of scaling, rotation, translations, and volume preserving, respectively volume increasing, respectively volume decreasing, general linear or non-linear transformations;
c. determining information content of a said constraint set by determining the volume of said constraint set in an information theory engine; and
d. and having a facility to determine a parameter, which satisfies all constraints in a first constraint set, and where a specified objective function defined over said parameters is maximized over all parameters satisfying all constraints in same said first constraint set.

32. The method of claim 31, where a first maximum and a first minimum, and a first difference between said first maximum and said first minimum, of the said objective function are determined over all parameters satisfying all constraints in said first constraint set.

33. The method of claim 32, where a second difference between a second maximum and a second minimum of said objective function, is determined over all parameters satisfying all constraints in a second said constraint set.

34. The method of claim 33, where volume and information content of first said constraint set, and volume and information content of second said constraint set is determined.

35. The method of claim 32, where said first constraint set is transformed using one of said transformation facilities to reduce the said difference.

36. The method of claim 31, with a said parameter, being a vector whose components are values of a set of variables in a supply chain management system, said values being either restricted to integers, or allowed to have real number values, and said variables representing one of (a) demand, (b) supply, (c) inventory, (d) cost, (e) revenue or (f) profit or other relevant variables of an entity in a supply chain management system.

37. The method of claim 36, where the value of a said variable is read from the database of said supply chain management system, said variable value or values being updated in realtime by input to said supply chain management system.

38. The method of claim 37, where said facility gives a signal indicating satisfaction or non-satisfaction of at least one of said constraint sets, or satisfaction or non-satisfaction of a complex query on said constraint sets, by said variable value or values.

39. The method of claim 36, where a constraint set is obtained from at least one of user input, prediction from data or constraints present in said supply chain management database, or transformation of a second constraint set present in said supply chain management database, where said prediction utilises an apriori constraint about the constraint set, and creates a constraint set which is a best approximation to the convex hull of the parameters in said supply chain management database, said apriori constraint being one of:
a. the value of a constraint coefficient is fixed;
b. the sum of all constraint coefficients is fixed;
c. the mean square sum of all constraint coefficients is fixed.

40. The method of claim 36, where said transformation is a volume preserving linear transformation or translation applied to said second constraint set.

41. The method of claim 36, where the constraint set obtained by transformation uses one of a general volume preserving nonlinear transformation, which may change the number of constraints in said constraint set or a non-volume preserving transformation.

42. The method of claim 36, where the constraint set obtained by transformation is stored back in a said supply chain management database,

43. The method of claim 36 where an optimal inventory policy is obtained either by using said constraint set in the input to a linear or convex or mixed integer linear or convex programming problem or by determining a trigger constraint set and a reorder constraint set, at least one of said trigger and reorder constraint sets involving more than one said supply chain variable, where said inventory policy initiates a supply chain reorder action, when a said supply chain variable or variables result in a parameter being included in the trigger constraint set, said supply chain reorder action moving said parameter to a point in the reorder constraint set.

44. The method of claim 36 where the results are analyzed in an output analyzer which offers facilities to look at the aggregates of said variables in a subset of the supply chain, said aggregrates being at least one of sum, maximum, or minimum, or other relevant analytics, said subset comprised of at least one of a supply chain node or edge.

45. A Computer implemented Decision Support system, comprising the means of feeding information in the form of at least one constraint set defined over a space of parameters, with a parameter being a multidimensional vector, with a constraint set having at least one constraint defined over said parameters, with allowable parameters satisfying all the constraints in at least one said constraint set, and means to invoke facilities for at least one of:
a. determining at least one of set-theoretic (subset, disjoint, and intersection) and metric relations, inclusive of distances between a first said constraint set and a said second constraint set, in an extended relational algebra engine;
b. transformation of a first said constraint set to obtain a second said constraint set having the same, greater, or smaller multidimensional volume using at least one of scaling, rotation, translations, and volume preserving, respectively volume increasing, respectively volume decreasing, general linear or non-linear transformations;
c. determining Information content of a said constraint set by determining the volume of said constraint set in an information theory engine;
d. and having a facility to determine a parameter, which satisfies all constraints in a first constraint set, and where a specified objective function defined over said parameters is maximized over all parameters satisfying all constraints in same said first constraint set.
